(19) United States
(12) Patent Application Publication
(10) Pub. No.: US 2017/0206004 A1
(43) Pub. Date: Jul. 20, 2017

(54) INPUT OF CHARACTERS OF A SYMBOL-BASED WRITTEN LANGUAGE

(71) Applicant: AMAR Y SERVIR, CHASTRE (BE)

(72) Inventors: PIERRE-HENRY DE BRUYN, BRUSSELS (BE); OLIVIER VAN DER BORGHT, BRUSSELS (BE); FRANÇOIS DE BAUW, BRUSSELS (BE)

(21) Appl. No.: 15/326,098

(22) PCT Filed: Jul. 15, 2014
(86) PCT No.: PCT/EP2014/065146

§ 371 Date: Jan. 13, 2017

(51) Int. Cl. G06F 3/0488; G06F 3/0482; G06F 3/01; G06F 17/22

(52) U.S. Cl. CPC G06F 3/04886; G06F 17/2223; G06F 3/04883; G06F 3/0482; G06F 3/018

(57) ABSTRACT

Methods for inputting characters of a symbol-based written language for encoding in a computerised system including a touch-sensitive surface, some methods comprising no more than four input steps. Movements of an object over the surface of the touch-sensitive surface, maintaining continuous contact therewith, defines a unique input path for each character. From a start position, an initial component in the input path selects a part of an alphabetical phonetic transcription associated with the character to be encoded. Groups of letters are displayed when initial contact is made, and, selection of one group displays individual letters within that group for selection. Once a selection has been made using the object, further components related to the character are displayed on the touch-sensitive surface at each step of the input path in accordance with previous selections, and if there is no ambiguity, removal of the object from the touch-sensitive surface encodes the character.

### FIELD OF THE INVENTION

The present invention relates to the input of oriental characters, and is more particularly, although not exclusively, concerned with the input of Chinese characters into a computerised system using a touch-sensitive input device.

### BACKGROUND OF THE INVENTION

There is a single common Chinese writing, which can take the form of traditional characters or of simplified characters. However, there are various Chinese spoken languages, each constituting a distinct dialect, and users desiring to input one or more Chinese characters into a computerised system face a number of issues as described below. Users of the Japanese, Korean and Vietnamese writing and associated spoken languages face similar issues, where characters similar to or based on Chinese characters remain in use to some degree.

In alphabet-based writing systems, the set of 26 letters in the Latin alphabet together with punctuation and other symbols constitute a clear, unambiguous and defined set of units that can be used as a basis for text input on a computer keyboard or other input device for a computerised system, allowing, through a direct mapping between the input and the output, the direct generation by the computer of unambiguous and reliable text that can be displayed on a screen; or the further processing of the text for other purposes.

The Chinese writing system does not provide such a clear, unambiguous and defined set of units that can be used as a basis for text input into a computerised system. Chinese characters are indeed complex: there are tens of thousands of Chinese characters and, in addition, ambiguity is inherent to the Chinese writing and the Chinese spoken languages. The ambiguity primarily originates in the many homophones, that is, Chinese characters written differently and with different meanings but having the same syllabic pronunciation, and sometimes also the same tonal pronunciation, in a given Chinese spoken language, and the many heteronyms, that is, a single Chinese character with two or more different pronunciations in a given Chinese spoken language and/or two or more meanings depending on the context or the word or of the sentence of which they are part. This ambiguity, particularly with respect to homophonous Chinese characters, has generally been considered as a serious obstacle to a direct mapping between the input and the output.

As a consequence of the features of the Chinese writing and of the Chinese spoken languages, inputting Chinese characters into a computerised system in such a way that the computerised system is able to generate unambiguous and reliable text requires at least four main steps:

(i) a mental encoding by the user of each of the targeted output Chinese characters into data units that can be entered into a computerised system through a keyboard or another input device;

(ii) the input by the user of such data units, which are not the targeted output Chinese characters, into a computerised system through a keyboard or another input device;

(iii) the decoding of the input data units by software in the computerised system for identifying and generating the targeted output Chinese characters in a computerised format for storage in the computerised system for further processing purposes such as the display on a screen; and

(iv) when needed, a process, carried out usually between steps (ii) and (iii) by the user and/or by software in the computerised system, for resolving ambiguities among homophones and among heteronyms.

Hundreds if not thousands of input methods have been developed for handling steps (i) to (iv) above. Many of such methods are used but none of them appears to have provided a fully satisfactory disambiguation process of homophonous Chinese characters and of heteronymous Chinese characters while at the same time offering users willing to input Chinese characters into their computerised systems or devices for writing text or for other processing purposes an efficient, reliable, speedy, easy to learn and user-friendly input scheme.

Two main categories of input methods for Chinese characters are currently implemented in the main commercial software products: phoneme-based input methods and shape-based input methods. Other ways of inputting Chinese characters into a computer are to use one of the existing Chinese handwriting recognition and input software and Chinese speech recognition and input software.

Phoneme-based input methods are based primarily upon the Chinese spoken language. The user, before starting the computer input, mentally encodes phonetically the targeted Chinese character using, for the spelling of the syllables, an alphabetical phonetic transcription system, such as, Pinyin or Zhuyin. Pinyin is the official alphabetical phonetic transcription system for the 412 phonemes of the Putonghua Chinese language, which is the official spoken language of the People's Republic of China (referred to hereinafter as “Mainland China”), and, is called Guoyu in Taiwan and Huayu in Singapore. Pinyin, which is based on the Latin alphabet, is taught in Chinese schools in Mainland China and is widely used in Mainland China and is also used to some extent in Taiwan and in Singapore. Zhuyin, also called Zhuyin Fuhao or Bopomofo is a non-Latin phonetic transcription system of Putonghua/Guoyu used mainly in Taiwan and is based upon 37 “letters” and four, or sometimes five, tone marks on a special keyboard. The user inputs into the computerised system the phonetic notation (with or without the tonal information, but most existing input methods are non-tonal) on an alphanumeric keyboard, such as, a QWERTY keyboard or on another input device. The software within the computerised system, having received the input data units, processes such input data units to identify, retrieve, display and store the targeted Chinese characters.

In the case of homophonous Chinese characters, which the software cannot itself disambiguate for identifying the targeted Chinese character, the software usually presents the user on the screen with a list of homophonous Chinese characters from which the user must, as an additional step, choose and select the targeted Chinese character by means of an additional input, allowing the software to identify and retrieve the targeted Chinese character and to store if for processing such as its display on a screen.

Predictive systems built around databases have been developed and embedded in phoneme-based input software in an attempt to assist in the disambiguation of homophones and to speed up the disambiguation process. Such systems try to predict, through a statistical approach, a targeted Chinese character, or a string of targeted Chinese characters, on the basis of the context (assuming that the user inputs a text of some length) and of the preferences of the user (built from his previous use of the software). Given the existence of many homophones, the whole input process is regularly interrupted by a software request for choice and selection by the user in often long lists of homophonous Chinese characters. In addition, the software often automatically reinterprets, on the basis of a given additional input by the user, a string of output Chinese characters that have already been displayed on the screen and have formed a text corresponding to the targeted output text of the user, and, working backwards, automatically modifies the string by replacing some or all of the output Chinese characters by other Chinese characters, forcing the user to work backwards to reject the replacements in order to restore the initial output.

None of those predictive systems, however, provide 100% accuracy in the disambiguation: choice and selection by the user from lists of homophonous Chinese characters are still required by the software in many instances, and, the user must in addition often work backwards (by deleting an inaccurate prediction and having to retype, or carry out another input step, for eventually getting some or all of the targeted Chinese characters).

Some phoneme-based methods have been refined or designed in such a way as to reduce the number of keystrokes needed for keying in the alphabetical phonetic transcription, thereby offering users the possibility to increase the speed of their typing. For example, inputting the alphabetical phonetic translation of the phoneme “zhuang” in Pinyin input methods requires six keystrokes, that is, one stroke for each letter of the transcription. However, some so-called shuangpin methods simplify the Pinyin input process by using only two predetermined letter keys to represent the alphabetical phonetic transcription of a phoneme. In this case, several letters are mapped to a one or two keystroke input, which means, for example, that “zhuang” can be entered by typing “zh” and “uang”. Similar approaches for reducing the number of keystrokes have also been developed for Zhuyin input methods.

Since phoneme-based input methods are based on a given spoken language, the user will not be able to input a targeted Chinese character that he/she reads or knows how to write but does not know how to pronounce in such spoken language. If the user wants to input this Chinese character into a computerised system, he/she will have to resort to a shape-based method or to the use of handwriting recognition and input software.

Shape-based input methods are based on the Chinese writing and not on the Chinese spoken language. The set of input units is pre-defined by the method and corresponds to “standard shapes” based on a mostly geometric decomposition of the graphological structure of each Chinese character into components or elements. Each of such methods follows its own rules for the decomposition process, which the user has to assimilate prior to being able to use the method. Some of such methods, for example, decompose Chinese characters into parts; others into structural elements based on “Chinese radicals” (bushou in Chinese), that is, one or more graphic portion of a Chinese character, irrespective of its role (phonetic, semantic, both or none) under which such a Chinese character is listed in dictionaries; others into types of structure at the corners of Chinese characters (such as the “Four Corners” method invented in the 1920s by Wang Yunwu where four or five numerical digits are used to encode each Chinese character, and such digits are chosen according to the shape of the four corners of each Chinese character); and others still into strokes of which some or all are included in the set of input units. The Cangjie input method, invented in 1976, is one of such methods and appears to be one of the most widely used by users of shape-based methods. Another frequently used of such methods is the Wubi input method, which allows the input of every Chinese character with at most four keystrokes.

Before starting the computer input, the user of a shape-based method mentally analyses the graphical structure of the targeted Chinese character to break it down into components or elements in accordance with the decomposition rules proposed by the relevant input method, and mentally identifies and selects the data units to which each component or element corresponds according to the method. The user inputs the selected data unit(s) into the computerised system using a special keyboard having a number of dedicated keys, each key being assigned a different data unit; an alphanumeric keyboard, such as, a QWERTY keyboard where each data unit is assigned to a particular letter key; or another input device. The software in the computerised system, having received the input data units, processes the input data units to identify (basically using the decomposition rules in reverse), retrieve and store the targeted Chinese character for further processing.

Homophonous Chinese characters are not an issue in shape-based input methods since such methods are not based on the spoken language and no disambiguation of homophones is therefore needed.

A significant feature of shape-based input methods is that they cannot be used if the user does not acquire and maintain a perfect knowledge of the decomposition rules and pre-defined “standard shapes” specific to that method, and of how to write each of the targeted Chinese characters (failing which he cannot do the mental decomposition). Software using shape-based methods cannot handle mistakes committed by the user in the mental decomposition of the graphical structure of a given Chinese character which results in the input of an erroneous element (which may be notified to the user, usually by emitting an error message, such as, a beep, that the software cannot further proceed), and cannot make up for Chinese characters which the user has forgotten how to write.

Another issue, which adds to the difficulty of learning and mastering shape-based input methods, is that the decomposition rules and “standard shapes” are essentially based upon technical software and hardware constraints and do not follow the analysis standards of the structure of Chinese characters and the stroke order rules of Chinese calligraphy defined by language and education authorities.

Enough practice is said to help overcoming these issues, but, because of that requirement, and also of the fact that shape-based methods require a continuous analysis of the structure of each targeted Chinese character during the input process and therefore demand increased concentration, they are mainly used by professional typists.

Predictive systems similar to those embedded in phoneme-based input software can be embedded in shape-based input software but cannot make up for erroneous input: they can operate only on the basis of text of some length made up of targeted Chinese characters already successfully entered into the computerised system.

Since shape-based input methods are based on the written language, the user will not be able to input a targeted Chinese character that he/she knows how to pronounce but does not know how to write. If the user wants to input this Chinese character into a computerised system, he/she will have to resort to a phoneme-based method or to speech recognition and input software.

There have been attempts to resolve the issue of disambiguation of homophonous Chinese characters in phoneme-based methods by inputting additional information taken from the structure of the targeted Chinese character but none of those “phono-semantic” input methods appears to have solved the issue with 100% accuracy.

If one takes a broader view and looks at what would constitute an ideal input method, or at least a significant progress towards an ideal method, none of the existing phoneme-based methods or shape-based methods, and none of the attempts to develop a phono-semantic method appear to have met in a satisfactory manner at the same time each of the following main criteria, each corresponding to one of the main issues of Chinese character computer input:

(1) the method offers a definitive solution to the issue of disambiguation of homophonous Chinese characters such that a one-to-one mapping can be achieved between a set of input units and each of the corresponding targeted Chinese characters, resulting in 100% accuracy of output;

(2) the method allows the user to input a targeted Chinese character through a finite sequence of input steps, with such steps being limited in number and preferably in the low range of one to four steps;

(3) the method is easy to learn and easy to use, such that when thinking of, or seeing, a targeted Chinese character, the user can easily identify the relevant set of input units and the sequence of the input steps without the need to learn, assimilate and memorise a significant amount of new information, such as arbitrary input code, before being able to use the method;

(4) the structure and input logic of the method are such that the method is not limited to one or a few input devices but can, with appropriate user interface adaptations when needed, be used with the same input logic on most if not all input devices available or in development, such as, a keyboard, a touch-sensitive surface of any size, an in-air motion tracking device, an eye-motion tracking device, a brain impulse tracking device, etc.

The existing input methods only meet some of the criteria described above, as summarised in the Table 1 below:

TABLE 1

| | Phoneme-based | Shape-based |
|---|---|---|
| Homophonous characters handling | No | Yes |
| Finite sequence | No | Yes |
| Easy to learn and easy to use | Yes | No |
| Broad input device portability | No | No |

Given the limitations of the existing methods, a method that would meet at least all the above main criteria at the same time, thereby bringing a combined solution to the main issues of Chinese character computer input, would have the potential to become the most used and widespread method for inputting Chinese characters into computerised systems.

### SUMMARY OF THE INVENTION

It is an object of the present invention to provide a universal input method which can be used for characters in a symbol-based written language, such as Chinese, which does not suffer from the disadvantages of the prior art discussed above.

It is another object of the present invention to provide a method for inputting such characters for encoding which does not require more than four input steps.

In accordance with one aspect of the present invention, there is provided a method of inputting a character in a symbol-based written language for encoding in a computerised system using at least phonetic information relating to the character to be input in no more than four input steps, the four input steps defining an input path and each input step resolving ambiguity associated with the encoding of the character, the method comprising performing at least one input step for selecting an alphabetical phonetic transcription related to the character from a plurality of alphabetical phonetic transcriptions in the symbol-based written language.

The method further comprises displaying an array of possible components for selection in accordance with the input path of the character to be encoded.

In one embodiment, the alphabetical phonetic transcription may comprise at least an initial component for the character, and said at least one input step may comprise selecting an initial component of an alphabetical phonetic transcription, the array comprising a plurality of first level elements arranged around a start position, each of the first level elements providing at least a group of initial alphabetical phonetic components.

Preferably, the selection of a first level element corresponding to a group of initial components generates a nested sub-array. Each nested sub-array may comprise a plurality of second level elements, each second level element including at least one initial component.

In one embodiment, each array comprises six first level hexagons and each nested sub-array comprises six second level hexagons arranged around a central first level hexagon, each of the six second level hexagons corresponding to at least one initial component of the alphabetical phonetic transcription. The initial components in each second level hexagon may be displayed in accordance with the selection of a group of initial components in the first level hexagon with which the second level hexagons are associated.

The selected initial component may be validated, for example, by a user, or automatically, for example, by the computerised system, and, in one embodiment, no further input steps are required as the initial component comprises a complete alphabetical phonetic transcription for the character which is unambiguous and is used for encoding the character.

In another embodiment, the alphabetical phonetic transcription comprises at least a final component for the character to be encoded and said at least one input step comprises selecting a final component of an alphabetical phonetic transcription, the array comprising a plurality of third level elements arranged around a start position, each of the third level elements providing at least a group of final alphabetical phonetic components.

In one embodiment, the selection of a third level element corresponding to a group of final components may generate a nested sub-array. Each nested sub-array may comprise a plurality of fourth level elements, each fourth level element including at least one final component of the alphabetical phonetic transcription.

Each array may comprise six third level hexagons and each nested sub-array may comprise six fourth level hexagons arranged around a central third level hexagon, each of the six fourth level hexagons corresponding to at least one final component of the alphabetical phonetic transcription. In one embodiment, the final components in each fourth level hexagon may be displayed in accordance with the selection of a group of final components in the third level hexagon with which the fourth level hexagons are associated.

As described above, the selected final component may be validated by the user or automatically. In one embodiment, the final component may comprise a complete alphabetical phonetic transcription for the character which is unambiguous and is used for encoding the character.

Where said at least one input step comprises the selection of the final component of the alphabetical phonetic transcription, a first input step may be bypassed using a shortcut to a second input step, the first input step and the second input step respectively corresponding to the selection of an initial component or a final component of the alphabetical phonetic transcription of the character to be encoded. The selection of the final component may be made using an array having a plurality of third level elements arranged around a central element corresponding to an end point of the shortcut, each third level element corresponding to a group of final alphabetical phonetic components.

In this embodiment, the selection of a third level element corresponding to a group of final components may generate a nested sub-array. Each nested sub-array may comprise a plurality of fourth level elements, each fourth level element including at least one final component.

In one embodiment, each array may comprise six third level hexagons and each nested sub-array may comprise six fourth level hexagons arranged around a central third level hexagon, each of the six fourth level hexagons corresponding to at least one final component of the alphabetical phonetic transcription. The final components in each fourth level hexagon may be displayed in accordance with the selection of a group of final components in the third level hexagon with which the fourth level hexagons are associated.

However, where there is conflict between possible characters which share the same initial component of the alphabetical phonetic transcription, a second input step is needed for selecting a final component of the alphabetical phonetic transcription for the character in accordance with the selected initial component, the initial component and the final component together comprising a complete alphabetical phonetic transcription for the character.

In one embodiment, the second input step further comprises displaying possible final components of the alphabetical phonetic transcription in accordance with the selected initial component of the alphabetic phonetic transcription.

As described above, the array may comprise a plurality of third level elements arranged around a central element, each third level element corresponding to a group of final alphabetical phonetic components. In this case, the central element corresponds to the selected initial component of the alphabetical phonetic transcription. A nested sub-array may be generated when a third level element is selected as described above, and, each nested sub-array may comprise a plurality of fourth level elements, each fourth level element including at least one final component.

Each array may comprise six third level hexagons and each nested sub-array may comprise six fourth level hexagons arranged around a central third level hexagon as described above, each of the six fourth level hexagons corresponding to at least one final component of the alphabetical phonetic transcription.

As described above, the final components in each fourth level hexagon may be displayed in accordance with the selection of a group of final components in the third level hexagon with which the fourth level hexagons are associated.

Validation of the selection of the final component may be needed to obtain the complete alphabetical phonetic transcription for the character. This validation may be performed by the user or automatically once the final component of the alphabetic phonetic transcription has been selected.

Where the complete alphabetical phonetic transcription is unambiguous, it can be used for encoding the character without having to perform any further input steps.

If the complete alphabetical phonetic transcription is ambiguous, that is, there is more than one possible character which can be encoded for the complete alphabetical phonetic transcription, the method further comprises performing a third input step for selecting at least one semantic component for the character based on the selected alphabetical phonetic transcription from a plurality of semantic components related to the character in the symbol-based written language.

At said third input step, said at least one semantic component is selected from a plurality of semantic components grouped according to similarities in at least one of: meaning and shape. The plurality of semantic components may be displayed in an array similar to those described above for the initial and final components of the alphabetical phonetic transcription.

Alternatively, said at least one input step may comprise a third input step for selecting at least one semantic component for the character. This can be achieved by utilising bypasses to skip the selection of both the initial and final components of the alphabetical phonetic transcription.

In one embodiment, the array may comprise a plurality of fifth level elements arranged around a central element corresponding to the selected final component of an alphabetical phonetic transcription corresponding to the character to be encoded, each fifth level element corresponding to a group of semantic components compatible with the combination of the selected initial and final components of the alphabetical phonetic transcription. The selection of a fifth level element corresponding to a group of semantic components may generate a nested sub-array.

In one embodiment, each group of semantic components comprises a group of radicals.

Each nested sub-array may comprise a plurality of sixth level elements, each sixth level element including at least one of a semantic component for the character to be encoded and a character to be encoded.

In one embodiment, each array comprises six fifth level hexagons and each nested sub-array comprises six sixth level hexagons arranged around a central fifth level hexagon corresponding to the selected group of semantic components, each of the six sixth level hexagons corresponding to at least one of a semantic component for the character to be encoded and a character to be encoded.

Said at least one of a semantic component for the character to be encoded and a character to be encoded in each sixth level hexagon may be displayed in accordance with the selection of a group of semantic components in the fifth level hexagon with which the sixth level hexagons are associated.

As the sixth level hexagons display either a semantic component of the character to be encoded or the character itself which is to be encoded, if no ambiguity remains, the character to be encoded may be selected. If ambiguity remains, a semantic component of the character to be encoded is selected. As described above, the selection of either the selected semantic component or the character to be encoded may be validated, for example, by a user, or automatically, for example, by the computerised system.

If the character to be encoded is selected, the selection may be validated by the user, or automatically by the computerised system. In this case, the selection provides the character and no further steps are required.

If a semantic component is selected which has more than one character associated with it, there is a conflict between possible characters which share the same semantic component selected at the third input step, and a fourth input step for selecting a character may be required to resolve any ambiguities for the character.

It will readily be appreciated that any one of the initial and final components of the alphabetical phonetic transcription is readily selectable either alone or in combination with a previously selected component (in the case of the final component following an initial component).

In addition, a semantic component may be selected following either the selection of the initial component of the alphabetical phonetic transcription or the selection of the final component of the alphabetical phonetic transcription. In the latter case, the final component of the alphabetical phonetic transcription can be selected after the selection of an initial component, the final component being determined in accordance with the selected initial component, and the semantic component available for selection is determined in accordance with the previous component selection(s).

A character may be selected at the fourth input step from a number of possible characters in the same grouping of semantic components to resolve any ambiguities arising from similarities in at least one of: meaning and shape. The number of possible characters are compatible with the semantic component selected at the third step.

In one embodiment, the number of characters in the same grouping comprises a fixed list of characters. The fixed list of characters may be arranged in a predetermined hierarchy. In one embodiment, the predetermined hierarchy comprises a rank based on frequency of use.

In one embodiment, the number of characters in the same grouping of semantic components may be displayed in a matrix. The matrix may comprise at least a 3×3 matrix. The 3×3 matrix may comprise at least a first level in which up to nine possible characters is provided for selection. These nine possible characters may be arranged in locations around a central location which corresponds to an end point of the previous input step.

If there are more than nine characters still in conflict, the matrix comprises a second level, a link being provided to the second level from the first level. In this way, up to a further eight characters can be provided for selection.

Naturally, the matrix may comprise an n×n matrix where n is greater than 3, but it would not be possible to use all locations in such a matrix as one would need to pass through at least one inner location to reach an outer location. In such an embodiment, only the other locations may be populated with characters for selection.

In one embodiment, the method further comprises inserting at least one of: punctuation, symbols, numbers and spaces into a string of encoded characters. In a similar way to the display of the initial and final components of the alphabetical phonetic transcription and the semantic components, said at least one of: punctuation, symbols, numbers and spaces may be displayed in an array. The array may comprise a plurality of elements, and, the selection of an element in the array generates at least one nested sub-array.

In one embodiment, the plurality of elements may comprise six hexagons arranged around a central hexagon. Each nested sub-array may comprise a plurality of hexagons arranged around the hexagon with which it is associated. Each hexagon and the central hexagon may comprise at least one of: punctuation, symbols, numbers and spaces.

In a preferred embodiment, each input step in the input path for the character to be encoded is performed in at least one single continuous movement on a touch-sensitive input device. Preferably, each step of the input path is displayed during said at least one single continuous movement.

In another embodiment, when two movements are made in the same direction, a clockwise movement may be used to replace the second of said movements. In a further embodiment, a counter-clockwise movement may be used to bypass an input step.

In another embodiment, each input step in the input path for the character to be encoded may be performed in a gesture recognition system, the gesture recognition system forming part of the computerised system.

Advantageously, the method provides a start position for said at least one input step irrespective of positioning within a predetermined interaction region.

In one embodiment, each input step in the input path for the character to be encoded may be performed using a series of discrete movements on a touch-sensitive input device. The series of discrete movements may include at least one predetermined movement, for example, at least one of a tap, a stroke and a swipe.

In addition, said at least one predetermined movement may comprise lifting an object from a touch-sensitive surface.

In another embodiment, each input step in the input path for the character to be encoded may be performed using a series of discrete movements on an input device including a numeric keypad. The series of discrete movements may comprise selecting at least one location on the numeric keypad. A plurality of selected locations on the numeric keypad may define directional movements relative to a neutral location. The neutral location may correspond to a central location of the keypad, and the selection of the central location may provide a validation of the character to be encoded. The plurality of selected locations may comprise an upper row and a lower row relative to the neutral location. Alternatively, the plurality of selected locations may comprise columns to the left and right of the neutral location.

In an embodiment, a predefined colour may be associated with each location on the numeric keypad. In this way, a colour can be used to indicate the direction which a user needs to select. This is advantageous for teaching people the directions. In another embodiment, a predefined sound may be associated with each location on the numeric keypad. Each predefined sound may correspond to a defined note in a musical scale.

In one embodiment, a symbolic representation may be associated with said at least one input step.

In accordance with another aspect of the present invention, there is provided apparatus for encoding a character in a symbol-based written language in a computerised system, the system comprising:—

a database arranged for storing information relating to each character to be encoded;

an input device operable for permitting input of at least one input component relating to a character to be encoded, and, through which information stored in the database is retrieved in accordance with said at least one input component;

a processor connected to the database and the input device, the processor being operable for using said at least one component input to the input device for retrieving information relating to said at least one input component relating to character to be encoded from the database; and

a display connected to the processor and being operable for displaying said at least one input component and information retrieved from the database relating to said at least one input component.

The apparatus further comprises a memory associated with the processor, the memory being operable for storing retrieved information relating to the character to be encoded.

The input device preferably comprises a touch-sensitive surface, contact and subsequent movement of an object over the touch-sensitive surface inputting said at least one input component. The touch-sensitive surface ideally forms part of the display so that the components can be displayed on the touch-sensitive surface, and, the object can be used to interact directly with the display.

In one embodiment, the computerised system comprises a tablet. In another embodiment, the computerised system comprises a smart phone. In another embodiment, the computerised system comprises a smart watch. The computerised system may also comprise a computerised system with a touch-sensitive surface, display or screen which performs the same as a tablet, smart phone or smart watch but is not as portable.

In one embodiment, the processor comprises an operating system associated with the touch-sensitive surface.

In another embodiment, the input device comprises a numeric keypad. The numeric keypad may form part of the computerised system. Alternatively, the numeric keypad may form part of a touch-sensitive surface.

In an embodiment, the computerised system may associate a predefined colour with each location on the numeric keypad. In this way, a colour can be used to indicate the direction which a user needs to select. In another embodiment, the computerised system may associate a predefined sound with each location on the numeric keypad. Each predefined sound may correspond to a defined note in a musical scale. In a further embodiment, the computerised system may associate both a colour and a sound to each location on the numeric keypad.

In one embodiment, the input device comprises a gesture recognition system associated with the computerised system.

The database may be located in a hosted environment, the processor being operable to connect to the hosted environment. Alternatively, the database may form part of the computerised system.

In accordance with a further aspect of the present invention, there is provided a method of encoding a character in a symbol-based written language using a touch-sensitive input device, the touch-sensitive input device having a touch-sensitive surface, the method comprising:—

making contact with a first region of the touch-sensitive surface of the touch-sensitive input device using an object; and

selecting at least an initial component relating to the character to be encoded from a plurality of initial components by moving the object from the first region to at least one other region on the touch-sensitive surface maintaining contact between the object and the touch-sensitive surface.

Said at least one other region is preferably located around the position of the object in contact with the first region of the touch-sensitive input device.

In one embodiment, the method further comprises, with continuous contact between the object and the touch-sensitive surface, moving the object in at least one direction from the second region to at least one other region to select additional components of the character to be encoded; and removing the object from said at least one other region to encode the character. In one embodiment, said at least one other region comprises a nested sub-region.

In one embodiment, the object may be moved in a predetermined direction prior to removing it from contact with said at least one other region. This effectively validates the last selection.

Ideally, said at least one other region comprises a series of regions, each region including a plurality of components relating to the character to be encoded compatible with a previously selected component, the object being removed from contact with the region of the series which fully defines the character to be encoded.

In one embodiment, removing the object from contact with the touch-sensitive surface encodes the character.

The method also comprises displaying the components for selection at each region.

In accordance with a further aspect of the present invention, there is provided a computer program product executable on a computerised system and operable for performing the method of inputting a character in a symbol-based written language for encoding in a computerised system using at least phonetic information relating to the character to be input in no more than four input steps, the four input steps defining an input path and each input step resolving ambiguity associated with the encoding of the character, the method being as described above.

In accordance with yet a further aspect of the present invention, there is provided a computer program product executable on a computerised system and operable for performing a method of encoding a character in a symbol-based written language using a touch-sensitive input device, the touch-sensitive input device having a touch-sensitive surface, the method comprising the steps as described above.

In accordance with yet another aspect of the present invention, there is provided a computer program product executable on a computerised system and operable for performing a method of encoding a character in a symbol-based written language using a gesture recognition system associated with a computerised system, the method comprising the steps described above.

### BRIEF DESCRIPTION OF THE DRAWINGS

For a better understanding of the present invention, reference will now be made, by way of example, to the accompanying drawings in which:—

FIG. 1 illustrates an arrangement for a Ming Tang in accordance with the present invention;

FIG. 2 illustrates a Second Floor for the Ming Tang of FIG. 1;

FIG. 3 illustrates relationships of the possible Chinese characters, including the associated Chinese radical and encoding information, for a series of homophonous Chinese characters;

FIG. 4 illustrates a Ming Tang and its Second Floor;

FIGS. 5a and 5b illustrate an arrangement of characters in a Ming Tang in accordance with their encoding tag;

FIG. 6 illustrates a flow chart of the steps in the input process in accordance with the present invention;

FIG. 7 illustrates first level hexagons in accordance with the present invention;

FIG. 8 illustrates, simultaneously, first and second level hexagons in accordance with the present invention;

FIG. 9 is similar to FIG. 8 and illustrates first level hexagons with their associated Latin characters and Chinese initial components;

FIG. 10 illustrates third and fourth level hexagons starting from the selection of an initial component of an alphabetical phonetic transcription associated with the Chinese character to be encoded;

FIG. 11 is similar to FIG. 10 but illustrates fifth and sixth level hexagons starting from the selection of a complete alphabetical phonetic transcription;

FIG. 12 illustrates another embodiment of the present invention in which a numeric keypad can be used for the input of characters to be encoded;

FIG. 13 illustrates a table of number inputs for a numeric keypad and the associated glyphs;

FIG. 14 illustrates the steps of the input method in accordance with the present invention and the relationship with glyphs;

FIG. 15 illustrates a table of alphabetical phonetic transcriptions and of specific Chinese characters with the addition of glyphs;

FIG. 16 illustrates the relationship of a numeric keypad with directions thereon in accordance with the input steps with symbols and scripts derived from the input steps as well as with colours;

FIG. 17 illustrates examples of CCs converted to symbols and scripts as derived from the input steps;

FIG. 18 illustrates a table of characters in different keyboards, keypad entries, together with the input steps of the present invention, as well as the symbols and scripts derived from the input steps as well as musical values;

FIG. 19a illustrates the input path for a CC with the encoding tag ‘PRIC’ and which is also an Alphabetical CC;

FIG. 19b is similar to FIG. 19a but for a CC with the encoding tag ‘PRUC’;

FIG. 19c is similar to FIG. 19a but for a CC with the encoding tag ‘SUCa’;

FIG. 19d is similar to FIG. 19a but for a CC with the encoding tag ‘PRIC’ which is not an Alphabetical CC;

FIG. 19e is similar to FIG. 19a but for a CC with the encoding tag ‘SILO’;

FIG. 19f is similar to FIG. 19a but for a CC with the encoding tag ‘SUCu’;

FIG. 19g is similar to FIG. 19a but for a CC with the encoding tag ‘DUCAMa’;

FIG. 19h is similar to FIG. 19a but for a CC with the encoding tag ‘HUCa-1’; and

FIG. 19i is similar to FIG. 19a but for a CC with the encoding tag ‘HUCa-28y’.

FIG. 20a illustrates a QWERTY keyboard to which glyphs derived from the input steps are allocated;

FIG. 20b is similar to FIG. 20a but illustrates a QWERTY keyboard to which another set of glyphs derived from the input steps are allocated;

FIGS. 21a and 21b illustrate relationships between some Chinese characters and associated correspondence in other languages; and

FIG. 22 illustrates a table of Alphabetical CCs and their relationship with Pinyin, traditional CCs and simplified CCs, numerical keypad entries, symbols and scripts derived from the input steps including glyphs.

### DESCRIPTION OF THE INVENTION

The present invention will be described with respect to particular embodiments and with reference to certain drawings but the invention is not limited thereto. The drawings, which comprise flowcharts, described and/or referred to are only schematic and are non-limiting. In the drawings, the size of some of the elements may be exaggerated and not drawn to scale for illustrative purposes.

Although the present invention and the particular embodiments will be described below with reference to Chinese characters in their simplified form (jianti zi) and in their traditional form (fanti zi) and also to Pinyin, the official Latin alphabetical phonetic transcription system for the 412 phonemes of the Putonghua Chinese language, the official spoken language of the People's Republic of China, and which is called Guoyu in Taiwan and Huayu in Singapore, this is not meant to limit the scope of the invention.

The invention may also be applied to other symbol-based languages. In addition, the invention may be applied to letters of an alphabet, such as the Latin alphabet, the Cyrillic alphabet, the Arabic alphabet and to the phonetic transcription of a spoken language for which such an alphabet is used as a phonetic transcription. In addition, the letters of any one of these alphabets may be considered to represent symbols. Moreover, the invention may also be applied to other Chinese characters, such as, kanji, hanja, chu nho, or chu nom, as used in other character-based writing systems.

Chinese characters and other phonetic transcription systems of a Chinese spoken language, such as, Zhuyin, also called Zhuyin Fuhao or Bopomofo, which is a non-Latin phonetic transcription system of Putonghua/Guoyu used mainly in Taiwan and based upon 37 “letters” and four, or sometimes five, tone marks on a special keyboard, may also be input using the method of the present invention.

However, the application of the present invention to the inputting of Chinese characters and Latin alphabetical phonetic transcription or non-Latin phonetic transcription of another Chinese spoken language or dialect, such as, Shanghainese (Wu) or Cantonese (Yue) or even to Chinese characters and to the Latin alphabetical phonetic transcription or non-Latin phonetic transcription of another language using Chinese characters, such as, Japanese, Korean and (old) Vietnamese, and to another Latin alphabetical phonetic transcription system or non-Latin phonetic transcription system of a Chinese, Japanese, Korean, Vietnamese or other spoken language, such as, Wade-Giles Romanisation, EFEO Romanisation, Yale Romanisation, Jyutping, Peh-oe-ji, Hepburn Romanisation, Hihon-shiki, Kurei-shiki, McCune-Reischauer Romanisation, Revised Romanisation of Korean, quoc ngu, Japanese Kana (Katakana and/or Hiragana), Hangul (jamo), Cyrillic alphabet, Arabic alphabet, Indian Devanagari, etc., are also envisaged.

The terms “CC” and “CCs” as used herein refer to Chinese characters, in the singular and the plural respectively, in their simplified form (jianti zi) and in their traditional form (fanti zi). In the examples below, the traditional form of the CC is shown in parentheses following the simplified form of the CC.

The term “targeted CC” as used herein refers to a CC which is to be encoded.

The term “PUDASHU” (for “ [symbol] ( [symbol] )”), the abridged form of “ [symbol] ( [symbol] ) [symbol] ( [symbol] )”) or “pushi dazi shurufa jishu” in Pinyin as used herein refers to a universal (PUshi) input method (shurufa) and technique (jiSHU) for typing (DA) characters (zi) which comprises an original classification of CCs and produces a new symbolic representation system of CCs.

The terms “PUDASHU-database” and “PDS-db” as used herein refer to a database in which the original classification of Chinese characters is stored. The CCs within the PDS-db are arranged logically to support the input method as will be described below.

The term “IBEEZI” (for “ [symbol] ( [symbol] ) [symbol] ” or “yibi yizi” in Pinyin and meaning “one brush, one character” or for “ [symbol] ( [symbol] ) [symbol] ” or “yibizi” in Pinyin and meaning “character of a single stroke”, or literally, “character of a single brush”) as used herein refers to a method of encoding using a touch-sensitive surface as an input device as will be described in more detail below.

The terms “alphabetical phonetic transcription” and “alphabetical phonetic transcription systems” as used herein refer to the transcription of a Chinese character into a Latin alphabetical representation thereof. In one embodiment, the alphabetical phonetic transcription system refers to Pinyin, but is not limited thereto, and other Latin alphabetical phonetic transcription systems or non-Latin phonetic transcription systems, such as, for example, Zhuyin Fuhao, are also possible as described above. In addition, these terms are not limited to use with only Chinese and can be used for Japanese, Korean and Vietnamese or other symbol-based written languages.

The terms “symbol-based language” or “symbol-based written language” as used herein refer to a non-alphabetical written language, for example, Mandarin (Putonghua), Shanghainese (Wu), Cantonese (Yue), Japanese, Korean and (old) Vietnamese, etc. as described above, as well as alphabetical languages, such as, Cyrillic, Arabic, Russian etc., and Latin-based alphabetical languages, such as, English, French, German, Spanish etc.

The term “component” as used herein refers to parts of a CC which are selected when using the PUDASHU input method. These components comprise an initial alphabetical phonetic component and a final alphabetical phonetic component of an alphabetical phonetic transcription of the targeted CC. There is also a semantic component which is associated with the shape and/or meaning of the targeted CC.

The terms “Initial Phonetic step” and “Final Phonetic step” as used herein respectively refer to steps required to select an alphabetical phonetic transcription for the targeted CC. The Initial and Final Phonetic steps correspond to the selection of initial and final components respectively of the relevant alphabetical transcription of the targeted CC, and, correspond respectively to first and second input steps of the PUDASHU input method. For some CCs, the alphabetical phonetic transcription comprises only a single component. Such a single component may comprise an initial component which can automatically be selected after the initial component input step or a final component which can be selected by bypassing the initial phonetic step using a shortcut as will be described in more detail below.

The term “radical” as used herein refers to a family of meanings or shapes, but does not in itself provide a sufficient semantic or phonetic information. It is, however, the minimum form of identification and recognition for a CC in a set of CCs, and comprises a necessary and sufficient part to be taken as a basic criterion for distinguishing between CCs with the same alphabetical phonetic transcription.

The term “Chinese Radical step” as used herein refers to the selection of the group of Chinese radicals to which the targeted CC has been assigned as described below. This input step may also be referred to as the selection of a semantic component, and, corresponds to the third input step of the PUDASHU input method.

The term “Ming Tang” as used herein refers to a geometrical arrangement for resolving ambiguities after the Chinese Radical step. In the present invention, the geometrical arrangement comprises three columns and three rows where each element in the arrangement is assigned a specific number. There may be two levels of the Ming Tang as will be described in more detail below. In addition, for each combination of alphabetical phonetic transcription and Chinese radical, there is only one possible Ming Tang arrangement, and, as a consequence, there are a plurality of possible Ming Tang arrangements according to the selection of the alphabetical phonetic transcription followed by the selection of the Chinese radical.

The term “ambiguity” as used herein refers to the possibility of selecting more than one CC having at least one component in common but for which there are a number of possible CCs. The resolution of an ambiguity, in some cases, provides the targeted CC.

The term “ambiguous” as used herein relates to CCs having at least one of the same components and which can be selected in the PUDASHU input method.

The term “rank” as used herein refers to the frequency of use of a CC within a set of CCs in which there is ambiguity. CCs within such a set are, as a matter of principle, ranked in accordance with their frequency of use from the highest to the lowest in a descending order of use.

The terms “validation” and “validating” as used herein refer to the selection of a character from a plurality of possible characters. In some cases, where there is only one possible character, the validation may automatically be performed by the computerised system to encode the character. In other cases, a user needs to select the desired character and validate it for encoding.

The term “hosted environment” as used herein refers to an environment which can host the software, or part of the software, for performing the PUDASHU input method. In one embodiment, this may be a “cloud environment” which is accessed through an internet connection.

The present invention will be described with reference to a specific embodiment in which a touch-sensitive input device is used on which input steps are performed, the touch-sensitive input device being operated by software to retrieve CCs from the PDS-db. However, it will be appreciated that other ways of performing input steps are also possible using other input devices which are operated by similar software to retrieve CCs from the PDS-db.

The present invention utilises a database for storage of CCs in accordance with their classification as will be described in more detail below. The PUDASHU input method relies for its use on a series of data stored in a specific database, called “PUDASHU database” or “PDS-db”, not visible to the user of the PUDASHU input method and where a selection of CCs that can be used as targeted CCs are stored and systematically classified as described below together with all their possible alphabetical phonetic transcriptions and with the other data described below, among which a unique input path associated with each of such alphabetical phonetic transcriptions. 8,536 CCs have been currently selected and stored in the PDS-db and can each be used as a targeted CC by a user of the PUDASHU input method but, if and when necessary, additional CCs can be selected, classified and stored in the PDS-db and then used as additional targeted CCs by a user of the PUDASHU input method.

As will be described further below, using the PUDASHU input method comprises, for a given targeted CC stored in the PDS-db, following and traversing, through successive input steps by the user, a unique input path associated with such a targeted CC. It will readily be understood that there can be more than one unique input path associated with a given targeted CC since a significant number of CCs included in the PDS-db are heteronymous and therefore have more than one alphabetical phonetic transcription. The current PDS-db contains 9,556 alphabetical transcriptions, and therefore 9,556 unique input paths, whereas it contains only 8,536 CC. In addition, a significant number of CCs included in the PDS-db are homophonous, that is, they share the same alphabetical phonetic transcriptions and therefore have at least one identical portion in their respective input paths.

The unique input path for a targeted CC is made of the succession of distinct data units that a user of the PUDASHU input method must enter into an input device for triggering the retrieval of the CC corresponding to the targeted CC in the PDS-db by software in a computerised system and the storage of such CCs in the computerised system in a computerised format for further processing.

Traversing a unique input path for a targeted CC is achieved by means of the sequential input by the user of the method of phonetic, shape-related and other data specific to such a targeted CC and associated with such a targeted CC in the PDS-db. At each step of the input sequence, the user resolves ambiguities among the CCs included in the PDS-db by traversing a portion of the unique input path of the targeted CC, which portion the targeted CC shares with one or more other CCs in the PDS-db, and, each additional step brings the user nearer to the portion of the input path which is unique to the targeted CC, the user obtaining the targeted CC with the last input step.

At each step of the input sequence, the user is presented with the result of the steps already performed and with a finite number of possibilities from among which the user resolves ambiguities with the next input step. The input sequence ends up at the fourth input step, or at an earlier input step in some instances, with the selection by the user and the retrieval in the PDS-db by the software, or in some instances with the automatic retrieval in the PDS-db by the software without a selection by the user, of the targeted CC, which the software can then store in the computerised system in a computerised format for further processing.

The sequence of input for any CC in the PDS-db is made using a maximum of four input steps. The first input step, called the “Initial Phonetic step”, comprises, as will be described in more detail below, the input by the user of the initial component of the alphabetical phonetic transcription of a given targeted CC. The second input step, called the “Final Phonetic step”, comprises, as will be described in more detail below, the input by the user of the final component of the alphabetical phonetic transcription of such targeted CC. The third input step, called the “Chinese Radical step”, comprises, as will be described in more detail below, the input by the user of the partition of Chinese radicals to which the Chinese radical of such targeted CC has been assigned. The fourth input step, called the “Ming Tang step”, comprises, as will be described in more detail below, the selection by the user of the targeted CC in a specific geometrical arrangement of the finite and limited number of CC which the first, the second and the third input steps have not already excluded.

Since each of the distinct data units which the user inputs at each step of the input sequence is assigned a distinct code in the PDS-db and is associated with a single movement of a finger or other object over a touch-sensitive surface of an input device input device associated with the computerised system for inputting such data units, each CC being included in the PDS-db or, if such a CC is an heteronym each of the alphabetical phonetic transcription associated with such a CC, can be and is assigned, a unique code which is also stored in the PDS-db and which corresponds to each one of the activation positions along the unique input path for such a CC or, if such a CC is an heteronym, along the unique input path for each alphabetical transcription associated with such a CC. For example, the unique code assigned to the “ [symbol] ” (cang) CC corresponds to the unique input path of such alphabetical phonetic transcription of such a CC comprising the four input steps, each of which is described in more detail below. First and second input steps select the initial component and the final component of the alphabetical phonetic transcription of such a CC, followed by a third input step where the head of the partition of Chinese radicals to which such CC has been assigned is selected, and, a fourth input step where the CC “ [symbol] ” is selected by the user in a Ming Tang arrangement to resolve ambiguities.

For some CCs, as will be described in more detail below, after the first input step, only the second input step or the third input step may be necessary, and confirmation that no further step (third step or fourth step respectively) is required, and, in such a case, the unique code of such a CC will, in one embodiment of the present invention, be confirmed by the removal of the finger from the input device as will be described in more detail below.

For some other CCs, as will be described in more detail below, no second input step is required, and, in such a case, the unique code of such a CC will, in one embodiment of the present invention, be confirmed by the removal of the finger from the input device indicating that no second step is required.

For some CCs, the “Initial Phonetic step” or first input step may be bypassed by a shortcut so that the user moves directly to the “Final Phonetic step” or second input step without first selecting an initial component of the alphabetical phonetic transcription. The selection of the final component of the alphabetical phonetic transcription of the targeted CC may comprise the targeted CC itself, or, it may lead to the “Chinese Radical step” or the third input step for the selection of the Chinese radical associated with the final component of the alphabetical phonetic transcription of the targeted CC.

The structuring of the PDS-db, the way CCs are classified and stored in the PDS-db, the way the specific phonetic, shape-related and other data associated with each of such CCs are identified, labelled and classified and then stored in the PDS-db, the way the appropriate input steps for encoding each of such CCs are identified, classified and stored in the PDS-db and generally the reasons for which all data included in the PDS-db are deemed relevant and are identified, labelled and stored in the PDS-db, are primarily dictated by the following main requirements: constituting a unique input path for each of such CCs, or if they are heteronymous, a unique input path associated with each of their alphabetical phonetic transcription; and assigning a short input sequence, that is, of less than four steps, to as many of the CCs included in the PDS-db as possible.

The PDS-db is a data structure currently comprising 9,556 records, each of which comprising various fields where text, numeric and other data are stored and each of the 9,556 records comprises at least the following fields:

the simplified form (jianti zi) of the CC itself;

the traditional form (fanti zi) of the CC itself;

the complete alphabetical phonetic transcription in Pinyin of such a CC or, if such a CC is an heteronym, each of the complete alphabetical phonetic transcriptions of such a CC;

the complete alphabetical phonetic transcription in Zhuyin Fuhao of such a CC or, if such a CC is an heteronym, each of the complete alphabetical phonetic transcriptions of such a CC;

the initial component of the alphabetical phonetic transcription of such a CC or, if such a CC is an heteronym, the initial component of each of the alphabetical phonetic transcriptions of such a CC;

the relative position on a visual display to which such initial component has been assigned;

the final component of the alphabetical phonetic transcription of such a CC or, if such a CC is an heteronym, the final component of each of the alphabetical phonetic transcriptions of such a CC;

the relative position on a visual display to which such final component has been assigned;

if such a CC is an heteronym, the precedence, based upon frequency of use, assigned to each of its alphabetical phonetic transcriptions;

if such a CC is an heteronym, the distinct tonal information for each of its alphabetical phonetic transcriptions with, where a given alphabetical phonetic transcription can have more than one distinct tonal information, the precedence, based upon frequency of use, assigned to each such distinct tonal information;

the group of Chinese radicals, as will be described in more detail below, to which such a CC is assigned;

the partition of Chinese radicals, as described below, to which such a CC traditional form (fanti zi) is assigned;

the CC which has been assigned as the head of such partition;

the relative position on a visual display to which such head of partition has been assigned;

the Secondary Radical, if any, associated with such a CC as described in more detail below;

the generic encoding tag, as will be described in more detail below, associated with such a CC;

the generic Ming Tang arrangement, as will be described in more detail below, associated with such a CC;

the positioning of such a CC in the Ming Tang, as will be described in more detail below;

the code for each of the components of the unique input path associated with such a CC or, if such a CC is an heteronym, of the unique input path associated with each of the alphabetical phonetic transcriptions associated with such a CC;

the direction of the movements that the user will need to make for activation or selection at each input step for such a CC;

the input shortcuts, if any, associated with such a CC;

the punctuation and other symbols, and space for insertion after or before a CC, a punctuation or other symbol, as will be described below; and

the various user guidance tools, in the form of colours or otherwise, associated with the input path of such a CC.

The PDS-db can be organised as one table or as a relational database in the form of multiple tables with relationships between data stored in two or more of such tables and with each of such tables comprising fields relevant to the information stored in each such table and the person skilled in the art would have no difficulties in determining combinations of multiple tables in a way compatible with the PUDASHU input method.

The phonetic data included in the PDS-db, that is, the initial components and the final components of the alphabetical phonetic transcriptions and the complete alphabetical phonetic transcriptions of CC included in the PDS-db are based upon the alphabetical phonetic transcriptions of CC in Pinyin, that is, made of one or more of the 26 letters of the Latin alphabet.

The shape-related data, such as the identification of the group and the partition of Chinese radicals, included in the PDS-db where they are associated with the relevant CC are also associated with the 26 letters of the Latin alphabet, the relevant letter being identified through a specific classification, described below, of the traditional 214 classes of Chinese radicals of the Kangxi dictionary of the 18^{th} century.

The association of such shape-related data with the 26 letters of the Latin alphabet is substantially as described in US-A-2012/0259614, namely:
by allocating, based upon similarities in meaning and/or shape, the 214 Chinese radicals of the Kangxi dictionary among 78 groups;
by allocating, based upon similarities in meaning and/or shape, the 78 groups to 26 partitions, each partition comprising three of the 78 groups of Chinese radicals;
by identifying in each of the 26 partitions of Chinese radicals one of the Chinese radicals of each of such partition and assigning to such Chinese radical the role of head of such partition;
by assigning to each of the 26 partitions of Chinese radicals one distinct capital letter of the Latin alphabet. Each such distinct capital letter is assigned to a given partition based upon similarities between its shape and the shape of the Chinese radical assigned as the head position for each partition;
by assigning three variants to each such distinct capital letter, each variant corresponding to one of the three groups of the partition to which such distinct letter is assigned;
by labelling each of such three variants through a three-level labelling allowing to identify each of the three groups in a partition: “A” (meaning “Accessible”) for the Chinese radicals allocated in the “floor level” group; “U” for the Chinese radicals allocated to the “Upper level” group (not to be confused with the “U” meaning “Univocal” as described below); and “O” for the Chinese radicals allocated to the “dOwn level” group; and
by assigning to one of the 78 groups, according to the Chinese radical of the traditional form (fanti zi) of CC, each CC in the PDS-db that shares with one or more other CC in the PDS-db the same alphabetical phonetic transcription, which results in each such CC being also assigned to one of the 26 partitions.

Whilst US-A-2012/0259614 is directed to the transliteration of CCs to promote learning of the Chinese written language, it discloses the grouping and the sorting of CCs by their Chinese radicals. These Chinese radicals comprise at least a part (or sometimes all) of the CCs. The method described makes use of the 214 conventional radicals as a starting point for the reduction into a smaller number of radicals. The number of reduced radicals is 26*3 and these 78 radicals are represented by symbols of the Latin alphabet. The 214 conventional radicals have been distributed between 78 groups, with the head of each such group being called a “Radical Capital” and with each of such groups being divided in three subsets each of which forming a family of conventional radicals. The conventional radicals grouped in one family share similarities in one of: meaning or shape, and each family is headed by one conventional radical.

Whilst the present invention makes use of the same traditional 214 classes of Chinese radicals of the Kangxi dictionary (and as described in US-A-2012/0259614) as a starting point for the identification of the Chinese radicals and their bridging with the Latin alphabetical system, it will readily be appreciated that another set of Chinese radicals or other shape-related elements of CCs compatible with the PUDASHU input method can be used and stored with a modified PDS-db structure which is modified in accordance with this different set of Chinese radicals or other shape-related elements. The CCs and their Chinese radicals are allocated among groups and partitions as described above but it will readily be understood that the allocation can be made in another way in accordance with the particular database structure.

The PUDASHU input method has a maximum of four input steps which need to be followed by the user. The actual number of input steps for encoding a given targeted CC is determined by the number of instances along the input sequence where phonetic, shape-related and/or other data associated with such targeted CC are in conflict, or are not in conflict, with phonetic, shape-related and/or other data associated with other CCs included in the PDS-db.

The instances of conflicts are classified as follows, based upon the distinct nature of each of such instances:
conflicts between two or more targeted CCs which are homophonous, that is, which share a same alphabetical phonetic transcription;
conflicts between two or more targeted CCs having been assigned to a same partition of Chinese radicals;
conflicts between two or more targeted CCs having been assigned to at least two different groups of Chinese radicals in a same partition;
conflicts between two or more targeted CCs having been assigned to a same group of Chinese radicals;
conflicts between two or more targeted CCs not being CCs to which, as will be described in more detail below, precedence has been given based upon their frequency of use and having been assigned to a same group of Chinese radicals to which more than one CC has been assigned; and
conflicts between two or more targeted CCs not being CCs to which, as will be described in more detail below, precedence has been given based upon their frequency of use and having been assigned to two or more groups of Chinese radicals to each of which more than two CCs have been assigned.

Such classification allows the identification in the PDS-db of subsets made of finite numbers of conflicting CCs for each instance of conflict of a given distinct nature. Rules have been determined to identify which one of the CCs in each of such subsets takes precedence over the others with a view to limiting the number of input steps for the most frequently used targeted CCs. As a result of the application of such rules, the number of CCs included in the PDS-db which remain in conflict with a targeted CC is gradually reduced as one progresses along the input sequence, culminating in the fourth input step, if required, where the user selects the targeted CC from within a limited set of conflicting CCs. The rules described below, also based upon highest frequency of use of the CCs, have been determined for easing for the user the task of selecting the targeted CC within such final subset.

The present invention makes use of specific tables of frequency of use of CCs as a reference, but other tables of frequency of use of CCs could have been taken as a reference instead with a corresponding adaptation of the PDS-db.

The classification of conflicts and the rules for managing such conflicts and for easing the selection of the targeted CC at the fourth step, if required, are expressed and summarised in 32 generic encoding tags further described below and each CC included in the PDS-db is associated with one of such 32 generic encoding tags.

With respect to the fourth input step, the generic encoding tag, where needed, also expresses the position assigned to each CC associated with such generic encoding tag, as described in more detail below, in the Ming Tang for selecting the targeted CC in the final subset of conflicting CCs. Each CC identified as likely to end up in a Ming Tang is assigned a position in one of the nine locations of the Ming Tang on the basis of the conventions of positioning as described below in relation to the encoding tags.

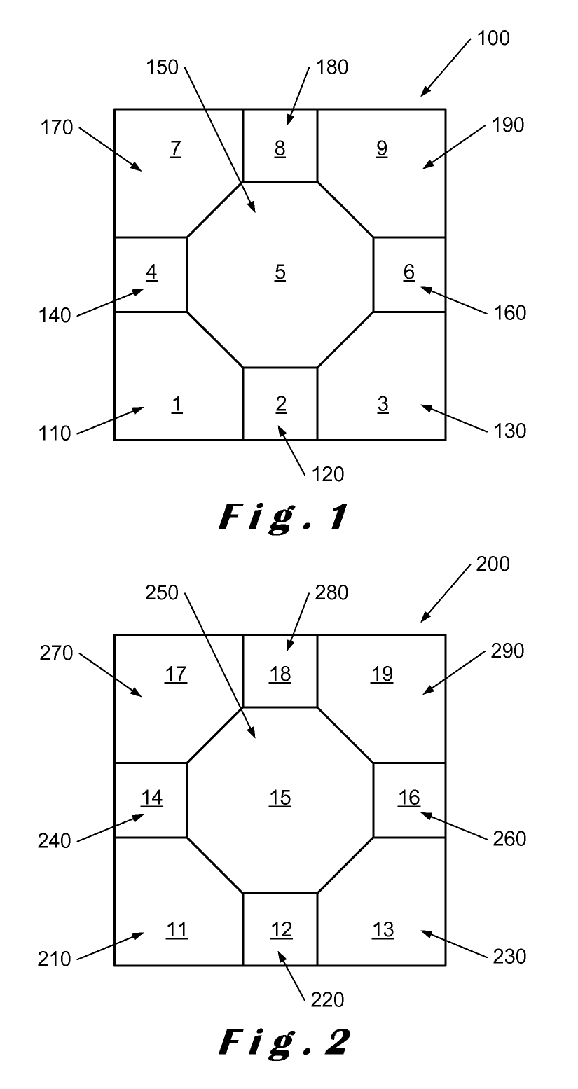

FIG. 1 illustrates a Ming Tang 100 comprising an array of nine locations 110, 120, 130, 140, 150, 160, 170, 180, 190 in which CCs in conflict are positioned for ambiguity resolution. Here, the nine locations are arranged as a symmetrical 3×3 matrix and each location is allocated a number 1 to 9 as shown in FIG. 1 and/or a name. In this case, locations 110, 120, 130, 140, 150, 160, 170, 180, 190 are respectively numbered as 1, 2, 3, 4, 5, 6, 7, 8, 9. In the Ming Tang, the “Upper Row” comprises locations 170, 180, 190; the “Middle Row” comprises locations 140, 150, 160; and the “Bottom Row” comprises locations 110, 120, 130. Similarly, from the top of the Ming Tang, the “Left Column” comprises locations 170, 140, 110; the “Central Column” comprises locations 180, 150, 120; and the “Right Column” comprises locations 190, 160, 130.

In this embodiment, the nine locations are arranged in three rows and three columns with the location at the intersection of the Central Column and the Middle Row being the position at which a user arrives after the third input step, and, the location at the intersection of the Left Column and the Bottom Row providing access to a Second Floor of the Ming Tang as will be described in more detail below.

Although the Ming Tang 100 is shown as a symmetrical matrix in FIG. 1, it will readily be appreciated that the Ming Tang may comprise any suitable arrangement which provides nine locations. It will also be appreciated that the Ming Tang does not need to be limited to providing nine locations and that any other suitable number of locations may be implemented.

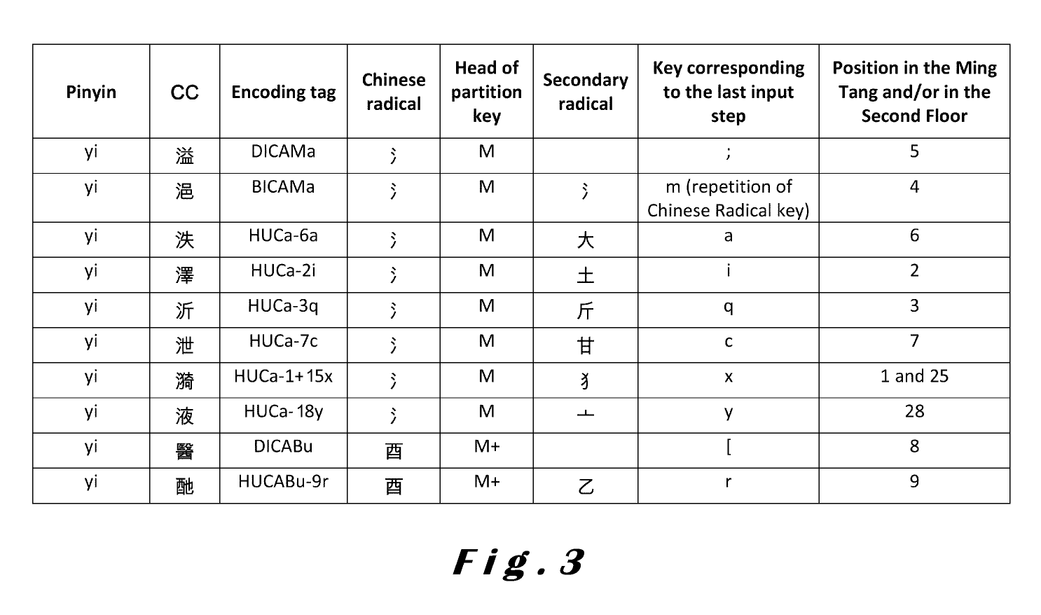

In the exceptional cases where there are more than nine CCs to be positioned in a Ming Tang, nine of such CCs are assigned a location in the Ming Tang 100 as described with reference to FIG. 1, and, one of the locations of the Ming Tang, in this case, location 110, is, in addition, assigned the function of giving access to a “Second Floor” 200 of the Ming Tang, such a Second Floor being also a matrix of nine locations 210, 220, 230, 240, 250, 260, 270, 280, 290, each location being assigned a number 11 to 19 as shown in FIG. 2. As before, the numbers can be replaced with names. The Second Floor 200 of the Ming Tang as shown in FIG. 2 is of similar or identical layout to the Ming Tang shown in FIG. 1 with the exception that it has a different number and/or name. In the Second Floor, the “Upper Row” comprises locations 270, 280, 290; the “Middle Row” comprises locations 240, 250, 260; and the “Bottom Row” comprises locations 210, 220, 230. Similarly, from the top of the Second Floor, the “Left Column” comprises locations 270, 240, 210; the “Central Column” comprises locations 280, 250, 220; and the “Right Column” comprises locations 290, 260, 230. The location at the intersection of the Central Column and the Middle Row is the end point from the Ming Tang 100 and provides access to CCs in the other eight locations of the Second Floor.

However, it will be appreciated that the Second Floor of the Ming Tang may have a different layout to the Ming Tang itself in accordance with a particular embodiment.

If there is a Second Floor, the CC that is positioned in the location 110 of the Ming Tang 100 giving access to the Second Floor 200 is replicated in the Second Floor, in this case, in location 250, and the other CCs in excess of nine (corresponding to the Ming Tang 100) are each assigned a position in one of the other eight locations 210, 220, 230, 240, 260, 270, 280, 290 of such a Second Floor 200. Each CC identified as needing to be in a Second Floor is assigned to a position in one of the eight locations of the Second Floor surrounding the location 250 on the basis of the conventions of positioning described in more detail below.

Although the Ming Tang and the Second Floor are described as 3×3 matrices, it will readily be appreciated that the matrix may comprise an n×n matrix where n is any suitable number greater than 3, preferably where n is odd to provide a central location which corresponds to the last position of the third input step. However, it will be appreciated that where n is greater than 3, it will not be possible to utilise all the locations in the matrix as it will not be possible to select the outer locations without passing through the inner locations. In this case, only the outer locations of the matrix may be populated with CCs for selection.

Each of the 32 generic encoding tags takes the form of letters of the Latin alphabet and, in some instances, numbers and/or symbols aggregated sequentially in accordance with the sequence of the succession of conflicts, or with the absence of conflict. Each letter (or group of letters for the letters “PR”, “AB” and “AM”) corresponds to:

a family of conflicts;

a sub-family of conflicts;

a category of conflicts; and

a sub-category of conflicts.

The 32 generic encoding tags are made of combinations of:

five families of conflicts expressed by the letters “PR” (for “Phonetically Referential”), “S” (for “Single”), “D” (for “Directing”), “B” (for “Binary”) and “H” (for “Homophono-isoradicalar”);

two sub-families of conflicts expressed by the letters “U” (for “Univocal”) and “I” (for “In conflict”) for each of the five families;

two categories of conflicts expressed by the letters “AB” (for “Added to a Binary list”) and “AM” (for “Added to a list of More than two”) for families “D”, “B” and “H”; and

three sub-categories of conflicts expressed by the letters “A” (for “Accessible”), “U” (for “Upper level”) and “O” (for “dOwn level”) for categories “AB” and “AM”.

When the letter “C” is also included in an encoding tag between two vowels or at the end of an encoding tag, this letter stands for “CC” and is included only as a means of facilitating the pronunciation of such encoding tag.

When the letter “B” is the first letter of an encoding tag, it refers to a family of conflicts and when it is the fifth letter of an encoding tag and combined with A to form “AB”, it refers to a category of conflicts.

When used in lower case, a letter indicating a sub-category (“a”, “u” and “o”) and included in an encoding tag is not a component of the input path of the CC but indicates to which one of the three groups of Chinese radicals (“A”, “U” and “O”) the Chinese radical of such CC has been assigned. Each of the numbers and other symbols included in some of the 32 generic encoding tags refers to specific conflicts as will be described below in relation to each such encoding tags.

A generic encoding tag that includes the sub-family letter “U” (for “Univocal”) is associated with a CC for which, after a given input step in the input sequence as described below, such a CC is no longer in conflict with any other CCs of the previous subsets in which it was included, and, the only information to be provided by the user is the selection of such a CC as the targeted CC. In the embodiment to be described below, the selection is made by removing the finger from the touch screen, and the targeted CC will automatically be retrieved from the PDS-db.

A generic encoding tag that includes the sub-family letter “I” (for “In conflict”) is associated with a CC for which, after a given input step in the input sequence as described below, such a CC is still in conflict with one or more other CCs of the previous subsets in which it was included, and, additional information for resolving such conflict is to be provided by the user in a next step.

A generic encoding tag that includes the family letter “D” (for “Directing”) is associated with two or more conflicting CCs in a set of CCs having each the same identical alphabetical phonetic transcription and a Chinese radical assigned to the same group of Chinese radicals. Since there are three groups of Chinese radicals in each partition of Chinese radicals, the family letter “D” is also associated with two or more conflicting CCs in a set of CCs each having a Chinese radical assigned to the same group of Chinese radicals and, moreover, having, as the case may be, an alphabetical phonetic transcription in conflict with the alphabetical phonetic transcription of one or more other CCs, the Chinese radical of which being assigned to the same group of Chinese radicals or to one or two of the two other groups of the same partition of Chinese radicals. In such a case, the approach is to always give one of such conflicting CCs, in each of such groups where there are at least two such conflicting CCs, a precedence based on its frequency of use and the CC having the higher frequency of use (if only two conflicting CCs) or the highest frequency of use (if more than two conflicting CCs) is assigned to the simplest or shortest input path, while the other CCs each having a Chinese radical assigned to the same group of Chinese radicals are each assigned a more complex or longer input path.

CCs with “D” in their encoding tag have therefore been assigned, by convention, an input path comprising the input of their alphabetical phonetic transcription followed by the input of the relevant partition of Chinese radicals, and, when required for solving conflicts between two or more alphabetical transcriptions across groups of the same partition of Chinese radicals, by the input of the level, determined in accordance with the three-level convention described above, of the group of Chinese radicals to which they have been assigned. CCs with “D” in their encoding tag are always positioned in one of the locations of the Central Column of the Ming Tang in the following order of priority: a CC, the Chinese radical of which has been assigned to a level “A” group of Chinese radicals, is positioned in location 5 (indicated by reference number 150); a CC, the Chinese radical of which has been assigned to a level “U” group of Chinese radicals, is positioned in location 8 (indicated by reference number 180); and a CC, the Chinese radical of which has been assigned to a level “O” group of Chinese radicals, is positioned in location 2 (indicated by reference number 120). In some embodiments, shortcuts designed to ease the encoding and input by the user of some CCs may lead to modifying the order of priority described above.

The meanings of each of the 32 generic encoding tags is as follows:

1) Alphabetical phonetic transcription not in conflict (PRUC): If for a given alphabetical phonetic transcription there is no identical alphabetical phonetic transcription in the PDS-db, the input of an initial component and of a final component of that given alphabetical phonetic transcription constitutes, as such, a unique input path for the CC to which it corresponds and no additional input of shape-related or other data is needed. CCs with that characteristic have “PRUC” (for “Phonetic Referential Univocal CC”, in Chinese “ [symbol] ” (“pinyinzi”)) as their encoding tag, and, software in a computerised system in an embodiment of the invention can automatically generate their retrieval from the PDS-db from the mere input of the initial and the final components of their alphabetical phonetic transcription. Examples are the CCs [symbol] (chua), [symbol] (dei), [symbol] (den), [symbol] (dia)”, [symbol] (eng), [symbol] (fo), [symbol] (gei), [symbol] (lia), [symbol] (neng), [symbol] (nuan), [symbol] (seng), [symbol] (shei), [symbol] (zei) and [symbol] (zhei).

The unique code assigned to the CC [symbol] (dei) requires the selection of an initial component (first step) and a final component (second step) of its alphabetical phonetic transcription, followed by two automatic steps, namely, a third input step and a fourth input step, which are automatically performed by the software without any further input from the user. The selection of the initial and final components of the alphabetic phonetic transcription will be described in more detail below and are made by movement over a touch-sensitive input device during which contact is maintained by the finger, for example, of a user with the touch-sensitive input. Removal of the contact, in one embodiment, indicates the targeted CC has been input.

14 of the CCs included in the current PDS-db have “PRUC” as their encoding tag.

2) Maximised simplification for conflicting alphabetical phonetic transcriptions (PRIC): For resolving conflicts between at least two identical alphabetic phonetic transcriptions of CCs where the written CCs are different, the approach is to always give one of them a precedence based on its frequency of use with the CC having the higher frequency of use (where there are two CCs with identical alphabetical phonetic transcriptions) or the CC with the highest frequency of use (where there are more than two CCs having identical alphabetical phonetic transcriptions) being assigned the simplest or shortest input path while the other CCs sharing the same alphabetical phonetic transcription are each assigned a more complex or longer input path in accordance with their descending frequency of use. This is the case for CCs with “PRIC” (for “Phonetic Referential In conflict CC”, in Chinese “ [symbol] ” (“pinquezi”)) as their encoding tag, for which by convention, given their higher frequency of use than other CCs, their alphabetic phonetic transcription alone constitutes their input path. This means that software in a computerised system in an embodiment of the invention can automatically generate their selection from the PDS-db by the mere input of their alphabetical phonetic transcription together with confirmation by the user that the CC selected this way is the targeted CC.

A CC with “PRIC” in its encoding tag does not require more that one or two input steps, followed by the confirmation that it is the targeted CC. A CC with PRIC in its encoding tag therefore does not require the input of a partition of Chinese radicals nor a positioning in the Ming Tang since there is, for such a CC, no need for further ambiguity resolution after the phonetic input steps. An example is the CC [symbol] (da), the unique code of which corresponds to a first input step (initial component), and a second input step (final component) of the alphabetical phonetic transcription of such a CC, followed by confirmation by the user that the CC selected this way is the targeted CC, such confirmation being made by removing the finger from the touch-sensitive input device, in one embodiment. A fourth input step is automatically performed by the software without any further input from the user. The selection of the initial and final components of the alphabetical phonetic transcription and their confirmation will be described in more detail below.

Approximately 4.1% of the CCs included in the current PDS-db have “PRIC” in their encoding tag.

3) Chinese radical not in conflict (SUC): If a given alphabetical phonetic transcription corresponds, in the PDS-db, to one single CC in a set of CCs having each a Chinese radical assigned to the same partition of Chinese radicals, the unique input path for that CC comprises the input of its alphabetical phonetic transcription followed by the input of information corresponding to that same partition. In the PDS-db, CCs with that characteristic have “SUC” (for “Simple Univocal CC”, in Chinese “ [symbol] ” (“dandazi”)) as their encoding tag, and, since the identification of the group of Chinese radicals to which they have been assigned is not a required component of their input path, this identification can optionally be included in their encoding tag, but then in lower case (for example, as “SUCa”, “SUCu”, “SUCo”).

Software in a computerised system in an embodiment of the invention can automatically generate their selection from the PDS-db from the input of their alphabetical phonetic transcription followed by the identification of the relevant partition of Chinese radicals. An example is the CC [symbol] (fan), which is the only CC with “fan” as its alphabetical phonetic transcription among all CCs assigned to the partition of Chinese radicals with [symbol] (kou) as head of such partition. The unique code of the CC [symbol] (fan) corresponds to the unique input path comprising three input steps, namely, a first input step (initial component) and a second input step (final component) of the alphabetical phonetic transcription of such a CC, and a third input step where the head of the partition of Chinese radicals to which such a CC has been assigned is selected. A fourth (input) step is automatically performed by software without any further input from the user.

Approximately 28.3% of the CCs included in the current PDS-db have “SUC” in their encoding tag.

4) Conflicting groups of Chinese radicals (SICA, SICU, SICU-5, SICO): If a given alphabetical phonetic transcription corresponds, in the PDS-db, to one single CC in a group of CCs in a set of CCs each having a Chinese radical assigned to the same partition of Chinese radicals, the direct and unique input path for that single CC comprises the input of its alphabetical phonetic transcription followed by the encoding of the information corresponding to that group of Chinese radicals. In the PDS-db, CC with that characteristic have “SIC” (for “Single but In conflict CC”, in Chinese “ [symbol] ” (“danquezi”)) in their encoding tag.

There are three sorts of CCs with “SIC” in their encoding tag, depending upon the group of Chinese radicals to which they have been assigned and they have therefore “SICA”, “SICU” or “SICO” as their encoding tag, with “A”, “U” and “O” in capital letters since the identification of the group of Chinese radicals to which they have been assigned is a component of their input path. Software in a computerised system in an embodiment of the invention can automatically retrieve such CC from the PDS-db using the input of their alphabetical phonetic transcription followed by the identification of the radical group to which they have been assigned. This identification is twofold: the partition, and the level of their group, identified in accordance with the three-level convention described above.

When positioned in the Ming Tang, CCs with “SIC” in their encoding tag are always positioned in one of the cases of the Central Column in the following order of priority: a CC with “SICA” as its encoding tag is positioned as a matter of priority in location 5 (indicated by reference numeral 150 in FIG. 1); a CC with “SICU” as its encoding tag is positioned as a matter of priority in location 8 (as indicated by reference numeral 180 in FIG. 1); and a CC with “SICO” as its encoding tag is positioned as a matter of priority in location 2 (as indicated by reference numeral 120 in FIG. 1).

However, as a CC with “SICU” as its encoding tag is positioned as a matter of priority in location 5, and therefore such a CC has “SICU-5” as its encoding tag if there are no CCs the Chinese radical of which has been assigned to a group of Chinese radicals of an “A” level in the Ming Tang (corresponding to location 5 and indicated by reference numeral 150 in FIG. 1). In some embodiments, shortcuts designed to ease the encoding and input by the user of some CCs may lead to modifying the order of priority described above.

Examples of CCs are the homophonous CCs [symbol] , [symbol] and [symbol] , each of which having “chen” as their alphabetical phonetic transcription and each of which having been assigned to a different group of Chinese radicals within the same partition of Chinese radicals the head of which is [symbol] (ri). Such three CCs share the same first three input steps, and the three first components of their respective unique code are therefore identical, but encoding each of such CCs requires a different fourth input step.

The unique code of the CC [symbol] (chen), which has “SICA” in its encoding tag, in the fourth input step, requires the selection of a CC positioned in location 5 (as shown by reference numeral 150 in FIG. 1) in the Ming Tang; the unique code of the CC [symbol] (chen), which has “SICU” in its encoding tag, in the fourth input step, requires the selection of a CC positioned in location 8 (as shown by reference numeral 180 in FIG. 1) in the Ming Tang; and the unique code of the CC [symbol] (chen), which has “SICO” in its encoding tag, in the fourth input step, requires the selection of a CC positioned in location 2 (as shown by reference numeral 120 in FIG. 1) in the Ming Tang.

Approximately 18% of the CCs included in the current PDS-db have “SIC” in their encoding tag.

5) Maximised simplification for conflicts within a group of Chinese radicals (DUCABa/u/o, DUCAMa/u/o): When, at the end of the third input step, there are two or more conflicting CCs in a set of CCs each having the same identical alphabetical phonetic transcription and a Chinese radical assigned to the same group of Chinese radicals, the approach is, as described above, to always give one of them a precedence based on its frequency of use with the CC having the higher frequency of use (where there are two conflicting CCs) or the highest frequency of use (where there are more than two conflicting CCs) being assigned the simplest or shortest input path while the other CCs each having a Chinese radical assigned to the same group of Chinese radicals are each assigned a more complex or longer input path in accordance with their frequency of use.

CCs being given such precedence have “DUCAB” (with “AB” for “Added to a Binary list”) as their encoding tag if there is, in the set of conflicting CCs, only one other CC having a Chinese radical assigned to the same group of Chinese radicals. CCs being given such precedence have “DUCAM” (with “AM” for “Added to a list of More than two”) as their encoding tag if there are, in the set, more than one other CC having a Chinese radical assigned to the same group of Chinese radicals.

When positioned in the Ming Tang, a CC with “DUCAB” or “DUCAM” as its encoding tag is always positioned in location 5. Since the input of the group of Chinese radicals to which CCs with “DUCAB” or “DUCAM” have been assigned is not a component of their input path, the identification of such group can optionally be included in their encoding tag but then in lower case (“DUCABa”, “DUCABu”, “DUCABo”, “DUCAMa”, “DUCAMu”, “DUCAMo”).

Examples of such CCs are the homophonous CCs [symbol] and [symbol] , each of which having “mo” as its alphabetical phonetic transcription and each of which having been assigned to the same partition of Chinese radicals the head of which is [symbol] (mu), and, having been assigned, within that partition, to the same group of Chinese radicals. Since the CC [symbol] (mo) is more frequently used than the CC [symbol] (mo), and since in the PDS-db there is no other CC with “mo” as its alphabetical phonetic transcription having been assigned to any of the two other groups of the same partition, the CC [symbol] (mo) is positioned in location 5 in the Ming Tang. The unique code of the CC [symbol] (mo), which has “DUCABa” as its encoding tag, in the fourth input step, requires the selection of a CC positioned in location 5 in the Ming Tang.

Approximately 10.4% of the CCs included in the current PDS-db have “DUC” in their encoding tag.

6) Maximised simplification for conflicts across groups of Chinese radicals (DICABA, DICABU, DICABU-5, DICABO, DICAMA, DICAMU, DICAMU-5, DICAMO): When, at the end of the third input step, there are two or more conflicting CCs in a set of CCs having both an identical alphabetical phonetic transcription and a Chinese radical assigned to the same group of Chinese radicals, and, moreover, being themselves in conflict with one or more other CCs of one or more other groups of the same partition of Chinese radicals, the approach is, as described above, to always give one of them precedence based on its frequency of use with the CC having the higher frequency of use (where there are two conflicting CCs) or the highest frequency of use (where there are more than two conflicting CCs) being assigned the simplest or shortest input path while the other CCs having each a Chinese radical assigned to the same group of Chinese radicals or to another group of Chinese radicals are each assigned a more complex or longer input path in accordance with their frequency of use.

CCs being given such precedence have “DICAB” (with “AB” for “Added to a Binary list”) in their encoding tag if there is, in the set of conflicting CCs, only one other CC having a Chinese radical assigned to the same group of Chinese radicals or to another group of the same partition of Chinese radicals. CCs being given such precedence have “DICAM” (with “AM” for “Added to a list of More than two”) in their encoding tag if there is, in the set, more than one other CC having a Chinese radical assigned to the same group of Chinese radicals.

The letters “A”, “U” or “O” combined to “DICAB” or “DICAM” as an encoding tag indicates that the input path associated with such combined encoding tag requires the input of the group of Chinese radicals to which such CC has been assigned. When positioned in the Ming Tang, CCs with “DICABA”, “DICABU”, “DICABO”, “DICAMA”, “DICAMU” or “DICAMO” as their encoding tag are always positioned in one of the cases of the Central Column in the following order of priority: a CC with “DICABA” or “DICAMA” as its encoding tag is positioned as a matter of priority in location 5; a CC with “DICABU” or “DICAMU” as its encoding tag is positioned as a matter of priority in location 8; and a CC with “DICABO” or “DICAMO” as its encoding tag is positioned as a matter of priority in location 2.

However, a CC with “DICABU” or “DICAMU” as its encoding tag is positioned as a matter of priority in location 5, and has “DICABU-5” or “DICAMU-5” as its encoding tag, if there are no CCs the Chinese radical of which has been assigned to a group of Chinese radicals of an “A” level in the Ming Tang.

Examples are the homophonous CCs [symbol] and [symbol] , each of which having “fu” as its alphabetical phonetic transcription and each of which having been assigned to a different group of Chinese radicals within the same partition of Chinese radicals the head of which is [symbol] (zu). Both CCs share the same first three input steps, and the three first components of their respective unique code are therefore identical, but encoding each of such CCs requires a different fourth input step: the unique code of the CC [symbol] (fu), which has “DICABA” in its encoding tag, in the fourth input step, requires the selection of a CC positioned in location 5 in the Ming Tang; the unique code of the CC [symbol] (fu), which has “DICABO” in its encoding tag, in the fourth input step, requires the selection of a CC positioned in location 2 in the Ming Tang.

Approximately 7.9% of the CCs included in the current PDS-db have “DIC” in their encoding tag.
7) Additional simplification for conflicts within a group of Chinese radicals (BUCABa/u/o, BUCAMa/u/o): When, at the end of the third input step, there are two or more conflicting CCs in a set of CCs each having the same identical alphabetical phonetic transcription and a Chinese radical assigned to the same group of Chinese radicals, and, when, moreover, the first position based on its frequency of use has already been assigned in such set to a CC with “DUCAB” or “DUCAM” as its encoding tag, the approach is always to assign one of the other CCs in the set to a second position based on its frequency of use with the CC having the higher frequency of use (where there are two conflicting CCs) or the highest frequency of use (where there are more than two conflicting CCs) having assigned to it the simplest or shortest input path while the other CCs in the set are each assigned, as the case may be and depending upon the embodiment of the invention, a more complex or longer input path than the CC in the first position and the CC in the second position.

CCs being assigned to such second positions have “BUCAB” (with “AB” for “Added to a Binary list”) as their encoding tag if there is, in the set of conflicting CCs, only one other CC having a Chinese radical assigned to the same group of Chinese radicals. CC being assigned such second position have “BUCAM” (with “AM” for “Added to a list of More than two”) as their encoding tag if there are, in the set, more than one other CC having a Chinese radical assigned to the same group of Chinese radicals.

When positioned in the Ming Tang, a CC with “BUCAB” or “BUCAM” as its encoding tag is always positioned in location 4 and there can be only one such CC in the Ming Tang. Since the input of the group of Chinese radicals to which CCs with “BUCAB” or “BUCAM” have been assigned is not a component of their input path, the identification of such group can optionally be included in their encoding tag but then in lower case (“BUCABa”, “BUCABu”, “BUCABo”, “BUCAMa”, “BUCAMu”, BUCAMo”).

An example of such a CC is the CC [symbol] which is a homophone of the CC [symbol] with “DUCABa” as its encoding tag as described above, both CCs having “mo” as their alphabetical phonetic transcription and each having been assigned to the same partition of Chinese radicals the head of which is [symbol] (mu) and each of such CCs having been assigned, within that partition, to the same group of Chinese radicals. Since the CC [symbol] (mo) is less frequently used than the CC [symbol] (mo), and since, in the PDS-db, there is no other CC with “mo” as its alphabetical phonetic transcription which has been assigned to any of the two other groups of the same partition, the CC [symbol] (mo) is positioned in location 4 in the Ming Tang. The unique code of the CC [symbol] (mo), which has “BUCABa” as its encoding tag, in the fourth input step, requires the selection of a CC positioned in location 4 in the Ming Tang, and is, by convention, the same as selecting the partition of Chinese radicals the head of which is [symbol] (mu).

Approximately 15.7% of the CCs included in the current PDS-db have “BUC” in their encoding tag.

8) Additional simplification for conflicts across groups of Chinese radicals (BICABa/u/o, BICAMa/u/o): When, at the end of the third input step, there are two or more conflicting CCs in a set of CCs having both an identical alphabetical phonetic transcription and a Chinese radical assigned to the same group of Chinese radicals, and, moreover, being themselves in conflict with one or more other CCs of one or more other groups of the same partition of Chinese radicals, and, when, in addition, the first position based on its higher frequency of use has already been assigned in such set to a CC with “DICAB” or “DICAM” as its encoding tag, the approach is to always assign one of the other CCs, in the set, to a second position based on its frequency of use and to assign it the simplest or shortest input path while the other CCs in the set are each assigned a more complex or longer input path than the CC in the first position and the CC in the second position. CCs being assigned such second position have “BICAB” (with “AB” for “Added to a Binary list”) in their encoding tag if there is in the set of conflicting CCs only one other CC having a Chinese radical assigned to the same group of Chinese radicals. CCs being assigned such second position have “BICAM” (with “AM” for “Added to a list of More than two”) in their encoding tag if there are in the set more than one other CC having a Chinese radical assigned to the same group of Chinese radicals.

In the case of such a conflict, precedence is given, over a CC the Chinese radical of which has been assigned to a “U” level and an “O” level, to CCs the Chinese radical of which has been assigned to a group of Chinese radicals of an “A” level, and, precedence is given, over CCs the Chinese radical of which has been assigned to an “O” level, to a CC the Chinese radical of which has been assigned to a group of Chinese radicals of a “U” level and such order of precedence is applied in all cases, except in very few cases as explained below with respect to CCs having “HUCABO” or “HUCAMA” as their encoding tag. The letter “a”, “u” or “o” combined to “BICAB” or “BICAM” as an encoding tag indicates that the input path associated with such combined encoding tag does not require the input of the group of Chinese radicals to which such CC has been assigned. When positioned in the Ming Tang, CCs with “BICAB-a”, “BICAB-u”, “BICAB-o”, “BICAM-a”, “BICAM-u” or “BICAM-o” as their encoding tag are always positioned in location 4, and, there is only one such CC in the Ming Tang.

An example is the CC [symbol] which has “fu” as its alphabetical phonetic transcription and the Chinese radical of which is [symbol] (zu) which is the head of a partition of Chinese radicals. There are, in the PDS-db, four CCs having each “fu” as their alphabetical phonetic transcription and with their respective Chinese radical having been assigned to the same or to a different group of Chinese radicals within the same partition the head of which is [symbol] (zu), that is: the CC [symbol] (fu); the CC [symbol] (fu) with “DICABA” as its encoding tag as described above; the CC [symbol] (fu) with “DICABO” as its encoding tag as described above; and the CC [symbol] (fu) the Chinese radical of which is assigned to the same group of Chinese radicals as the Chinese radical of the CC [symbol] (fu).

The CC [symbol] (fu), with “BICABA” as its encoding tag, is given precedence over the CC [symbol] (fu) which, given its frequency of use, has been assigned a second position among conflicting CC having a Chinese radical assigned to the same group of Chinese radicals of an “O” level and is assigned “HUCABO-5n” as its encoding tag, as described in more detail below. The three first components of the respective unique codes of such four CCs with “fu” as their alphabetical phonetic transcription are identical but encoding each of such CC requires a different fourth input step: the unique code of the CC [symbol] (fu), which has “BICABA” as its encoding tag, in the fourth input step, requires the selection of a CC positioned in location 4 in the Ming Tang.

Approximately 1.5% of the CCs included in the current PDS-db have “BIC” in their encoding tag.

9) Dual input path for less frequently used CCs (HUCa/u/o-Nx): When, at the end of the third input step, there are more than two conflicting CCs in a set of CCs having both an identical alphabetical phonetic transcription and a Chinese radical assigned to the same group of Chinese radicals, the following CCs within such set have been assigned an encoding tag beginning with “H” (for “Homo-phono-iso-radical”): CCs which in the group of Chinese radicals to which they have been assigned have not been given precedence based upon their frequency of use and as a consequence have not been assigned a “D” in their encoding tag and have not been positioned in location 5 in the Ming Tang; and CCs which in the partition of Chinese radicals to which they have been assigned have not been given precedence based upon their frequency of use or based upon the order of priority determined, as described above, by the level of the group of Chinese radicals to which their Chinese radical has been assigned (with level “A” being given precedence over levels “U” and “O” and level “U” being given precedence over level “O”) and as a consequence such CCs have not been assigned a “B” in their encoding tag and have not been positioned in location 4 in the Ming Tang.

CCs with an encoding tag beginning with “H” have been assigned two variations of the last input step among which, in some embodiments of the invention, the user can chose: the first variation is the selection of such a CC in the case where it is positioned in the Ming Tang (FIG. 1) or, as the case may be, in the Second Floor of the Ming Tang (as shown in FIG. 2); and the second variation is the selection of such a CC with one distinct “Secondary Radical” (“ [symbol] ” or “erbushou” in Chinese) associated with each CC with “H” in its encoding tag.

Each distinct Secondary Radical is a piece of information needed for the second variation and related to the shape of the CC other than the shape-related piece of information that comprises the Chinese radical used as a reference to assign the CC to a given group of Chinese radicals. The Secondary Radical is identified in the encoding tag by “x”, where “x” refers to the letter of the Latin alphabet to which the Secondary Radical is assigned, and which can be any letter from “a” to “z” except the letter corresponding to the same partition of Chinese radicals to which the conflicting CCs in a given set have been assigned, which letter in some embodiments of the invention is reserved for the selection of the CC having an encoding tag beginning with “B” and included in the set of conflicting CCs. The allocation of the Secondary Radicals is such that, for a given set of conflicting CCs having both an identical alphabetical phonetic transcription and a Chinese radical assigned to the same partition of Chinese radicals, there is only one Secondary Radical assigned to such partition. All CCs having been assigned an encoding tag beginning with “H” have also “U” (for “Univocal”) in their encoding tag.

It should be noted that the assignation of the Secondary Radicals to specific letters of the Latin alphabet corresponding to a partition of Chinese radicals follows the same assignation as the one chosen for the Chinese radicals as described above. It will readily be understood that this assignation is not relevant to the embodiments described below in which a touch-sensitive surface is used as the input device as the selection in the Ming Tang generated for the resolution of any remaining ambiguities as described below is not based on the shape of such Secondary Radical (second variation of the fourth input step) but on their position in such Ming Tang as described below (first variation of the fourth input step).

Since the group of Chinese radicals to which CCs with an encoding tag beginning with “H” have been assigned is not a component of their input path, the identification of such group by “A”, “U” or “O” can optionally be included in their encoding tag but then in lower case as “a”, “u” or “o” (HUCa-Nx, HUCu-Nx, HUCo-Nx).

For the purposes of the first variation of the last input step, CCs having been assigned an encoding tag beginning with “H” are positioned in the Ming Tang in accordance with the following order of priority: overriding priority in each of the three groups is given to the CC with the highest frequency of use in each of such three groups, and, such CCs, each having “D” in its encoding tag, are always positioned in the Central Column; priority is then given to one of the CCs with the second highest frequency of use in one of such three groups, as described below, and, such a CC is always positioned in location 4 and always has “B” in its encoding tag; other CCs are then positioned, with reference to their frequency of use (starting with the highest), in locations 8 and 2 in that order or location 6 following the sequence of such numbering, and, in doing so, in accordance with the precedence determined, as described above, by the level of the group of Chinese radicals to which their Chinese radical has been assigned, a CC the Chinese radical of which has been assigned to a group of Chinese radicals of an “A” level is positioned as a matter of priority in the Middle Row of the Ming Tang, a CC the Chinese radical of which has been assigned to a group of Chinese radicals of an “U” level is positioned as a matter of priority in the Upper Row of the Ming Tang, and a CC the Chinese radical of which has been assigned to a group of Chinese radicals of an “O” level is positioned as a matter of priority in the Bottom Row of the Ming Tang; if locations 2, 4, 5, 6 and 8 have been populated, the remaining CCs in the set of conflicting CCs are positioned, with reference to their frequency of use (starting with the higher), in locations 9, 3, 7 and 1 in that order.

An example of such a CC is the CC [symbol] (can) which is a homophone of the CC [symbol] (can) and of the CC [symbol] (can). Each of these three CCs has a Chinese radical assigned to the same partition of Chinese radicals the head of which is [symbol] (xin) or [symbol] (xin), a reference to the left portion of the structure of these three CCs. In addition, each of these three CCs [symbol] (can), [symbol] (can) and [symbol] (can)) has a Chinese radical assigned, within that same partition, to the same group of Chinese radicals, since they share the same left portion of their respective structures. Each of these CCs therefore needs another structural element to be able to distinguish it from the other two CCs. Since the CC [symbol] (can) is the least frequently used of these three CCs, and since [symbol] (xin) is inputted at the third input step for selecting the relevant partition and the right portion of the structure of the [symbol] (can) comprises the head of partition [symbol] (ri), [symbol] (ri) is assigned to the CC [symbol] (can) as its Secondary Radical. Therefore, a unique code for the CC [symbol] (can), with “HUCa-6e” as its encoding tag, in the fourth input step, requires the selection of the CC [symbol] (can) positioned in location 6 in the Ming Tang since its Chinese radical is assigned to a group of Chinese radicals of an “A” level. Depending upon the embodiment of the invention, the CC [symbol] (can) positioned in location 6 of the Ming Tang can also be accessed and selected through another unique input path, as described below.

Approximately 12% of the CCs included in the current PDS-db have “HUCa/u/o-Nx” as their encoding tag.

10) Simplification for conflicts of precedence within a same partition (HUCABU-x, HUCABU-6x, HUCABO-x/HUCAMA-x, HUCABO-6x, HUCAMU-x, HUCAMU-6x, HUCAMO-x, HUCAMO-6x): When, at the end of the third input step, there are two or more conflicting CCs in a set of CCs each having both an identical alphabetical phonetic transcription and a Chinese radical assigned to the same group of Chinese radicals, and, moreover, themselves being in conflict with one or more other CCs of one or more other groups of the same partition of Chinese radicals, and, when in addition, the first position based on its frequency of use has already been assigned in each group of the same partition to a CC with “DICAB” or “DICAM” as its encoding tag, and, the second position based on the next highest frequency of use has already been assigned in one of the groups of the partition to a CC with “BICAB” (with “AB” for “Added to a Binary list”) or “BICAM” (with “AM” for “Added to a list of More than two”) in its encoding tag, then each of the other CCs are assigned a second position based on the (higher or highest) frequency of use in one or two of the two other groups of the same partition have “HUCAB” or “HUCAM” as their encoding tags.

A CC has “HUCAB” (with “AB” for “Added to a Binary list”) in its encoding tag if there is, in the set of conflicting CCs, only one other CC having a Chinese radical assigned to the same group of Chinese radicals. A CC has “HUCAM” (with “AM” for “Added to a list of More than two”) in its encoding tag if there is, in the set of conflicting CCs, more than one other CC having a Chinese radical assigned to the same group of Chinese radicals. Each of the letters “A”, “U” or “O” combined with “HUCAB” or “HUCAM” as an encoding tag indicates that the input path for a CC associated with such a combined encoding tag is taking into account the input of the group of Chinese radicals to which such a CC has been assigned.

When positioned in a Ming Tang, CCs with “HUCABU” or “HUCAMU” as their encoding tag are always positioned in location 9, and, there is only one such CC in the Ming Tang; and CCs with “HUCABO” or “HUCAMO” as their encoding tag are always positioned in location 3, and, there is only one such CC in the Ming Tang. However, a CC with “HUCABU” or “HUCAMU” in its encoding tag is positioned as a matter of priority in location 6 and has “HUCABU-6” or “HUCAMU-6” as its encoding tag if there is no CC with “H” in its encoding tag the Chinese radical of which has been assigned to a group of Chinese radicals of an “A” level in the Ming Tang; and a CC with “HUCABO” or “HUCAMO” in its encoding tag is positioned as a matter of priority in location 6 and has “HUCABO-6” or “HUCAMO-6” as its encoding tag if there is no CC with “H” in its encoding tag the Chinese radical of which has been assigned to a group of Chinese radicals of an “A” level or of an “U” level in the Ming Tang.

The CC [symbol] , ( [symbol] ), (bi), given its specific structure, has been assigned “BICAMo” as its encoding tag and positioned in location 4 instead of the CC [symbol] (bi) which has been assigned “HUCAMA” as its encoding tag instead of “BICAMA” (that it should normally having been assigned if positioned in location 4 as required by the standard rules of positioning in a Ming Tang), but since this CC is the only one of its kind in the PDS-db, the encoding tags “HUCAMA” and “BICAMo” are not included in the list of the 32 types of encoding tags as independent tags but as variations of the “HUCAMO” encoding tag. The CC [symbol] ( [symbol] ) (bi) has been assigned “BICAMo” as its encoding tag because, in one embodiment of the invention, CCs with an encoding tag beginning with “B” have been assigned a different input path. The input path for the CC [symbol] , ( [symbol] ) (bi), given its specific structure ( [symbol] ( [symbol] )), would normally require, at the fourth input step, the duplication of the selection of the relevant partition ( [symbol] ( [symbol] ) of Chinese radicals, which would be a departure from the PUDASHU input method if such CC would have been assigned “HUCAMO” as its encoding tag. Therefore, the “HUCAMA” encoding tag has been specifically designed for the CC [symbol] (bi) to allow this particular CC [symbol] ( [symbol] ) (bi), the Chinese radical of which is assigned to an “O” level group of Chinese radicals, to become, by priority over a CC the Chinese radical of which is assigned to an “A” level group of Chinese radicals, a CC of the partition where CC are assigned “BICAMo” as their encoding tag.

Since CCs with “HUCABU”, “HUCABU-6”, “HUCABO”, “HUCABO-6”, “HUCAMU”, “HUCAMA”, “HUCAMU-6”, “HUCAMO” or “HUCAMO-6” as their encoding tag have “H” in their encoding tag, each of them also has a unique input path based upon their Secondary Radical. An example of such a CC is the CC [symbol] (fu), already described above, which has been assigned “HUCABO-6n” as its encoding tag. There are four CCs in the PDS-db each having “fu” as their alphabetical phonetic transcription and with their respective Chinese radical having been assigned to the same or to a different group of Chinese radicals within the same partition the head of which is [symbol] (zu), that is: the CC [symbol] (fu) with “DICABA” as its encoding tag as described above; the CC [symbol] (fu) with “BICABA” as its encoding tag as described above; the CC [symbol] (fu) with “DICABO” as its encoding tag as described above; and the CC [symbol] (fu) with “HUCABO-6n” as its encoding tag which is assigned such tag since it cannot be assigned an encoding tag beginning with “B” or “D”.

Since the Chinese radical of the CC [symbol] (fu) is [symbol] (ya) as a reference to the upper portion of the structure of such a CC and since the bottom portion of the structure of such a CC, that is, its Secondary Radical, is [symbol] (fu) which comprises [symbol] (chi), a Chinese radical assigned to a group of Chinese radicals of a “U” level within the partition the head of which is the Chinese radical [symbol] (chuo), the Secondary Radical of the CC [symbol] (fu) is also assigned the letter “n”, and, the letter “n” is therefore the last component of the encoding tag “HUCABO-6n” of such a CC. Since the Chinese radical [symbol] (ya) of the CC [symbol] (fu) is assigned to the same group of Chinese radicals as the Chinese radical [symbol] (mian) of the CC [symbol] (fu) which has “DICABO” as its encoding tag, and, since there are no more than two CCs in this group of Chinese radicals, the CC [symbol] (fu) has been assigned an encoding tag in which the two letters “AB” indicate, as described above, that such a CC is in conflict with one CC only the Chinese radical of which has been assigned to the same group in the same partition. Since both CCs [symbol] (fu) and [symbol] (fu) have a Chinese radical assigned to a group of Chinese radicals of an “O” level, the CC [symbol] (fu) has been assigned an encoding tag comprising “HUCABo”. However, as in the same set of conflicting CCs, the only other group to which CCs have been assigned which are not the two CCs [symbol] (fu) and [symbol] (fu) in which the Chinese radical has been assigned to a group of an “O” level, is a group of an “A” level which contains also two CCs only, that is, the CC [symbol] (fu) and the CC [symbol] (fu), the CC [symbol] (fu) is positioned in the Ming Tang in location 6 and not, as is the case for a CC having only “HUCABO” as its encoding tag, in location 3.

Approximately 1.5% of the CCs included in the current PDS-db have “HUCABU-x”, “HUCABU-6x”, “HUCABO-x”, “HUCABO-6x”, “HUCAMU-x”, “HUCAMA-x”, “HUCAMU-6x”, “HUCAMO-x” or “HUCAMO-6x” as their encoding tag.

11) Second Floor in exceptional cases (HUCa/u/o-1+5x): In the exceptional cases where, at the end of the third input step, the subset of CCs retrieved from the PDS-db comprises more than nine conflicting CCs each having both an identical alphabetical phonetic transcription and a Chinese radical assigned to the same partition of Chinese radicals, a CC positioned in location 1 in the Ming Tang 100 (FIG. 1) is replicated and positioned also in location 15 of the Second Floor of the Ming Tang (FIG. 2) and has “HUC-1+5x” as its encoding tag, with “x” referring to the partition of Chinese radicals to which the Secondary Radical of such a CC has been assigned. Since the input of the group of Chinese radicals to which CCs with “HUC-1+5x” as their encoding tag have been assigned is not a component of their input path, the identification of such group can optionally be included in their encoding tag but then in lower case (“HUCa-1+5x”, “HUCu-1+5x”, “HUCo-1+5x”). The number of CCs with “HUCa/u/o-1+5x” in their encoding tag is equal to the number of Ming Tang arrangements requiring a Second Floor. There are, as described below, a series of generic arrangements of the Ming Tang and in the current PDS-db there are 14 Ming Tang, allocated among 13 distinct generic arrangements, where the conflicting CC to be positioned are in excess of nine and therefore require a Second Floor.

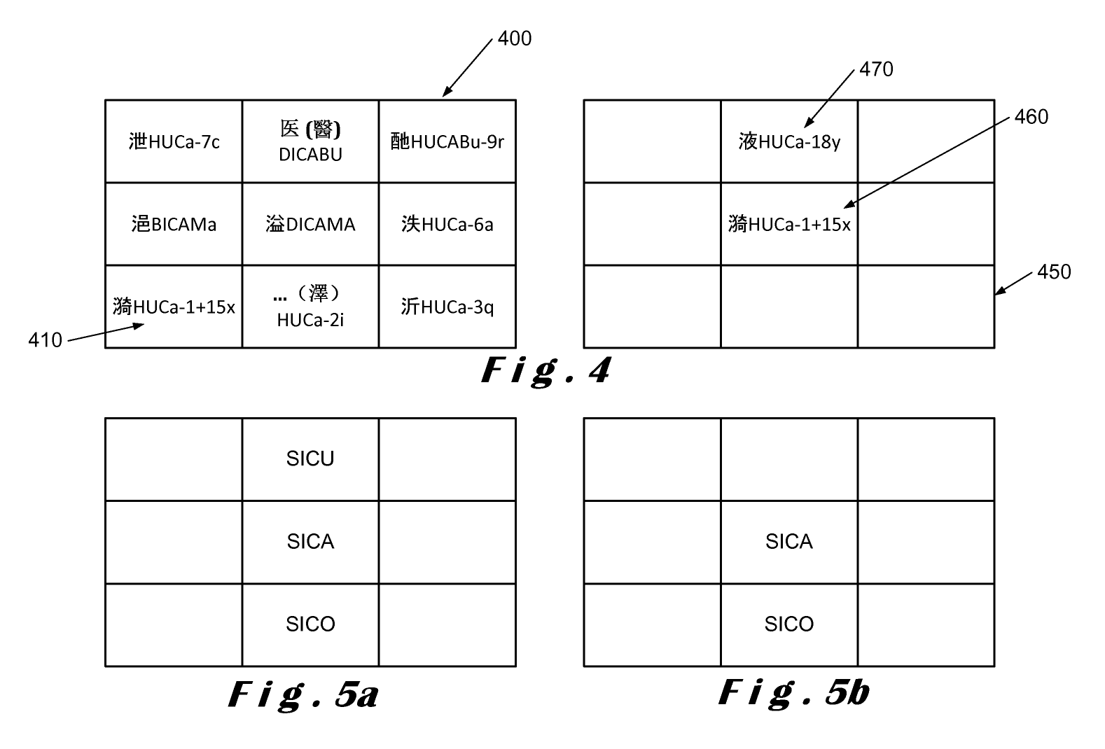

An example of such a CC is the CC [symbol] (yi) which has HUCa-1+5x as its encoding tag and is positioned in a Ming Tang arrangement called “DICAMABU-6” corresponding to only two such Ming Tang in the whole PDS-db, with each such Ming Tang containing 10 CCs. FIG. 3 illustrates a table corresponding to the Ming Tang with “DICAMABU-6” which includes the CC [symbol] (yi) and which requires a Second Floor.

As shown in FIG. 3, such a table comprises: 10 conflicting CCs with their Chinese radicals; the head of the “M” partition to which their Chinese radical is assigned; the encoding tag of each CC comprising the distinct position of each CC in the Ming Tang or in a Second Floor when required; the Secondary Radical of each of such CCs having an encoding tag beginning with “H”; and the key corresponding to the head of partition to which such Secondary Radical is assigned.

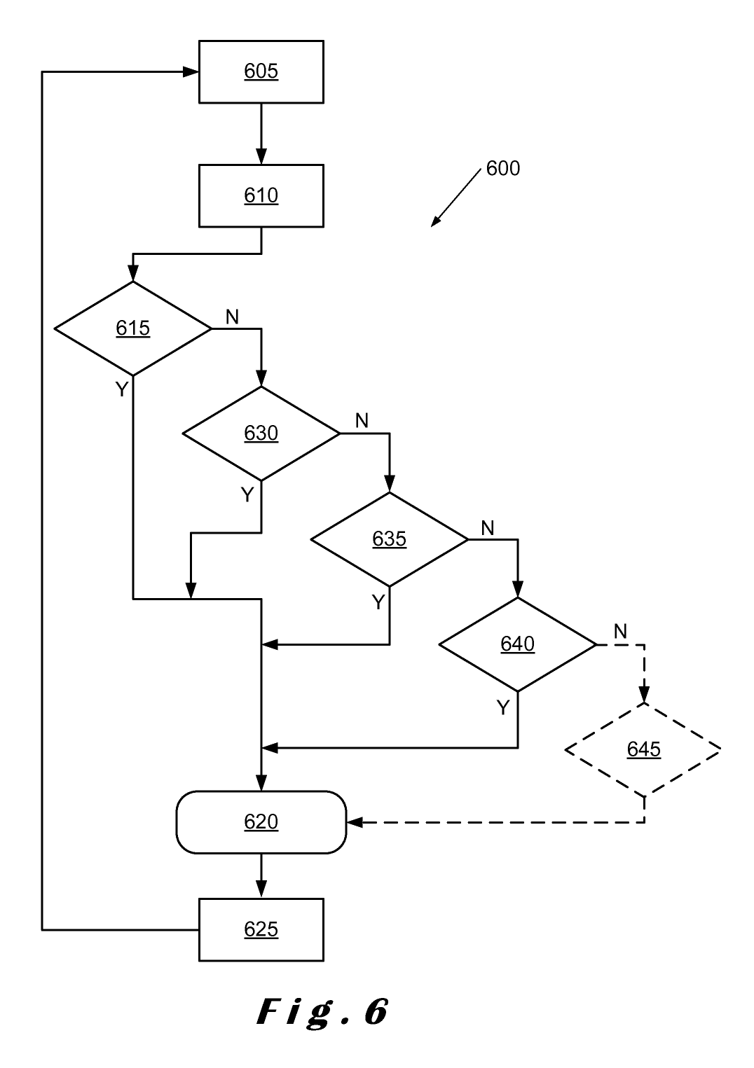

The Ming Tang and the Second Floor for the conflicting CCs of FIG. 3 are shown in FIG. 4. In FIG. 4, a Ming Tang 400 is shown which is fully populated with CCs which necessitates the Second Floor 450 for the additional CCs. The CC [symbol] (yi) with “HUCa-1+5x” as its encoding tag is positioned in both Ming Tang 400 in location 1 as indicated at 410 and the Second Floor 450 in location 15 as indicated at 460 with the remaining conflicting CC in location 18 as indicated at 470.

There are 14 CCs with “HUCa/u/o-1+5x” as their encoding tag in the current PDS-db, that is, 0.15% of the CCs of the current PDS-db.

12) Second floor and dual input path (HUCa/u/o-1Nx): CCs which are positioned in the Second Floor in one of the eight locations other than location 15 have “HUCa/u/o-1Nx” as their encoding tag, with “1N” referring to the location number, that is, from “11” to “14” and from “16” to “19”, for the locations in the Second Floor where each such CC is positioned and assigned to the partition “x” of Chinese radicals to which the Secondary Radical of such a CC has been assigned. CCs with “HUCa/u/o-1Nx” as their encoding tag have been assigned two variations of the last input step among which, in some embodiments of the invention, the user can chose: the first variation is the selection of a CC in the case where it is positioned in the Second Floor; and the second variation is the selection of a CC corresponding to the Secondary Radical of such a CC.

For the purposes of the first variation of the last input step, CCs having been assigned an encoding tag beginning with “HUCa/u/o-1Nx” are positioned in the Second Floor in accordance with the following order of priority: the CC which is displayed in location 1 of the Ming Tang is replicated and positioned in location 15 of the Second Floor; other CCs are then positioned, with reference to their frequency of use (starting with the highest), in locations 18, 12, 14 or 16 in that order, and in doing so, a CC the Chinese radical of which has been assigned to a group of Chinese radicals of an “A” level is positioned in the Middle Row, a CC the Chinese radical of which has been assigned to a group of Chinese radicals of an “U” level is positioned in the Upper Row and a CC the Chinese radical of which has been assigned to a group of Chinese radicals of an “O” level is positioned in the Bottom Row; if cases numbered 15, 18, 12, 14 and 16 have already been populated, the remaining CCs in the set of conflicting CCs are positioned, with reference to their frequency of use (starting with the highest), in case numbers 19, 13, 17 and 11 in that order.

For avoiding conflicts between the two variations of the fourth input step of CCs having ‘H” in their encoding tags, and in anticipation of the inclusion in the PDS-db of additional CCs and of conflicts for which a Second Floor is required: when the list of CCs having “H” in their encoding tag contains CCs the Secondary Radical of which has been assigned to a partition having been assigned “U”, “V”, “W”, “X” or “Y” as described above, cases numbered 18, 19, 13, 12 and 17 are reserved as a matter of priority for positioning CCs which require the use of the corresponding Secondary Radical, that is, case number 18 for “U”, case number 19 for “V”, case number 13 for “W”, case number 12 for “X”, and case number 17 for “Y”.

An example of such a CC is the CC a [symbol] (yi) referred to above which has the Secondary Radical [symbol] (tou) assigned to the letter “Y”. Since none of the CCs included in the current PDS-db creates a conflict among variations of the fourth input step with the CC [symbol] (yi), this CC is positioned in location 18, and, if the addition of a CC to the PDS-db creates a conflict among variations of the fourth input step, the CC [symbol] (yi) could be re-positioned in location 17.

There are 25 CCs with “HUCa/u/o-1Nx” as their encoding tag in the current PDS-db, that is, 0.26% of the CCs of the current PDS-db.

Each alphabetical phonetic transcription of each CC included in the PDS-db for which a positioning in the Ming Tang or in the Second Floor of the Ming Tang is required is also associated in the PDS-db with one generic Ming Tang configuration tag. There are as many possible Ming Tang arrangements as there are sets of conflicting CCs included in the PDS-db and positioned in a Ming Tang after the third step of the input process, but each Ming Tang where each CC in a set of conflicting CCs has been assigned an identical encoding tag constitutes the generic arrangement of such Ming Tang, and, each generic arrangement has been assigned a distinct name, as described in more detail below.

A generic Ming Tang arrangement indicates: the position of a given CC in the Ming Tang based upon the positioning rules associated with the encoding tag of such given CC; and, if this CC is in conflict with other CCs to be also positioned in the Ming Tang, the position in the Ming Tang, or as the case may be in the Second Floor of the Ming Tang, of all CCs to be simultaneously positioned and each simultaneous position is based upon the combination of the positioning rules associated with the encoding tag of each CC. Each Ming Tang configuration tag takes the form of capital letters of the Latin alphabet taken from the encoding tags of CCs positioned together in the Ming Tang.

In addition to the “DICAMABU-6” configuration tag described above, examples of such configuration tags are:

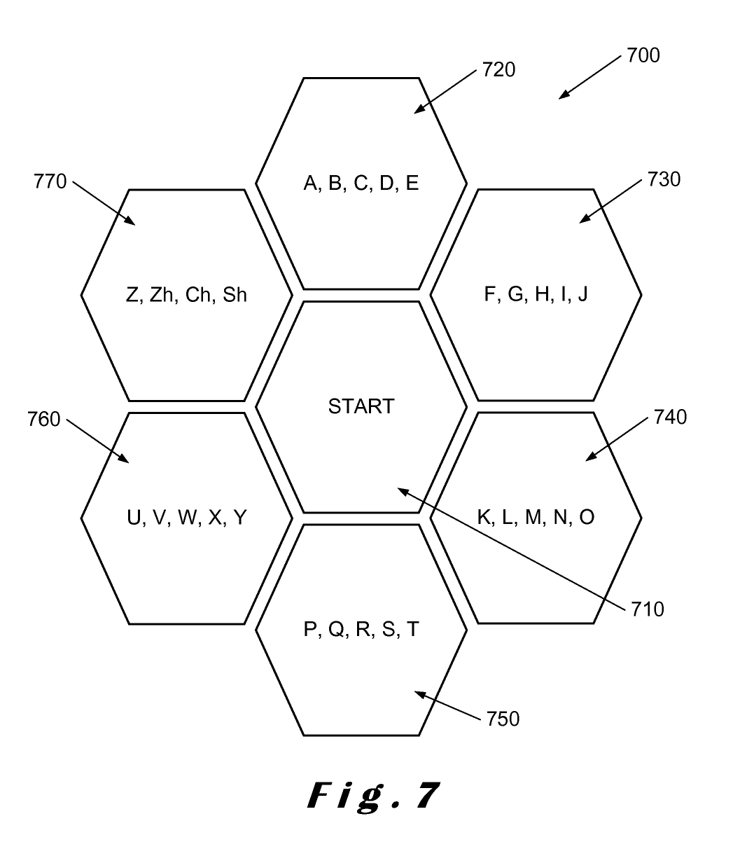

when there are CCs in the Ming Tang with “SICA”, “S(IC)U” and “S(IC)O” in their encoding tag, the Ming Tang configuration name is “SICASUSO” as shown in FIG. 5a; and

when there are only CCs in the Ming Tang with “SICA” and “S(IC)O” in their encoding tag, the Ming Tang configuration name is “SICASO” as shown in FIG. 5b.

Additional rules for handling and solving conflicts between CCs and additional corresponding generic encoding tags and additional generic arrangements of the Ming Tang and corresponding Ming Tang configuration tags can be determined and added to the 32 generic encoding tags and the generic Ming Tang arrangements and Ming Tang configuration tags described above if CCs not currently included in the PDS-db and added to the PDS-db are in conflict with other CCs already included in the PDS-db in such a way that none of the 32 generic encoding tags and the Ming Tang configuration tags described above can adequately describe such conflict and bring the solution to such conflicts.

The 32 generic encoding tags and the generic Ming Tang arrangements are each determined as described above, but other determinations could have been used instead which are compatible with the PUDASHU input method. The positioning of each CC in the Ming Tang is based upon the positioning rules described above but other positioning rules could be used which are compatible with the PUDASHU input method.

The PUDASHU input method allows the input by a user in a computerised system of the data needed for encoding one or more targeted CCs, which the software can then store in the computerised system in a computerised format for further processing purposes, such as, for example and without limitation, the processing and display of the targeted CC in a word processing software, in a messaging software, or in a worldwide web search software. The PUDASHU input method can also, when technically feasible, be embedded or otherwise integrated in any of such software.

The PUDASHU input method relies for its operation on the PDS-db as described above, where a selection of CCs that can be used as targeted CC are stored and systematically classified together with all their possible alphabetical phonetic transcriptions and with the other data described above.

Using the PUDASHU input method comprises, for a given targeted CC stored in the PDS-db, following and traversing a unique input path associated with such targeted CC. As described above, there can be more than one unique input path associated with a given targeted CC since many CCs are heteronyms and therefore have more than one alphabetical phonetic transcription. Traversing a unique input path for a targeted CC is done by means of the sequential input by the user of the PUDASHU method of phonetic, shape-related and other data specific to targeted CCs included in the PDS-db. Each input sequence is made of a maximum of four input steps. At each step of the input sequence, the user resolves ambiguities among the CCs included in the PDS-db by traversing a portion of the unique input path of the targeted CC, which portion the targeted CC shares with one or more other CCs in the PDS-db, and, each additional step of the input sequence brings the user nearer to the portion of the input path which is unique to the targeted CC and with the last input step the user reaches the targeted CC. After each step of the input sequence, the user is presented with a finite number of possibilities the selection of which resolves ambiguity for the next input step. The input sequence ends at the fourth input step, or at an earlier input step in some instances, with the selection by the user and the retrieval in the PDS-db by the software, or in some instances with the automatic retrieval by the software without a selection by the user, of the targeted CC, which the software can then store in the computerised system in a computerised format for further processing.

For selecting from the finite number of possibilities for input offered at each step, the user is guided by an adaptive graphical user interface (“GUI”) displaying the minimum information needed to follow with certainty the unique input path associated with, and giving the user a direct and unambiguous access to, the targeted CC.

The unique input path associated with a given targeted CC is covered in maximum four input steps as described below and taken by the user of the PDS input method from a starting position. The first and the second input steps are based on the alphabetical phonetic transcription of a targeted CC and are said to be “phonetic”. The third input step and the fourth input step are based primarily on pieces of information associated with the shape of such targeted CC and are said to be “shape-related”.

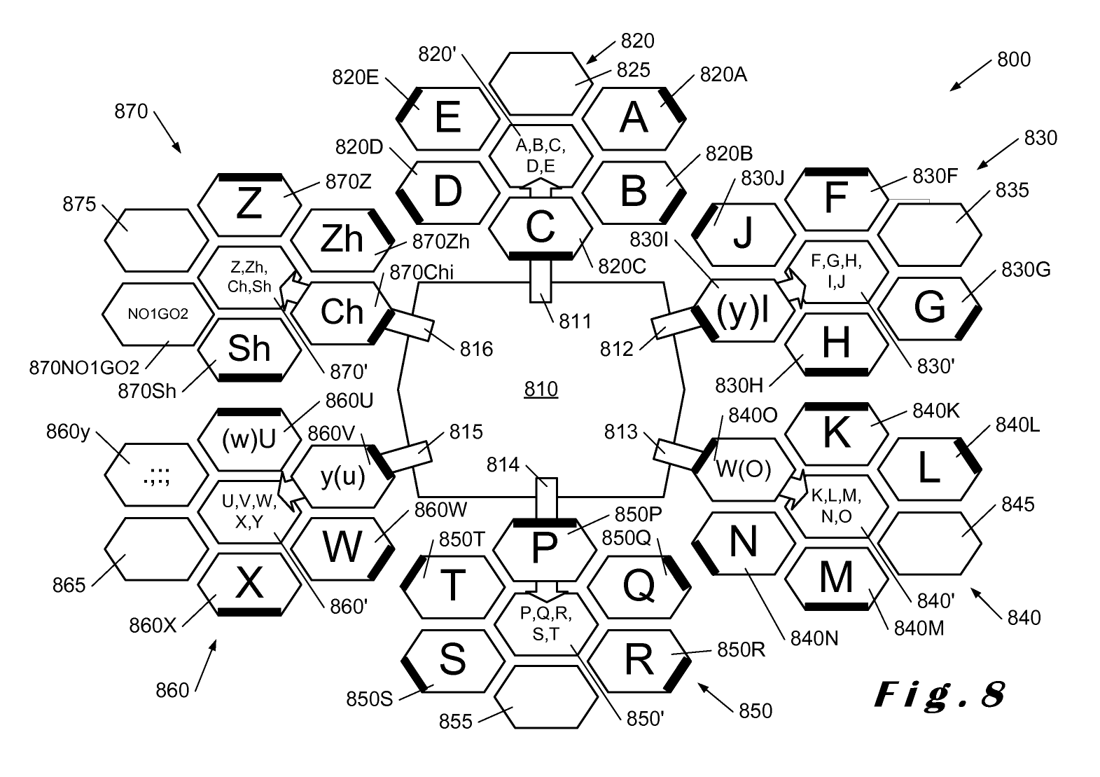

FIG. 6 illustrates a flow chart 600 of the input method in accordance with the present invention. Once a start position (step 605) has been identified, as will be described in more detail below, an array of six first level hexagons is generated around the start position, each hexagon in the array corresponding to a group of initial components of the alphabetical phonetic transcription. As hexagons are used, up to six groups of initial components may be provided. In a preferred embodiment, as will be described in more detail below, all six hexagons are active and populated with groups of initial components.

In step 610, the user selects the first level hexagon corresponding to the group including the initial component of an alphabetical phonetic transcription associated with the targeted CC. A nested sub-array of six second level hexagons is generated around the selected group of initial components associated with the targeted CC. Each nested sub-array of second level hexagons provides a limited number of possible initial components within the selected group of initial components. Selection of one of the second level hexagons effectively selects the initial component from the limited number of possible initial components. As hexagons are used, up to six possible initial components may be provided. In a preferred embodiment, as will be described in more detail below, one hexagon is inactive and only up to five hexagons are active and populated with initial components within the group of initial components.

If the selected initial component comprises a complete alphabetical phonetic transcription which corresponds to the targeted CC (step 615), the targeted CC is selected (step 620) and the input method ends (step 625) as the targeted CC has been selected. If another CC is to be input, the user re-starts at step 605.

In step 630, if the selected initial component requires a final component of an alphabetical phonetic transcription to provide the targeted CC, an array of six third level hexagons is generated around the selected initial component. Each third level hexagon corresponds to a group of final components of the alphabetical phonetic transcription which are compatible with the selected initial component of the alphabetical phonetic transcription. As hexagons are used, up to six possible groups of final components may be provided. In a preferred embodiment, as will be described in more detail below, all six hexagons are active and populated with groups of final components.

The user selects the group of final components containing the final component relating to the targeted CC. A nested sub-array of six fourth level hexagons are generated around the selected third level hexagon corresponding to the group of final components which provides a limited number of possible final components. As hexagons are used, up to six possible final components may be provided. In a preferred embodiment, as will be described in more detail below, one hexagon is inactive and only up to five hexagons are active and populated with final components within the group of final components.

The user selects the final component from one of the fourth level hexagons to provide the complete alphabetical phonetic transcription corresponding to the targeted CC. If this complete alphabetical phonetic transcription comprises the targeted CC, the method is advanced to the selection step, step 620, and the end step, step 625. Again, if another CC is to be input, the user re-starts at step 605.

If the complete alphabetical phonetic transcription does not provide the targeted CC, the user needs to select an appropriate Chinese radical in accordance with the selected complete alphabetical phonetic transcription (step 635). In this case, an array of six fifth level hexagons is generated around the selected complete alphabetic phonetic transcription. Each fifth level hexagon comprises a group of Chinese radicals corresponding to the selected complete alphabetical phonetic transcription. As hexagons are used, up to six possible groups of Chinese radicals may be provided. In a preferred embodiment, as will be described in more detail below, all six hexagons are active and populated with groups of Chinese radicals.

Selection of one of the groups of Chinese radicals generates a nested sub-array of six sixth level hexagons around the selected group of Chinese radicals. As hexagons are used, up to six possible Chinese radicals may be provided. In a preferred embodiment, as will be described in more detail below, one hexagon is inactive and only up to five hexagons are active and populated with Chinese radicals. If the selection of the Chinese radical provides the targeted CC, the method is advanced to the selection step, step 620, and the end step, step 625. Again, if another CC is to be input, the user re-starts at step 605.

If the Chinese radical does not provide the targeted CC, the user moves into the Ming Tang (step 640) to select the targeted CC. In this case, as the Ming Tang comprises a square matrix, in a preferred embodiment, a 3×3 matrix, there are nine locations in each of which one CC can be positioned in accordance with the group to which its Chinese radical has been assigned and with its frequency of use as described above. The Ming Tang is generated with location 5 corresponding to an end point from the previous input step. If the selection of the CC in the Ming Tang provides the targeted CC, the method is advanced to the selection step, step 620, and the end step, step 625. Again, if another CC is to be input, the user re-starts at step 605.

In the minority of cases where the Ming Tang does not provide the targeted CC, the user needs to move to the Second Floor of the Ming Tang (step 645) to input the targeted CC. As described above, the Second Floor is preferably the same format as the Ming Tang with a link being provided from location 1 in the Ming Tang to location 15 of the Second Floor. If the targeted CC is not present in the Ming Tang, the user moves to location 1 to be linked to location 15 of the Second Floor. Moving to location 1 of the Ming Tang generates the Second Floor around location 1 with the link to location 15 in the Second Floor. The user selects the targeted CC in the Second Floor, and the method is advanced to the selection step, step 620, and the end step, step 625. Again, if another CC is to be input, the user re-starts at step 605. It will readily be appreciated that the Ming Tang comprises the fourth input step if needed where the Second Floor only makes more CCs available for selection as described above.

In some instances, the user may choose to bypass the first input step by selecting a shortcut to the second input step as will be described in more detail below. When the targeted CC is a Secondary Alphabetical CC as described below, the second input step may comprise a single input step which provides the targeted CC. When the targeted CC is not a Secondary Alphabetical CC but has the same alphabetical phonetic transcription as the Secondary Alphabetical CC, the second input step is followed by at least the third input step for the selection of the Chinese radical.

At the end of each of the first and the second input steps in a given input sequence, software in the computerised system displays in a selection window (“Selection Window”) associated therewith, one CC from the finite number of possible selections presented to the user, which CC the user can select if it is the targeted CC, and, such a CC is called “Emperor CC” because it is displayed in a central location which is the same as the central location in the Ming Tang. In such case, there is no need to perform the next input steps or step and the software will detect such selection and will return to a starting position allowing the user to begin a new input sequence for encoding another targeted CC.

A CC displayed in the Selection Window at the end of the first input step or of the second input step is a CC to which such precedence has been given based upon its frequency of use and which has been assigned a simplest or shortest encoding path as described above. If a CC displayed by the software in the Selection Window is not the targeted CC, the user must proceed to the next step for effecting ambiguity resolution from among CCs in the PDS-db sharing at least a portion of the input path not yet traversed by the user.

At the end of the third input step in a given input sequence, the software in the computerised system displays a Ming Tang with a CC positioned in the middle thereof (in location 5 as shown in FIG. 1). Such a CC in the middle of the Ming Tang is called the “Emperor CC”, to which such precedence has been given based upon its frequency of use and the positioning rules described above, and which the user can select if it is the targeted CC.

For the purposes of shortening the input sequence of a series of CC, if a CC about to be displayed by the software in the Selection Window after the second input step (having thus “PRUC” as its encoding tag) or about to be displayed as the Emperor CC in the Ming Tang after the third input step (having thus “SUC” as its encoding tag), does not require any further ambiguity resolution because it does not share, with any other CC in the PDS-db, a portion not yet traversed of its input path, then the software automatically associates such a CC with the targeted CC and no further CCs are displayed in the Selection Window or in the Ming Tang. In such a case, the user does not need to select such CC and the software automatically retrieves the targeted CC from the PDS-db and stores it in the computerised system in a computerised format for further processing, and, returns to a starting position allowing the user to begin a new input sequence of maximum four steps for encoding another targeted CC.

The method also provides, as described in more detail below, the means of inserting: a space; one or more punctuation symbols; or other symbols. In addition, the method also provides means of deleting CCs, punctuation and other symbols; and means of performing a backspace, an insert, a validation or other functions, if the user so wishes before beginning a new input sequence. Shortcuts allowing the user to speed up the encoding process; and guidance for the user, in the form of colours in a graphical user interface (“GUI”) and/or sounds and/or vibrations and/or any other suitable guidance may also be provided.

In one embodiment of the present invention, the PUDASHU input method is applied to a touch-sensitive surface and an associated graphical user interface (“GUI”), and is called IBEEZI. The touch-sensitive surface can be any computing device that receives from a user tactile input or input through any object. The user interacts with the computerised system and with the GUI typically through finger contact and finger movements on the touch-sensitive surface. The touch-sensitive surface can be a touch-sensitive display, also known as “touch screen”, where the touch-sensitive surface both displays to the user in a GUI information generated by the computerised system and receives information from the user.

It will be readily appreciated that although the description of this embodiment of the invention refers to such a touch-sensitive display, the touch-sensitive surface can also be a touch-sensitive surface without display, such as, a track pad or a region of a touch-sensitive display, that receives information from the user, and, in such a case, the information generated by the computerised system can be displayed to the user, in a GUI distinct from the touch-sensitive surface, and, the GUI can also display a replication of the finger contacts and finger movements made by the user on the touch-sensitive surface.

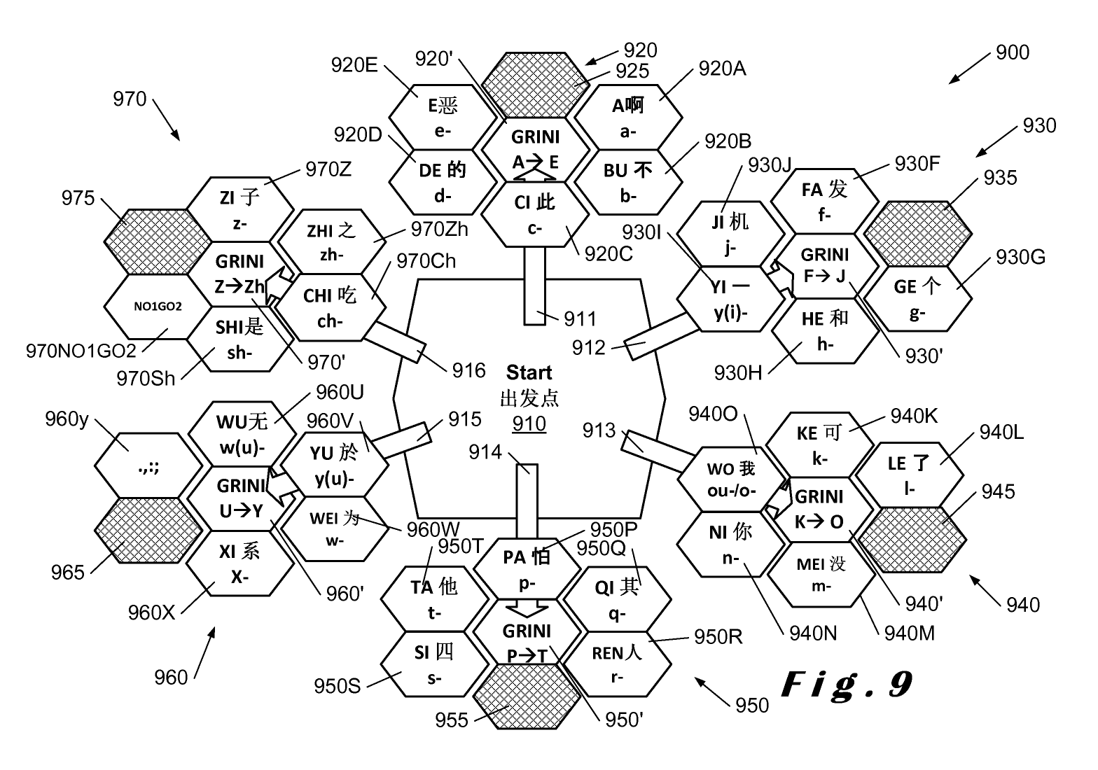

For the first input step, called “Initial Phonetic step”, a selection is made from among 30 possibilities, each possibility corresponding to a distinct initial component and presented by the software to the user. The 30 distinct initial components are presented to the user in a first arrangement 700 which takes the form of a first set of six hexagons surrounding a central hexagon as shown in FIG. 7.

In accordance with one embodiment, the first arrangement 700 is generated around a position selected by the user on the touch-sensitive surface. This position can be randomly chosen by the user and the software generates the first set of six hexagons around that position.

In FIG. 7, as the arrangement 700 comprising a central hexagon 710 with six hexagons 720, 730, 740, 750, 760, 770 surrounding the central hexagon 710. Each of the hexagons 720, 730, 740, 750, 760, 770 operates as a distinct key that the user, starting from the central hexagon 710, can activate by moving his finger on the touch-sensitive surface in the direction, and into the perimeter, of the relevant surrounding hexagon 720, 730, 740, 750, 760, 770.

In FIG. 7, each surrounding hexagon 720, 730, 740, 750, 760, 770 has initial components assigned to it as shown, and comprises one of the groups of initial components (referred to hereinafter as a “GRINI”). The grouping of the initial components of the alphabetic phonetic transcription shown in the GRINI, as described with reference to FIGS. 7, 8 and 9 has been made coherent with the order of the Latin alphabet. Hexagon 720 has initial components “a-”, “b-”, “c-”, “d-” and “e-”; hexagon 730 has initial components “f-”, “g-”, “h-”, “y(i)-” and “j-”; hexagon 740 has initial components “k-”, “l-”, “m-”, “n-”, “wo-”, “o-” and “ou-”; hexagon 750 has initial components “p-”, “q-”, “r-”, “s-” and “t-”; hexagon 760 has initial components “w(u)”, “ii-” (instead of the “v” letter which is not used in Pinyin), “w-” and “x-”, with “y” which is assigned a specific function as described in more detail below; and hexagon 770 has initial components “z-”, “zh-”, “ch-” and “sh-”. In addition, an additional location (not shown) is provided in hexagon 770 for specific functions. This hexagon arrangement 700 can be referred to as a first level hexagon arrangement.

It will readily be appreciated that although hexagons are described and used, as they can be more closely packed together around a central hexagon, the regions represented by the hexagons can be represented by other shapes or in any other suitable manner.

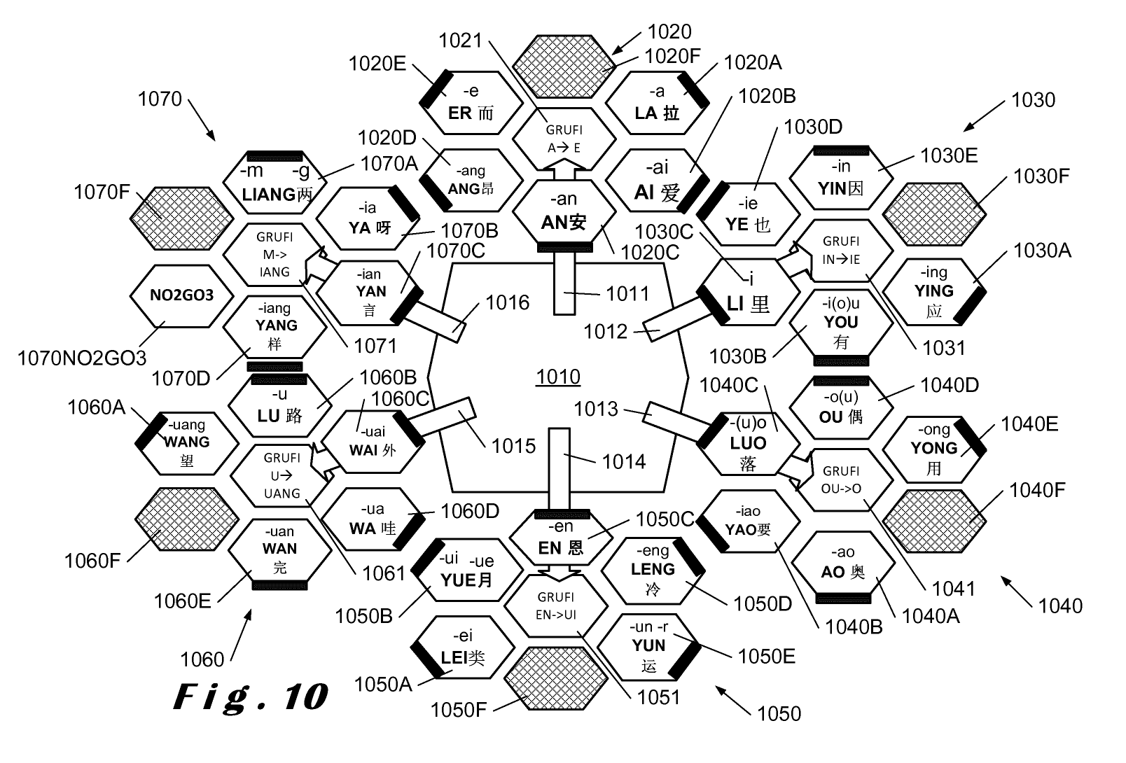

Movement by the user into one of the first level hexagons 720, 730, 740, 750, 760, 770 from the central hexagon 710 creates second level hexagon arrangements, centred on respective ones of hexagons 720, 730, 740, 750, 760, 770. This is shown in FIG. 8. It will readily be understood that, although the second level hexagon arrangements are shown for each of the hexagons 720, 730, 740, 750, 760, 770, during the input process, only one second level hexagon arrangement would be available for selection at a time in accordance with the first level hexagon selected. For example, if first level hexagon 720 is chosen, only the second level hexagons containing the initial component of the alphabetical phonetic transcription of the targeted CC will be displayed, that is, the initial components “a-”, “b-”, “c-”, “d-” and “e-” as shown in FIG. 8. Similarly, the respective initial components associated with each of the other first level hexagons 730, 740, 750, 760, 770 will be displayed when the associated first level hexagon is selected.

The 30 distinct initial components are arranged in an arrangement 800 of hexagons as shown in FIG. 8, hexagons 810, 820, 830, 840, 850, 860, 870 corresponding to respective ones of hexagons 710, 720, 730, 740, 750, 760, 770 in the hexagon arrangement 700 shown in FIG. 7. Hexagon 810 corresponds to the start position as before and each first level hexagon 820, 830, 840, 850, 860, 870 has an arrangement of second level hexagons associated with it as will be described in more detail below. The assignment of the initial components in the first level hexagons 820, 830, 840, 850, 860, 870 is as follows:

the initial components “a-”, “b-”, “c-”, “d-”, “e-” are assigned to hexagons 820A, 820B, 820C, 820D, 820E respectively in the second level hexagons corresponding to first level hexagon 820, and, hexagon 825 is kept empty and inactive as will be described in more detail below;

the initial components “f-”, “g-”, “h-”, “i-” (also written “yi-” or “y-” in Pinyin as an initial component, when it is not followed by the final component “-ü”, as in “yu”, “yuan”, “yue” or “yun”, or by the final component “-ong” as in “yong”), “j-” are assigned to hexagons 830F, 830G, 830H, 830I, 830J respectively in the second level hexagons corresponding to first level hexagon 830, and, hexagon 835 is kept empty and inactive as will be described in more detail below;

the initial components “k-”, “l-”, “m-”, “n-”, are assigned to hexagons 840K, 840L, 840M, 840N, respectively and the initial components “o-”, “wo-” and “ou-”, which are not at this stage considered as being distinct, are assigned to hexagon 840O in the second level hexagons corresponding to first level hexagon 840, and, hexagon 845 is kept empty and inactive as will be described in more detail below;

the initial components “p-”, “q-”, “r-”, “s-”, “t-” are assigned to hexagons 850P, 850Q, 850R, 850S, 850T respectively in the second level hexagons corresponding to first level hexagon 850, and, hexagon 855 is kept empty and inactive as will be described in more detail below;

the initial components “(w)u”, “u-” (written “yu-” in Pinyin), “x-” and the “y” key, which is assigned a specific function of, when selected, initiating a process for inserting a punctuation or other symbol—these components being assigned to hexagons 860U, 860V, 860X, 860Y respectively, and the initial component “w-”, when it is not followed by the final component “-o” as in “wo” (assigned to hexagon 840O) or “-u” as in “wu” (assigned to hexagon 860U) is assigned to hexagon 860W in the second level hexagons corresponding to first level hexagon 860, and, hexagon 865 is kept empty and inactive as will be described in more detail below; and

the initial components “z-”, “zh-”, “ch-”, “sh-” are assigned to hexagons 870Z, 870Zh, 870Ch, 870Sh, respectively, and, a “shortcut” function is assigned to hexagon 870NO1GO2 in the second level hexagons corresponding to first level hexagon 870, and, hexagon 875 is kept empty and inactive as will be described in more detail below.

Each of the hexagons in any of the second level hexagons that is positioned in the same direction as the first movement made from the central hexagon of the first level hexagons is not assigned any function and is empty and inactive. As shown in FIG. 8, these six empty hexagons are hexagons 825, 835, 845, 855, 865 and 875, and, if the user moves his finger on the touch-sensitive surface from a central hexagon 820′, 830′, 840′, 850′, 860′, 870′ in the direction of respective ones of these empty hexagon 825, 835, 845, 855, 865 and 875, the software registers this movement as an extension of the movement made by the user in the same direction from the central hexagon of the first level hexagons in the direction, indicated by arrows 811, 812, 813, 814, 815, 816, and not as a different movement. It will be appreciated that one or more of these empty and inactive hexagons can be assigned a function that the user can select.

In this embodiment of the present invention, the 30 distinct initial components are allocated to the first and second level hexagons as described above but it will readily be appreciated that other allocations are possible and that several distinct functions can also be assigned to the same hexagon.

The launching by the user of the software that implements this embodiment of the invention activates the touch-sensitive surface, which becomes ready to receive an input from the user, and displays a GUI, which when it appears, notifies the user that the system is ready to accept the input for a targeted CC. Once the user establishes an initial finger contact, and, maintains such contact with any part of the activated touch-sensitive surface, that is, a single spot contact without a movement in any direction, the software generates a display, around the position of such initial finger contact, of the first level hexagons, irrespective of the positioning on the touch-sensitive surface such finger initial contact is established.

Once the finger of the user is positioned in the central hexagon surrounded by the six first level hexagons, the user then, without lifting the finger from the touch-sensitive surface, selects the GRINI corresponding to the initial component of the targeted CC with the exceptions of “y”, hexagon 860Y, to which the specific function, when activated, of initiating a process for inserting a punctuation or other symbol is assigned, and, the hexagon 870NO1GO2, as will be described in more detail below.

The user makes the selection by moving the finger on the touch-sensitive surface from the central hexagon 810 in the direction of the hexagon corresponding to the desired GRINI, as indicated by arrows 811, 812, 813, 814, 815, 816 as shown in FIG. 8, and into the perimeter of such a hexagon, without lifting the finger from the touch-sensitive surface during and at the end of such movement. As described above, hexagons 820, 830, 840, 850, 860, 870 correspond to the GRINIs.

The software detects that the finger has moved and also detects the direction of such movement and/or the fact that the finger has moved into the perimeter of one of such hexagons and as a consequence identifies the GRINI that the user has selected.

The selection by the user of such GRINI in the relevant first level hexagon suppresses the display of the first level hexagons (under control of the software), and activates and displays, around the position of the finger of the user on the touch-sensitive surface, the layout of the second level hexagons that corresponds to the selected GRINI, in a position on the touch-sensitive surface where the finger is located after the movement into the selected GRINI, resulting in the finger being automatically positioned in the central hexagon surrounded by the six second level hexagons.

Once the finger of the user is positioned in the central hexagon surrounded by the six second level hexagons, the user then, without lifting the finger from the touch-sensitive surface, selects from the second level hexagons the initial component corresponding to the targeted CC (or selects “y” (hexagon 860Y) or selects 870NO1GO2), by moving such finger on the touch-sensitive surface from the central hexagon in the direction of the hexagon corresponding to such initial component (or to hexagon 860Y corresponding to the insertion of punctuation etc. as described above) and into the perimeter of the relevant hexagon, without lifting such finger from the touch-sensitive surface during and at the end of such movement.

Selection of the hexagon 870NO1GO2 moves the user from the selection hexagons (first level and second level hexagons) for the initial component of the alphabetical phonetic transcription of the targeted CC to the selection hexagons (third and fourth level hexagons) for the final component of the alphabetical phonetic transcription of the targeted CC. In this case, the hexagon 870NO1GO2 is used as a “shortcut” to transition the user from the first input step to the second input step without having first selected an initial component in the first input step.

Movements on the touch-sensitive surface for selecting hexagon 870NO1GO2 are as follows: starting from hexagon 810 in the first level hexagons, the user moves his finger in the direction of hexagon 870 and into the perimeter of that hexagon, which triggers the display of second level hexagons with hexagon 870′ as the central hexagon; the user then moves his finger from hexagon 870′ in the direction of hexagon 870NO1GO2 and into the perimeter of that hexagon, without lifting his finger from the touch-sensitive surface at the end of such movement.

In this embodiment of the invention, if the selected initial component is a complete alphabetical phonetic transcription and corresponds to an Alphabetical CC as described below and to the targeted CC, and if the user lifts the finger from the touch-sensitive surface, the software detects that the finger is no longer in contact with the touch-sensitive surface and automatically confirms the selection made.

As long as the software that implements this embodiment of the invention remains active, any such new initial spot contact after the user has lifted his finger from the touch-sensitive surface results in such finger being automatically positioned on the touch-sensitive-surface in the central hexagon surrounded by the six first level hexagons.

For the purposes of shortening the input sequence for the encoding of a series of CCs, the hexagon 870NO1GO2 described above is assigned the function, when activated by the user, of bypassing the first input step and allowing the user to select, at the second input step, as described below, some of the alphabetical phonetic transcriptions which have been assigned to each one of the 29 hexagons in fourth level hexagons, and which also correspond to 29 CCs, called “Secondary Alphabetical CCs” (“ [symbol] ” or “momuzi” in Chinese) and having “PRIC” as their encoding tag and not being one of such Alphabetical CCs, as described in more detail below.

The user selects the hexagon 870NO1GO2 by moving his finger on the touch-sensitive surface from the central hexagon 870′ in the direction, and into the perimeter, of hexagon 870NO1GO2. As an alternative hexagon 870NO1GO2 can be selected, by moving the finger counter-clockwise on the touch-sensitive surface within the perimeter of central hexagon 810′ without lifting the finger from the touch-sensitive surface at the end of the counter-clockwise movement.

Effective activation of the hexagon 870NO1GO2 triggers the suppression by the software of the display of the second level hexagons and the activation and the display around the position of the finger of the user on the touch-sensitive surface of the layout of third level hexagons corresponding to the first stage of the final component selection of the alphabetical phonetic transcription of the targeted CC, with the finger being automatically positioned within the perimeter of the central hexagon for selecting the Secondary Alphabetical CC that corresponds to the targeted CC. The user proceeds as described below with respect to the selection of one of the 29 Secondary Alphabetical CCs at the second input step. Effective activation of the hexagon 870NO1GO2 also triggers the retrieval, in the PDS-db by the software, of a specific subset of CCs comprising only the 29 Secondary Alphabetical CCs and the CCs for which the alphabetical phonetic transcription is identical to the alphabetical phonetic transcription of one of the 29 Secondary Alphabetical CCs.

The selection by the user of an initial component in the relevant second level hexagon triggers, as described above, the retrieval, in the PDS-db by the software, of a first subset of CCs comprising only CCs to which corresponds an alphabetical phonetic transcription the initial component of which is the same as the initial component selected by the user or the same as one of the three initial components “o-”, “wo-” and “ou-”, which are not at this stage considered as being distinct, assigned to hexagon 840O as described above. Such selection by the user also triggers, for the purposes of the second input step where the user resolves ambiguities within such a subset of CCs sharing the same initial component, the generation of an appropriate layout or arrangement by the software as will be described in more detail below.

For the purposes of shortening the input sequence for the encoding of a series of CCs, each one of the 28 hexagons in the second level hexagons that has been assigned one distinct initial component, is, in addition assigned one single distinct complete alphabetical phonetic transcription, either made of the combination of the distinct initial component assigned to such hexagon or made of a vowel that constitutes a complete alphabetical phonetic transcription in itself.

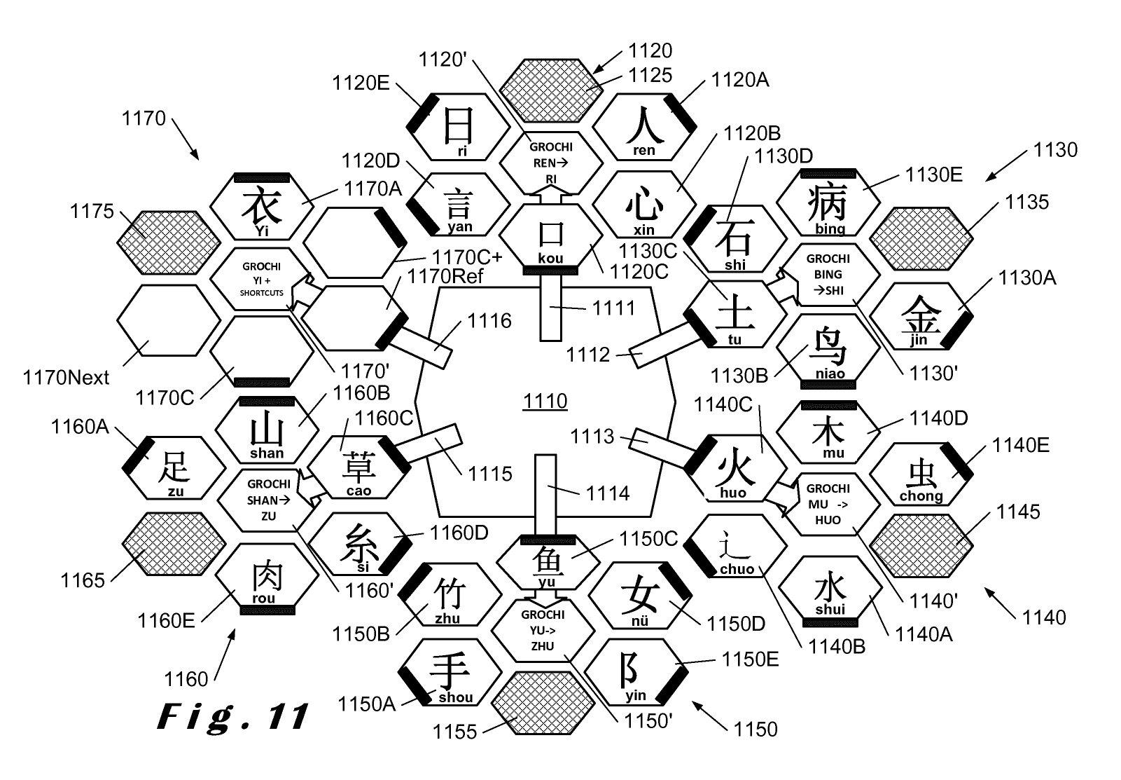

Each of such complete alphabetical phonetic transcriptions corresponds to a distinct CC having “PRIC” as its encoding tag and being called an “Alphabetical CC” (“ [symbol] ” or “zimuzi” in Chinese). Referring to FIG. 9, each of such 28 Alphabetical CC is assigned to a hexagon together with the corresponding alphabetical phonetic transcription and the relevant initial component. FIG. 9 is similar to FIG. 8, and, each element shown in FIG. 9 is referenced in a similar way to its corresponding element in FIG. 8 with the elements in FIG. 9 being in the ‘900’ range compared to the elements in the ‘800’ range shown in FIG. 8.

FIG. 9 shows each of the 28 Alphabetical CCs in addition to the relevant initial component in the relevant hexagon so as to make it visible to the user. An Alphabetical CC is also the only CC displayed in the Selection Window, such display being triggered by the selection by the user of one of the 28 initial components in the relevant hexagon of the second level hexagons. Since for such 28 Alphabetical CCs no ambiguity resolution is needed, the software automatically generates the retrieval of each of such 28 Alphabetical CCs in the PDS-db and then stores it in the computerised system in a computerised format for further processing from the mere selection of the relevant complete alphabetical phonetic transcription followed by the confirmation that such complete alphabetical phonetic transcription corresponds to the targeted CC. Such confirmation is performed by the user lifting the finger from the touch-sensitive surface after having moved the finger, on the touch-sensitive surface in the direction, and into the perimeter, of the relevant second level hexagon, the software detecting such lifting, and, in response automatically performing the confirmation. The software returns to a starting position allowing the user to begin a new input sequence for encoding another targeted CC once the confirmation has been performed.

As shown in FIG. 9, the assignment of the initial components and of the Alphabetical CCs in the first level hexagons 920, 930, 940, 950, 960, 970 is as follows:

the initial components “a-” and the Alphabetical CC [symbol] for which “a” is the complete alphabetical phonetic transcription, “b-” and the Alphabetical CC [symbol] for which “bu” is the complete alphabetical phonetic transcription, “c-” and the Alphabetical CC [symbol] for which “ci” is the complete alphabetical phonetic transcription, “d-” and the Alphabetical CC [symbol] for which “de” is the complete alphabetical phonetic transcription, “e-” and the Alphabetical CC [symbol] for which “e” is the complete alphabetical phonetic transcription are assigned to hexagons 920A, 920B, 920C, 920D, 920E respectively in the second level hexagons corresponding to first level hexagon 920, and, hexagon 925 is kept empty and inactive;

the initial components “f-” and the Alphabetical CC [symbol] ( [symbol] ) for which “fa” is the complete alphabetical phonetic transcription, “g-” and the Alphabetical CC [symbol] ( [symbol] ) for which “ge” is the complete alphabetical phonetic transcription, “h-” and the Alphabetical CC [symbol] for which “he” is the complete alphabetical phonetic transcription, “i-” (also written “yi-” or “y-” in Pinyin as an initial component, when it is not followed by the final component “-ü”, as in “yu”, “yuan”, “yue” or “yun”, or by the final component “-ong” as in “yong”) and the Alphabetical CC [symbol] for which “yi” is the complete alphabetical phonetic transcription, “j-” and the Alphabetical CC [symbol] ( [symbol] ) for which “ji” is the complete alphabetical phonetic transcription are assigned to hexagons 930F, 930G, 930H, 930I, 930J respectively in the second level hexagons corresponding to first level hexagon 930, and, hexagon 935 is kept empty and inactive;

the initial components “k-” and the Alphabetical CC [symbol] for which “ke” is the complete alphabetical phonetic transcription, “l-” and the Alphabetical CC [symbol] for which “le” is the complete alphabetical phonetic transcription, “m-” and the Alphabetical CC [symbol] for which “mei” is the complete alphabetical phonetic transcription, “n-” and the Alphabetical CC [symbol] for which “ni” is the complete alphabetical phonetic transcription, are assigned to hexagons 940K, 940L, 940M, 940N, respectively and the initial components “wo-”, “ou-” and “o-”, and the Alphabetical CC [symbol] for which “wo” is the complete alphabetical phonetic transcription are assigned to hexagon 940O in the second level hexagons corresponding to first level hexagon 940, and, hexagon 945 is kept empty and inactive;

the initial components “p-” and the Alphabetical CC [symbol] for which “pa” is the complete alphabetical phonetic transcription, “q-” and the Alphabetical CC [symbol] for which “qi” is the complete alphabetical phonetic transcription, “r-” and the Alphabetical CC [symbol] for which “ren” is the complete alphabetical phonetic transcription, “s-” and the Alphabetical CC [symbol] for which “si” is the complete alphabetical phonetic transcription, “t-” and the Alphabetical CC [symbol] for which “ta” is the complete alphabetical phonetic transcription are assigned to hexagons 950P, 950Q, 950R, 950S, 950T respectively in the second level hexagons corresponding to first level hexagon 950, and, hexagon 955 is kept empty and inactive;

the initial components “u-” and the Alphabetical CC ( [symbol] ( [symbol] ) for which “wu” is the complete alphabetical phonetic transcription, “ü-” (written “yu-” in Pinyin) and the Alphabetical CC [symbol] for which “yu” is the complete alphabetical phonetic transcription, “x-” and the Alphabetical CC [symbol] for which “xi” is the complete alphabetical phonetic transcription and the “y” location, which is assigned a specific function of, when selected, initiating a process for inserting a punctuation or other symbol—these components and Alphabetical CCs being assigned to hexagons 960U, 960V, 960X, 960Y respectively, and the initial component “w-”, when it is not followed by the final component “-o” as in “wo” (assigned to hexagon 940O) or “-u” as in “wu” (assigned to hexagon 960U) and the Alphabetical CC [symbol] ( [symbol] ) of which “wei” is the complete alphabetical phonetic transcription are assigned to hexagon 960W in the second level hexagons corresponding to first level hexagon 960, and, hexagon 965 is kept empty and inactive; and

the initial components “z-” and the Alphabetical CC [symbol] for which “zi” is the complete alphabetical phonetic transcription, “zh-” and the Alphabetical CC [symbol] for which “zhi” is the complete alphabetical phonetic transcription, “ch-” and the Alphabetical CC [symbol] for which “chi” is the complete alphabetical phonetic transcription, “sh-” and the Alphabetical CC [symbol] for which “shi” is the complete alphabetical phonetic transcription are assigned to hexagons 970Z, 970Zh, 970Ch, 970Sh, respectively, and, a specific function, as described above, is assigned to hexagon 970NO1GO2 in the second level hexagons corresponding to first level hexagon 970, and, hexagon 975 is kept empty and inactive.

For the purposes of shortening the input sequence for the encoding of another series of CCs for which the complete alphabetical phonetic transcription is the same as the complete alphabetical phonetic transcription of one of the 28 Alphabetical CCs, the second input step, which consists of the selection by the user of the final component, is not necessary. Confirmation that the second input step is not necessary is made through the selection of the complete alphabetical phonetic transcription in the relevant hexagon of the second level hexagons, followed by the activation of the 1070NO2GO3 key in the relevant fourth level hexagon as will be described in more detail below.

If the complete alphabetical phonetic transcription of a targeted CC does not correspond to one of the 28 Alphabetical CCs, encoding such targeted CC requires the additional input of the final component of the alphabetical phonetic transcription and the user must for that purpose proceed to the second input step, which comprises the selection of the final component of the alphabetical phonetic transcription of the targeted CC, as described in more detail below.

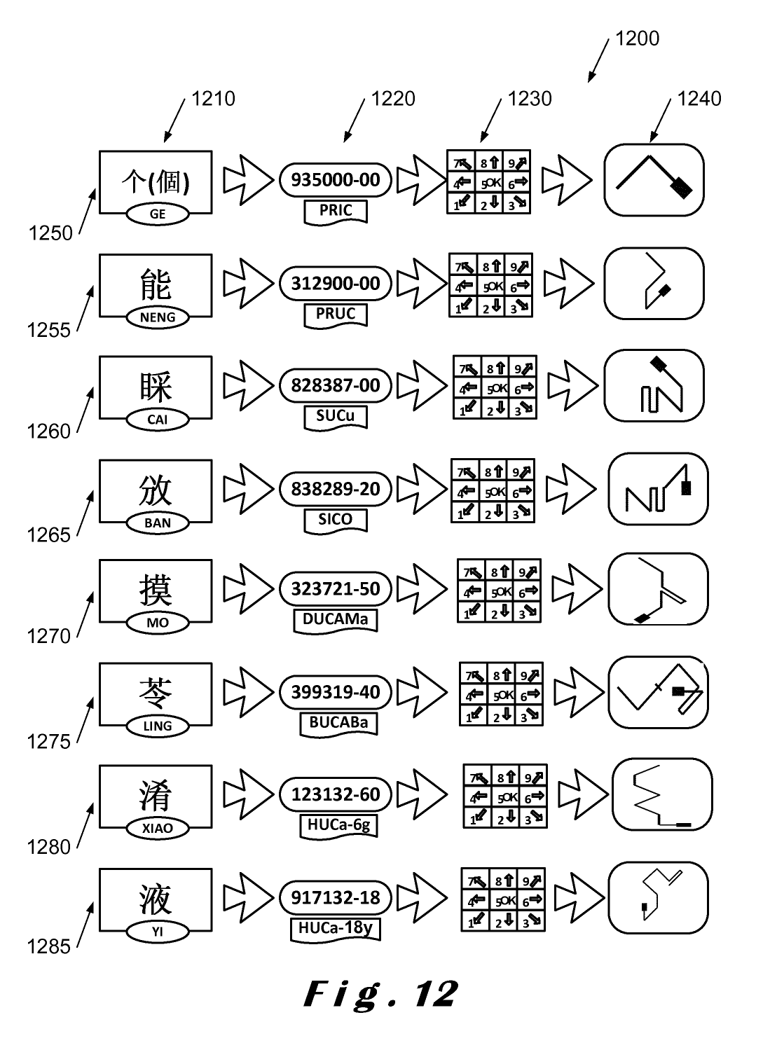

The selection by the user of the relevant initial component for the targeted CC in the relevant hexagon of the second level hexagons triggers the suppression of the display of the second level hexagons and the activation and display around the position of the finger of the user on the touch-sensitive surface of the layout or arrangement of third level hexagons corresponding to the final component of the alphabetical phonetic transcription, with the finger being automatically positioned within the perimeter of the central hexagon of the arrangement. The user then, without lifting the finger from the touch-sensitive surface, selects in the third level hexagons, the hexagon corresponding to, as described in more detail below, the group of final components (referred to hereinafter as “GRUFI”) by moving the finger in the direction of a relevant hexagon and into the perimeter thereof. This triggers the suppression of the third level hexagons and the generation of the layout or arrangement of fourth level hexagons as shown in FIG. 10 as will be described in more detail below.

The second input step, called “Final Phonetic step”, comprises, as described above, the selection, by the user, of the final component of the alphabetical phonetic transcription of a given targeted CC. The user can proceed to such input step only after having completed the first input step by selecting the initial component of the alphabetical phonetic transcription of the given targeted CC. The selection of the final component is made from 40 possibilities each corresponding to a distinct final component and presented by the software to the user. In this embodiment of the invention, the 40 possible distinct final components are presented to the user in a specifically designed arrangement comprising third level hexagons surrounding a central hexagon and fourth level hexagons surrounding a central hexagon. The third and fourth level hexagons are equivalent to the first and second level hexagons of the initial component, but, naturally, provide different possible selections for the user.

Referring to FIG. 10, a hexagon arrangement 1000 similar to hexagon arrangements 800 (FIG. 8) and 900 (FIG. 9) is shown, but in this case, instead of central hexagon 1010 corresponding to the start position, it corresponds to the selected initial component of the alphabetical phonetic transcription of the targeted CC. Central hexagon 1010 is surrounded by six third level hexagon arrangements 1020, 1030, 1040, 1050, 1060, 1070, and, each third level hexagon arrangement has a central hexagon 1021, 1031, 1041, 1051, 1061, 1071 which has an arrangement of six fourth level hexagons associated with it as will be described in more detail below. Movement from the central hexagon 1010 in the direction of arrows 1011, 1012, 1013, 1014, 1015, 1016 selects respective ones of the third level hexagon arrangements 1020, 1030, 1040, 1050, 1060, 1070 to provide access to the final components arranged therein. Each of the third level hexagons 1020, 1030, 1040, 1050, 1060, 1070 corresponds to a GRUFI.

As shown in FIG. 10, hexagon arrangement 1020 comprises GRUFI 1021 and final components “-a” and the Secondary Alphabetical CC [symbol] for which “la” is the complete alphabetical phonetic transcription, “-ai” and the Secondary Alphabetical CC [symbol] ( [symbol] ) for which “ai” is the complete alphabetical phonetic transcription, “-an” and the Secondary Alphabetical CC [symbol] for which “an” is the complete alphabetical phonetic transcription, “-ang” and the Secondary Alphabetical CC [symbol] for which “ang” is the complete alphabetical phonetic transcription, “-e” and the Secondary Alphabetical CC [symbol] for which “er” is the complete alphabetical phonetic transcription assigned to respective ones of hexagons 1020A, 1020B, 1020C, 1020D, 1020E with hexagon 1020F being kept empty and inactive; hexagon arrangement 1030 comprises GRUFI 1031 and final components “-ing” and the Secondary Alphabetical CC [symbol] ( [symbol] ) for which “ying” is the complete alphabetical phonetic transcription, “-iu” and the Secondary Alphabetical CC [symbol] for which “you” is the complete alphabetical phonetic transcription, “-i” (also used as a mute final for the complete alphabetical phonetic transcription “ri”) and the Secondary Alphabetical CC [symbol] for which “li” is the complete alphabetical phonetic transcription, “-ie” and the Secondary Alphabetical CC [symbol] of which “ye” is the complete alphabetical phonetic transcription, “-in” and the Secondary Alphabetical CC [symbol] for which “yin” is the complete alphabetical phonetic transcription assigned to respective ones of hexagons 1030A, 1030B, 1030C, 1030D, 1030E with hexagon 1030F being kept empty and inactive; hexagon arrangement 1040 comprises GRUFI 1041 and final components “-ao” and the Secondary Alphabetical CC [symbol] for which “ao” is the complete alphabetical phonetic transcription, “-iao” and the Secondary Alphabetical CC [symbol] for which “yao” is the complete alphabetical phonetic transcription, “-(u)o” and the Secondary Alphabetical CC [symbol] for which “luo” is the complete alphabetical phonetic transcription, “-ou” and the Secondary Alphabetical CC [symbol] for which “ou” is the complete alphabetical phonetic transcription, “-(i)ong” and the Secondary Alphabetical CC [symbol] for which “yong” is the complete alphabetical phonetic transcription assigned to respective ones of hexagons 1040A, 1040B, 1040C, 1040D, 1040E with hexagon 1040F being kept empty and inactive; hexagon arrangement 1050 comprises GRUFI 1051 and final components “-ei” and the Secondary Alphabetical CC [symbol] ( [symbol] ) for which “lei” is the complete alphabetical phonetic transcription, “-tie” and the Secondary Alphabetical CC [symbol] for which “yue” is the complete alphabetical phonetic transcription, “-en” and the Secondary Alphabetical CC [symbol] for which “en” is the complete alphabetic phonetic transcription, “-eng” and the Secondary Alphabetical CC [symbol] for which “leng” is the complete alphabetical phonetic transcription, “-un/-r” and the Secondary Alphabetical CC [symbol] ( [symbol] ) for which “yun” is the complete alphabetical phonetic transcription assigned to respective ones of hexagons 1050A, 1050B, 1050C, 1050D, 1050E with hexagon 1050F being kept empty and inactive; hexagon arrangement 1060 comprises GRUFI 1061 and final components “-uang” and the Secondary Alphabetical CC [symbol] for which “wang” is the complete alphabetical phonetic transcription, “-u” and the Secondary Alphabetical CC [symbol] for which “lu” is the complete alphabetical phonetic transcription, “-uai” and the Secondary Alphabetical CC [symbol] for which “wai” is the complete alphabetical phonetic transcription, “-ua” and the Secondary Alphabetical CC [symbol] for which “wa” is the complete alphabetical phonetic transcription, “-uan” and the Secondary Alphabetical CC [symbol] for which “wan” is the complete alphabetical phonetic transcription assigned to respective ones of hexagons 1060A, 1060B, 1060C, 1060D, 1060E with hexagon 1060F being kept empty and inactive; and hexagon arrangement 1070 comprises GRUFI 1071 and final components “-ia” and the Secondary Alphabetical CC [symbol] for which “ya” is the complete alphabetical phonetic transcription, “-ian” and the Secondary Alphabetical CC [symbol] for which “yan” is the complete alphabetical phonetic transcription, “-iang” and the Secondary Alphabetical CC [symbol] for which “yang” is the complete alphabetical phonetic transcription, and rare final components “-m” and “-g” and the Secondary Alphabetical CC [symbol] ( [symbol] ) for which “liang” is the complete alphabetical phonetic transcription assigned to respective ones of hexagons 1070B, 1070C, 1070D, 1070A, with hexagon 1070NO2GO3 being assigned a confirmation function and hexagon 1070F being kept empty and inactive.

Hexagon 1030B also has final component “-iu” and “-ou” but the latter will only be active and displayed if “i-” is the initial component selected by the user at the first input step, and, in such case the final component “-iu” will not be active nor displayed.

Hexagon 1040C is effectively assigned two final components “-o” and “-uo”. “-o” is normally active and displayed, but, “-uo” is only active and displayed if the initial component selected by the user is one of: “d-”, “t-”, “n-”, “l-”, “g-”, “k-”, “h-”, “s-”, “z-”, “c-”, “r-”, “sh-”, “zh-” and “ch-”. In the latter case, the final component “-o” is not active nor displayed.

Hexagon 1040E is effectively assigned final components “-ong” and “-iong” depending on the selection of the initial component in the first input step. Only “-ong” is normally displayed unless “x-”, “j-” or “q-” is the initial component selected by the user at the first input step, and, in such a case, the final component displayed is “-iong” in hexagon 1040E.

Hexagon 1050B has final components “-ue”, “-üe” and “-ui” but final component “-üe” is only active and displayed if the initial component selected by the user is “n-” or “l-” and the other final components are not active nor displayed; “-ue” is only active and displayed if the initial component selected by the user is “x-”, j-”, “q-” or “ü-” with the other final components not being active nor displayed; and “-ui” is active and displayed for all other initial components and the other final components are not active nor displayed.

Hexagon 1050E is assigned final components “-un” and “-ün” (also written “-un” in Pinyin after the initial component “j-”, “q-” or “x-”), and the latter is active and displayed only if the initial component selected by the user at the first input step comprises “x-”, “j-”, “q-” or “ii-”, the final component “-un” being not active nor displayed. If “e-” is the initial component, hexagon 1050E has the final component “-r” active and displayed and the final components “-un” and “-ün” are not active nor displayed.

Hexagon 1060C also has final component “-u” (identifying the phoneme “-ü”), which is active and displayed only if the initial component selected by the user at the first input step is one of: “x-”, “j-”, “q-” or “ii-”, and, in such case, the final component “-uai” is not active nor displayed. The final component “-ü” is only active and displayed if the initial component selected by the user at the first input step is “n-” or “l-”, and, in such case, the final components “-uai” and “-u” are not active nor displayed.

Hexagon 1060E has the final component “-üan” (also written “-uan” in Pinyin) which is active and displayed only if the initial component selected by the user at the first input step is one of: “x-”, “j-”, “q-” or “ü-”, and in such case, the final component “-uan” is not active nor displayed.

Hexagon 1070A, to which rare final components are assigned, also has the final component “-g”, but is active and displayed only if “n-” is the initial component selected by the user at the first input step, and, in such case, the final component “-m” is not active nor displayed.

It should be noted that the final components required to form the complete alphabetical phonetic transcriptions chosen for the PUDASHU input method have been ordered so that the grouping of such components in the GRUFI, as described above with reference to FIG. 10, could overlap the grouping of the GRINI in a coherent way. The allocation of the final components has been chosen in order to build a basic coherence between the allocation of the initial components and their simplest final expression: “a-”, “e-”, “i-”, “(w)o-”, “(w)u” being selected in the first step by the same sequence of movements as that of the sequence for selecting the final components “-a”, “-e”, “-i”, “-o”, “-u” in the second step. The grouping of the final components in the GRUFI has been made coherent with the grouping already adopted for the building of the GRINI. For example, in GRUFI “A→E” as described above with reference to FIG. 10, four final components of the alphabetical phonetic transcription beginning with “-a” have been gathered together (“-a”, “-ai”, “-an”, “-ang”); in GRUFI “F→J” (shown as GRUFI “IN→IE” in FIG. 10 but corresponding to the positions of “F→J” in the GRINI), five final components of the alphabetical phonetic transcription beginning with “-i” (“-in”, “-ing”, “-i(o)u”, “-i”, “-ie”) have been gathered together; in GRUFI “K→O” (shown as GRUFI “OU→O” in FIG. 10 but corresponding to the positions of “K→O” in the GRINI), two final components of the alphabetical phonetic transcription beginning with “-o” (“-o(u)”, “-ong”), and three final components of the alphabetical phonetic transcription containing a “o” (“-iao”, “-ao”, “-(u)o”) have been gathered together; in GRUFI “P→T” (shown as GRUFI “EN→UI” in FIG. 10 but corresponding to the positions of “P→T” in the GRINI), allocated in the opposite direction of the GRUFI “A→E”, four final components of the alphabetical phonetic transcription with “e” (“-en”, “-eng”, “-ei”, “-ue”) together with “-ui” equated with “-ue”, “-un”, “-ün” equated with “-en”, and “-r” equated to “-er”) have been gathered together, while the “-e” itself, in order to be coherent with the position allocated to the initial component “e-” in the GRINI “A→E” remains in the GRUFI “A→E”; in GRUFI “U→Y” (shown as GRUFI “U→UANG” in FIG. 10 but corresponding to the positions of “U→Y” in the GRINI), final components of the alphabetical phonetic transcription containing the letters “u” (“-u”, “-ii” (not shown in FIG. 10 but sharing the same position as “-u” and available according to the selection of the initial component of the alphabetical phonetic transcription), “-ua”, “-uai”, “-uan”, -uang) have been gathered together; and in GRUFI “Z→Sh” (shown as GRUFI “M→IANG” in FIG. 10 but corresponding to the positions of “Z→Sh” in the GRINI), rare final components (“-g”, “-m”) of the alphabetical phonetic transcription and three final components of the alphabetical phonetic transcription beginning with “ia” (“-ia”, “-ian”, “-fang”) have been gathered together. It should also be noticed that the final components of the complete alphabetical phonetic transcriptions for the PUDASHU input method have been chosen so that the shape of the capital letters chosen as head of groups of semantic components (that is, the heads of the partitions of Chinese radicals as described above) could be directly related to the shape of the semantic component (that is, the Chinese radical) to which such letters are directly assigned.

As shown in FIG. 10, each of the 29 Secondary Alphabetical CCs is assigned as follows: the CC [symbol] (la) is assigned to hexagon 1020A; the CC [symbol] ( [symbol] ) (ai) is assigned to hexagon 1020B; the CC [symbol] (an) is assigned to hexagon 1020C; the CC [symbol] (ang) is assigned to hexagon 1020D; the CC [symbol] (U (er) is assigned to hexagon 1020E; the CC [symbol] (yin) is assigned to hexagon 1030E; the CC [symbol] ( [symbol] ) (ying) is assigned to hexagon 1030A; the CC [symbol] (you) is assigned to hexagon 1030B; the CC [symbol] (li) is assigned to hexagon 1030C; the CC [symbol] (ye) is assigned to hexagon 1030D; the CC [symbol] (ou) is assigned to hexagon 1040D; the CC [symbol] (yong) is assigned to hexagon 1040E; the CC [symbol] (ao) is assigned to hexagon 1040A; the CC [symbol] (yao) is assigned to hexagon 1040B; the CC [symbol] (luo) is assigned to hexagon 1040C; the CC [symbol] (en) is assigned to hexagon 1050C; the CC [symbol] (leng) is assigned to hexagon 1050D; the CC [symbol] ( [symbol] ) (yun) is assigned to hexagon 1050E; the CC [symbol] ( [symbol] ) (lei) is assigned to hexagon 1050A; the CC [symbol] (yue) is assigned to hexagon 1050B; the CC [symbol] (lu) is assigned to hexagon 1060B; the CC [symbol] (wai) is assigned to the hexagon 1060C; the CC [symbol] (wa) is assigned to the hexagon 1060D; the CC [symbol] (wan) is assigned to hexagon 1060E; the CC [symbol] (wang) is assigned to hexagon 1060A; the CC [symbol] (liang) is assigned to hexagon 1070A; the CC [symbol] (ya) is assigned to hexagon 1070B; the CC [symbol] (yan) is assigned to hexagon 1070C; and the CC [symbol] (yang) is assigned to hexagon 1070D. Each of such 29 Secondary Alphabetical CC is displayed in addition to the relevant final component in the relevant hexagon so as to make it visible to the user, but is so displayed only if the user at the first step has selected hexagon 970NO1GO2. When the user at the first input step has not selected hexagon 970NO1GO2, the CC displayed is the CC having PR in its encoding tag and the alphabetical phonetic transcription of which is the result of the combination of the initial component selected at the first input step and of the relevant final component. Since, for such 29 Secondary Alphabetical CCs, no ambiguity resolution is needed, the software automatically generates the retrieval of each of such Secondary Alphabetical CCs in the PDS-db and then displays and/or stores it for further processing from the mere selection in the relevant hexagon of the fourth level hexagons of the final component associated with each of such 29 Secondary Alphabetical CCs followed by the confirmation that this final component, combined with the initial component selected by the user from the second level hexagons, corresponds to the targeted CC.

Such confirmation is made by lifting the finger from the touch-sensitive surface after having moved the finger on the touch-sensitive surface in the direction, and into the perimeter, of the relevant hexagon, and, the software detects such lifting and automatically performs the confirmation function. The software displays the selected Secondary Alphabetical CCs in the Output Window and returns to the starting position allowing the user to begin a new input sequence for encoding another targeted CC.

Selection of the hexagon 1070NO2GO3 moves the user from the selection hexagons (third and fourth level hexagons) for the final component of the alphabetical phonetic transcription of the targeted CC to fifth and sixth level hexagons where the user will perform the third input step, that is, the selection of the Chinese radical of the targeted CC.

Movements on the touch-sensitive surface for selecting the hexagon 1070NO2GO3 are as follows: starting from central hexagon 1010 in the third level hexagons, the user moves his finger in the direction of hexagon 1070 and into the perimeter of that hexagon, which triggers the display of fourth level hexagons with hexagon 1071 as the central hexagon; the user then moves his finger from hexagon 1071 in the direction of hexagon 10700NO2GO3 and into the perimeter of that hexagon, without lifting his finger from the touch-sensitive surface at the end of such movement.

For speeding up the input process, selecting the hexagon 1070NO2GO3 can also be performed as follows: the selection by the user of the relevant initial component for the targeted CC, which is also the complete alphabetical phonetic transcription of such CC, in the relevant hexagon of the second level hexagons triggers, as described above, the suppression by the software of the display of the second level hexagons and the activation and the display around the position of the finger of the user on the touch-sensitive surface of the layout or arrangement of the third level hexagons corresponding to the first stage of the selection of the final component of the alphabetical phonetic transcription of the targeted CC, with the finger being automatically positioned within the perimeter of the central hexagon of the third level hexagons; the user then, without lifting such finger from the touch-sensitive surface, moves such finger counter-clockwise on the touch-sensitive surface within the perimeter of the central hexagon without lifting such finger from the touch-sensitive surface, and at the end of this counter-clockwise movement, the third level hexagons are suppressed and a hexagon arrangement corresponding to the Chinese radicals is generated as will be described in more detail below.

Effective activation of the hexagon 1070NO2GO3 in either one of the two ways described above also triggers the retrieval, in the PDS-db by the software, of a specific subset of CCs comprising only CCs each of which corresponds to an alphabetical phonetic transcription which is the same as the alphabetical phonetic transcription of the Alphabetical CC assigned to the same second level hexagon as the initial component selected by the user or, if the user has selected hexagon 840O (FIG. 8), the same as “wo”, “o” or “ou”. For ambiguity resolution within that specific subset of CCs, the user must proceed to the third input step, which consists of the selection by the user of one of the 26 partitions of Chinese radicals, as will be described in more detail below.

In each of the six hexagon layouts or arrangements 1020, 1030, 1040, 1050, 1060, 1070, the software only displays in the relevant hexagons, in addition to the hexagon 1070NO2GO3, the final components which, combined with the initial component selected by the user at the first input step, constitute a valid alphabetical phonetic transcription and the other hexagons are kept empty and inactive. In this embodiment of the invention, the 40 distinct final components are allocated as described above, but it will be appreciated that other allocations are possible.

The selection by the user of the final component in the relevant hexagon of the fourth level hexagons triggers, as described above, the retrieval by the software of a second subset of CCs in the PDS-db within the first subset of CCs described above. This second subset of CCs comprises only CCs to which corresponds an alphabetical phonetic transcription of which both the initial component selected by the user at the first input step and the final component selected by the user at the second input step together constitute the same alphabetical phonetic transcription. Such a selection by the user also triggers, for the purposes of the third input step where the user will resolve ambiguities within such subset of CCs sharing the same alphabetical phonetic transcription, the generation by the software of an appropriate layout for the selection of Chinese radicals as will be described in more detail below.

The selection by the user of the final component in the relevant hexagon of the fourth level hexagons also triggers the suppression by the software of the display of the fourth level hexagons and the activation and the display around the position of the finger of the user on the touch-sensitive surface of fifth level hexagons corresponding to a first stage of the selection of the Chinese radicals, wherever on the touch-sensitive surface the finger is positioned after the user has moved such finger for selecting the final component, resulting in the finger being automatically positioned in a central hexagon surrounded by the six fifth level hexagons, as will be described below.

The third input step, called “Chinese Radical step”, comprises, as described above, the selection by the user of one of the 26 partitions of Chinese radicals to which a given targeted CC has been assigned. The user can proceed to this third input step, as described above, only after having: completed the first and second input steps to select the initial and final components respectively; completed the first input step by selecting the initial component and activating the transition (using hexagon 1070NO2GO3 (FIG. 10) or performing the counter-clockwise movement on the touch-sensitive surface) that bypasses the second input step, as explained above; or completed the second input step after having bypassed the first input step by activating the transition (using hexagon 870NO1GO2 (FIG. 8) or performing the counter-clockwise movement on the touch-sensitive surface).

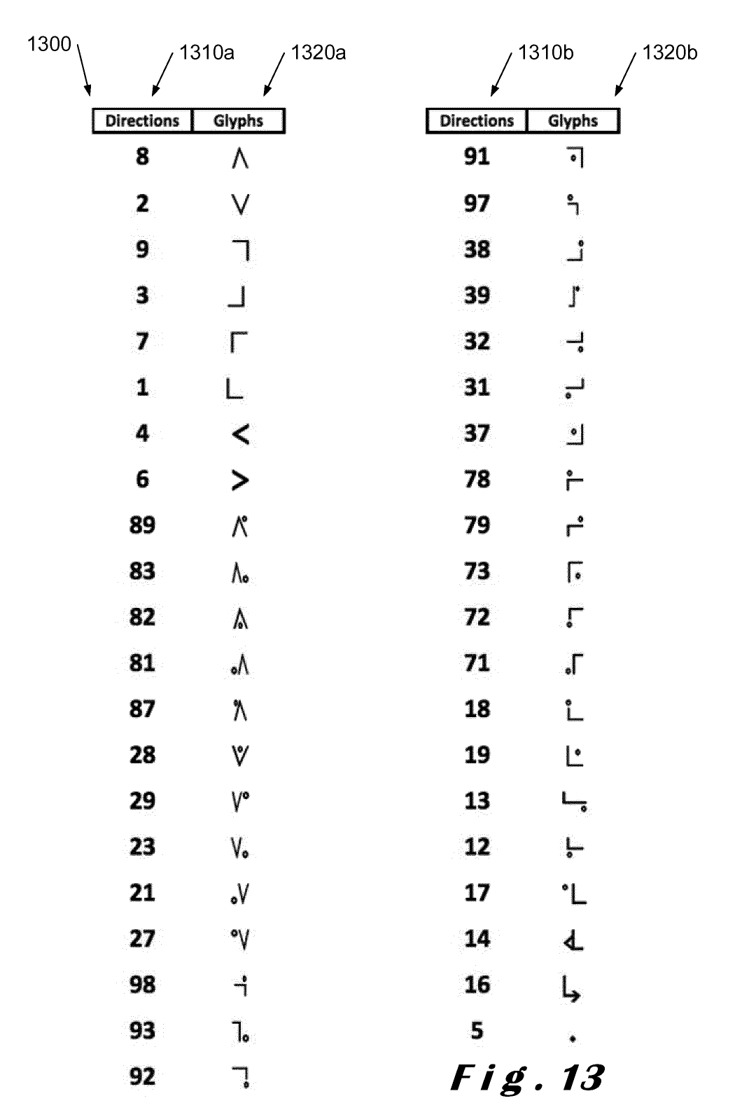

The selection of the partition of Chinese radicals is made from among 26 possibilities corresponding each to a distinct partition and presented by the software to the user. In this embodiment of the invention, the 26 distinct partitions are presented to the user in a specifically designed layout or arrangement 1100 comprising a first set of six hexagons (fifth level hexagons) 1120, 1130, 1140, 1150, 1160, 1170 surrounding a central hexagon 1110 and a second set of six hexagons (sixth level hexagons) surrounding a central hexagon selected from the first set of hexagons (or fifth level hexagons) as will be described below with reference to FIG. 11.

Referring to FIG. 11, the fifth and sixth level hexagons are shown. FIG. 11 is similar to FIG. 10, but instead of the central hexagon being the initial component of the alphabetical phonetic transcription, it is the complete alphabetical phonetic transcription of the targeted CC. The fifth level hexagons 1120, 1130, 1140, 1150, 1160, 1170 are shown around central hexagon 1110. Each of the fifth level hexagons corresponds to a group of heads of partition of Chinese radicals (hereinafter referred to as “GROCHI”). Hexagon 1120 includes heads of the groups “ren” (“ [symbol] ”) to “ri” (“ [symbol] ”); hexagon 1130 includes heads of the groups “bing” (“ [symbol] ”) to “shi” (“ [symbol] ”); hexagon 1140 includes heads of the groups “mu” (“ [symbol] ”) to “huo” (“ [symbol] ”); hexagon 1150 includes heads of the groups “yu” (“ [symbol] ”) to “zhu” (“ [symbol] ”); hexagon 1160 includes heads of the groups “shan” (“ [symbol] ”) to “zu” (“ [symbol] ”); and hexagon 1170 includes the head of the group “yi” (“ [symbol] ”) as well as shortcuts.

The sixth level hexagons correspond to the individual 26 distinct partitions, where:

the heads of partition “ [symbol] (ren)”, “ [symbol] (xin)”, “ [symbol] (kou)”, “ [symbol] (yan)”, “ [symbol] (ri)” are assigned to hexagons 1120A, 1120B, 1120C, 1120D, 1120E respectively, and hexagon 1125 is kept empty and inactive as will be described in more detail below;

the heads of partition “ [symbol] (jin)”, “ [symbol] ( [symbol] ) (niao)”, “ [symbol] (tu)”, “ [symbol] (shi)”, “ [symbol] (bing)” are assigned to hexagons 1130A, 1130B, 1130C, 1130D, 1130E respectively, and hexagon 1135 is kept empty and inactive as will be described in more detail below;

the heads of partition “ [symbol] (shui)”, “ [symbol] (chuo)”, “ [symbol] (huo)” “ [symbol] (mu)”, “ [symbol] (chong)” are assigned to hexagons 1140A, 1140B, 1140C, 1140D, 1140E respectively, and hexagon 1145 is kept empty and inactive as will be described in more detail below;

the heads of partition “ [symbol] (shou)”, “ [symbol] (zhu)”, “ [symbol] (yu)”, “ [symbol] (nü)”, “ [symbol] (yin)” are assigned to hexagons 1150A, 1150B, 1150C, 1150D, 1150E respectively, and hexagon 1155 is kept empty and inactive as will be described in more detail below;

the heads of partition “ [symbol] (zu)” “ [symbol] (shan)”, “ [symbol] (cao)”, “ [symbol] (si)”, “ [symbol] (rou)” are assigned to hexagons 1160A, 1160B, 1160C, 1160D, 1160E respectively, and hexagon 1165 is kept empty and inactive as will be described in more detail below; and

the head of partition “ [symbol] (yi)” is assigned to hexagon 1170A with hexagons 1170C+, 1170Pref, 1170C− and 1170Next being available for the assignment functions if needed, and hexagon 1175 is kept empty and inactive as described in more detail below.

In each of the hexagon arrangements 1120, 1130, 1140, 1150, 1160, 1170, the software only displays in the relevant hexagons, in addition to the functions key, as the case may be, the heads of partition corresponding to the Chinese radicals which are associated with each CC included in the second subset retrieved by the software after the user has selected a final component as described above, or to each CC included in the specific subset retrieved by the software after activation of the hexagon 1070NO2GO3 (or its functionality) as described above and the other hexagons are kept empty and inactive.

Instead of, or in addition to, the heads of partition, the software can display at least one of the following: the Chinese radicals associated with each CC included in the second subset; each such CC; and at least the head of the conflicting CCs list as will be described in more detail below.

It should be noted that the grouping of the semantic components in GROCHI is related: directly to the shapes of the initial components of the alphabetical phonetic transcriptions; indirectly to the respective groupings in GRINI of such initial components; indirectly to the shapes of the final components of the alphabetical phonetic transcriptions; and indirectly to the respective groupings in GRUFI of such final components, as described above.

In this embodiment of the invention, the 26 distinct partitions are allocated among the hexagons as described above but it will be appreciated that other allocations are possible.

The selection by the user of one of the 26 distinct partitions is made by selecting the relevant GROCHI in the fifth level hexagons, which triggers the display by the software of the layout of the sixth level hexagons and the user can then select the partition to which the targeted CC has been assigned.

As described above, the selection by the user of the final component in the relevant hexagon of the fourth level hexagons also triggers the activation and the display around the position of the finger of the user on the touch-sensitive surface of the layout of the fifth level hexagons, resulting in such finger being automatically positioned in the central hexagon 1110 surrounded by the six hexagons 1120, 1130, 1140, 1150, 1160, 1170 of the fifth level hexagons corresponding to the first stage of the selection of the Chinese radicals.

Once the finger of the user is positioned in the central hexagon 1110 surrounded by the six hexagons 1120, 1130, 1140, 1150, 1160, 1170, the user then, without lifting the finger from the touch-sensitive surface, selects the hexagon with the GROCHI corresponding to the partition to which the targeted CC has been assigned in the fifth level hexagons. The user makes such selection by moving the finger, on the touch-sensitive surface, from the central hexagon 1110 in the direction of the hexagon corresponding to such a GROCHI and into the perimeter of that hexagon, without lifting such finger from the touch-sensitive surface at the end of such movement.

The software detects that the finger of the user has moved and also detects the direction of such movement and/or the fact that such finger has moved into the perimeter of one of the fifth level hexagons, and, as a consequence identifies the GROCHI that the user has selected.

The selection by the user of a GROCHI in the relevant hexagon in the fifth level hexagons triggers the suppression of the display of the fifth hexagons and the activation and the display around the position of the finger of the user on the touch-sensitive surface of the sixth level hexagons that corresponds to the selected GROCHI, wherever on the touch-sensitive surface such finger is positioned after the user has moved such finger, resulting in such finger being automatically positioned in the central hexagon surrounded by the six sixth level hexagons.

Once the finger of the user is positioned in the central hexagon surrounded by the six sixth level hexagons, the user then, without lifting such finger from the touch-sensitive surface, selects the partition corresponding to the targeted CC in the sixth level hexagons, by moving such finger on the touch-sensitive surface from the central hexagon in the direction of the hexagon corresponding to the partition and into the perimeter of that hexagon, without lifting such finger from the touch-sensitive surface at the end of such movement. The software detects that the finger of the user has moved and also detects the direction of such movement and/or the fact that the finger has moved into the perimeter of one of the sixth level hexagons, and, as a consequence, identifies the partition or the function that the user has selected.

Each of the hexagons 1125, 1135, 1145, 1155, 1165, 1175 in the sixth level hexagons that is positioned in the same direction as the first movement made from the central hexagon 1110 of the fifth level hexagons is not assigned any function and is empty and inactive. If the user moves the finger on the touch-sensitive surface in the direction of any of these empty hexagons, the software registers this movement as an extension of the movement made by the user in the same direction from the central hexagon 1170 of the fifth level hexagons and not as a different movement. As described above, one or more of these empty and inactive hexagons can made active and assigned a function that the user can select.

The selection by the user of a partition in the relevant hexagon of the sixth level hexagons triggers the retrieval by the software of a third subset of CCs in the PDS-db, called “Conflicting CCs List”, either within the second subset of CCs described above (obtained after the second input step) or, if the user has activated hexagon 1070NO2GO3 (or its functionality) at the end of the first input step, within the specific subset of CCs described above. Such a Conflicting CCs List comprises only CCs to which corresponds a complete alphabetical phonetic transcription which is the same as the complete alphabetical phonetic transcription resulting from the combination of the initial and final components selected by the user in the first and second input steps, and, which in addition has been assigned to the same partition of Chinese radicals. Such a selection by the user also triggers, for the purposes of the fourth input step where the user will resolve ambiguities within such a Conflicting CCs List, the Ming Tang as described above.

The selection by the user of the partition in the relevant hexagon of the sixth level hexagons also triggers the suppression by the software of the display of the sixth level hexagons and the activation and the display, around the position of the finger of the user on the touch-sensitive surface, of a first set of eight cases of the Ming Tang for the fourth input step, wherever on the touch-sensitive surface the finger is positioned after the partition has been selected, resulting in such finger being automatically positioned in the central location 5 (as described above with reference to FIG. 1) surrounded by the eight locations of the Ming Tang, as described in more detail below.

For the purposes of shortening the input sequence for the encoding of a series of CCs, if a targeted CC has “SUC” in its encoding tag and is, by definition, the only CC in the partition selected by the user at the third input step, the software, since no further ambiguity resolution is needed, automatically generates the retrieval of such a CC in the PDS-db, and then stores it in the computerised system in a computerised format for further processing, from the mere detection that the targeted CC has “SUC” in its encoding tag and that it is, by definition, the only CC in the partition selected by the user. In such a case, the user does not need to take the fourth input step and the software automatically returns to a starting position allowing the user to begin a new input sequence for encoding another targeted CC.

The fourth input step, called “Ming Tang step”, comprises, as described above, of the selection by the user of the targeted CC within the Conflicting CCs List made of CCs retrieved by the software in the PDS-db following the selection by the user of one of the 26 partitions of the sixth level hexagons. The user can proceed to such fourth step only after having completed the third step by selecting a partition. The selection of the targeted CC is made from among possibilities corresponding each to one of the CCs included in the Conflicting CCs List, which are presented, by the software to the user, in the Ming Tang, and in the Second Floor of the Ming Tang as described above with reference to FIGS. 1 and 2.

Each CC contained in the Conflicting CCs List is automatically positioned by the software in one specific location in the nine locations of the Ming Tang on the basis of the identification of that specific location included in the data associated with such a CC in the PDS-db as described above. When the Conflicting CCs List contains less than nine CCs, each location where no CC is positioned is kept empty and inactive.

In exceptional cases where a Conflicting CCs List contains more than nine CCs, nine of these CCs are positioned in the Ming Tang with the remaining CCs being positioned in the Second Floor as described above. Generally, location 1 of the Ming Tang is, in addition, assigned the function of giving access to the Second Floor and the CCs in excess of nine are each positioned in one of the locations of such a Second Floor, each location of such a Second Floor where no CC is positioned is kept empty and inactive.

The selection by the user of one of the CCs within a Conflicting CCs List displayed in the Ming Tang is made by selecting, in the Ming Tang, the relevant location, or, if there are more than nine CCs in the Conflicting List, by selecting the relevant location in the Second Floor. In the case where there is a Second Floor, the location 1 in the Ming Tang, indicates, by means of a specific colour displayed by the software on the background of such a location or by any other means designed to inform the user, that there is a Second Floor and the selection by the user of such a location triggers the automatic display, by the software, of the Second Floor where the CC that was positioned in location 1 of the Ming Tang is replicated in location 15 of the Second Floor and the CCs of the Conflicting CCs List in excess of nine are displayed and automatically positioned by the software in one of the locations of the Second Floor on the basis of the identification of such a specific location included in the data associated with such a CC in the PDS-db as described above.

As described above, the selection by the user of the final component in the relevant hexagon of the fourth level hexagons also triggers the activation and the display around the position of the finger of the user on the touch-sensitive surface of the eight locations of the Ming Tang surrounding the central location 5 of such a Ming Tang, wherever on the touch-sensitive surface such finger is positioned after the user has moved such finger for selecting the partition, resulting in such finger being automatically positioned in the central location 5 surrounded by the eight other locations of the Ming Tang, and, the CC positioned in location 5 is called an “Emperor CC”.

Once the finger of the user is positioned in the central location 5 surrounded by the eight other locations of the Ming Tang, the user then, without lifting such finger from the touch-sensitive surface, selects in the Ming Tang the CC corresponding to the targeted CC or, if there is a Second Floor, the location giving access to such a Second Floor, by moving such finger on the touch-sensitive surface from the central location 5 in the direction, and into the perimeter, of the location corresponding to the targeted CC or to the location giving access to the Second Floor. The software detects that the finger has moved and also detects the direction of such a movement and/or the fact that the finger has moved into the perimeter of one of the locations, and, as a consequence identifies the CC that the user has selected, or, the fact that the user has selected the location giving access to the Second Floor.

If there is no Second Floor, the selection by the user of the relevant location triggers the retrieval by the software within the Conflicting CCs List of the CC that corresponds to the targeted CC and the software automatically retrieves such a CC in the PDS-db and stores it in the computerised system in a computerised format for further processing purposes. The software, in addition, can display such a CC in an output window (the “Output Window”) next to the previous targeted CC (if there is one) retrieved, and stored for further processing purposes. The Output Window may be embedded in messaging software, in word processing software or in any other software where the targeted CCs are to be used.

If the user at this stage still has his finger in contact with the touch-sensitive surface and sees in the Output Window that he has selected a CC which is not the targeted CC in the Ming Tang, or has selected one of the CCs in the Ming Tang instead of selecting location 1 giving access to the Second Floor, the user can change his selection by moving the finger, without lifting it from the touch-sensitive surface, into the perimeter of another of the nine locations of the Ming Tang. The user can perform such a movement by moving the finger on the touch-sensitive surface within the area that includes the nine locations of the Ming Tang. Each time the finger passes through the perimeter of any of the nine locations of the Ming Tang, the software detects that the finger has passed through such a perimeter, and, as a consequence, identifies the CC that corresponds to the targeted CC and automatically retrieves such CC in the PDS-db and stores it in the computerised system in a computerised format for further processing. The software, in addition, displays the CC in the Output Window next to the previous targeted CC (if there is one) retrieved, stored for further processing purposes and displayed in the Output Window.

If the user at this stage still has his finger in contact with the touch-sensitive surface and sees in the Output Window the CC that corresponds to the targeted CC, he/she then lifts the finger from the touch-sensitive surface and the selection of the targeted CC is finalised. The software detects the lifting of the finger and automatically suppresses the display of the Ming Tang and automatically returns the touch-sensitive surface to a starting position and the user can establish a new initial finger contact with the touch-sensitive surface to initiate another input sequence for encoding another targeted CC, as described above.

If there is a Second Floor, the selection by the user in the Ming Tang of the location giving access to the Second Floor, described above as location 1, triggers the activation and the display around the position of the finger of the user on the touch-sensitive surface of the eight locations of the Second Floor surrounding the central location of the Second Floor, wherever on the touch-sensitive surface the finger is positioned after the user has moved the finger for selecting the case giving access to the Second Floor, resulting in such finger being automatically positioned in the central location 15 surrounded by the eight other locations of the Second Floor.

Once the finger of the user is positioned in location 15 surrounded by the eight other locations of the Second Floor, the user then, without lifting the finger from the touch-sensitive surface, selects, in the Second Floor, the CC corresponding to the targeted CC by moving the finger on the touch-sensitive surface from location 15 in the direction of the location corresponding to the targeted CC and into the perimeter of that location. The software detects that the finger has moved and also detects the direction of such movement and/or the fact that the finger has moved into the perimeter of one of the locations, and, as a consequence, identifies the CC that the user has selected.

The selection by the user of the relevant location triggers the identification by the software within the Conflicting CCs List of the CC that corresponds to the targeted CC and the software automatically retrieves such a CC in the PDS-db and stores it in the computerised system in a computerised format for further processing purposes. The software, in addition, displays the targeted CC in the Output Window next to the previous targeted CC (if there is one) retrieved, stored for further processing purposes and displayed in the Output Window.

If the user at this stage still has his finger in contact with the touch-sensitive surface and realises that he has selected the wrong CC on the Second Floor, the user can change his selection by moving the finger, without lifting it from the touch-sensitive surface, into the perimeter of another one of the locations of the Second Floor. The user can perform such movement by moving the finger on the touch-sensitive surface within the area that includes the nine locations of the Second Floor. Each time the finger passes through the perimeter of any of the nine locations of the Second Floor, the software detects that that finger has passed through the perimeter, and, as a consequence, identifies the CC that corresponds to the targeted CC and automatically retrieves such CC in the PDS-db and stores it in the computerised system in a computerised format for further processing. The software, in addition, displays such CC in the Output Window next to the previous targeted CC retrieved, stored for further processing purposes and displayed in the Output Window.

If the user at this stage still has his finger in contact with the touch-sensitive surface and sees in the Output Window the CC that corresponds to the targeted CC, which can be the CC initially displayed in location 1 of the Ming Tang and replicated in location 15 of the Second Floor, he/she then lifts the finger from the touch-sensitive surface and the selection is finalised. The software detects such lifting and automatically suppresses the display of the Second Floor and automatically returns the touch-sensitive surface to a starting position and the user can establish a new initial finger contact with the touch-sensitive surface to initiate another input sequence for encoding another targeted CC, as described above.

If the user, after having selected, in the Ming Tang, the location giving access to the Second Floor, still has his finger in contact with the touch-sensitive surface and realises that he/she has erroneously selected the access to the Second Floor and wishes to go back to the Ming Tang, the user moves such finger counter-clockwise on the touch-sensitive surface within the perimeter of location 15 of the Second Floor without lifting the finger from the touch-sensitive surface at the end of the counter-clockwise movement. The software detects the counter-clockwise movement and suppresses the activation and the display of the Second Floor and reactivates and displays again around the position of the finger on the touch-sensitive surface, the Ming Tang, with the finger being automatically positioned again within the perimeter of location 5 in the Ming Tang.

As described above, when in any of the second, third and fourth input steps the user, after having moved a finger on the touch-sensitive surface in the direction, and into the perimeter, of a given hexagon or a location in a Ming Tang, moves the finger on the touch-sensitive surface in the same direction, and into the perimeter, of another hexagon or another location in a Ming Tang or in a Second Floor with a view to selecting another hexagon or another location, the software, even though the two successive movements are made in the same direction on the touch-sensitive surface, is configured in such a way that it does not register such two movements as a single movement but as two successive movements in the same direction. This is achieved by detecting when the finger leaves the perimeter of a first hexagon or location and passes through the perimeter of another hexagon or location in the same direction. Naturally, this can only be performed if the hexagon or location is active and has been assigned one of: a GRUFI; a GROCHI; or a Ming Tang (and/or Second Floor).

In effect, the software is configured in such a way that it registers the second movement as an extension of the first movement made by the user in the same direction and not as a different movement, unless the user pauses such finger within the perimeter of the first hexagon or location before moving the finger in the direction, and into the perimeter, of another hexagon or location.

As an alternative movement, the user can, after having moved a finger on the touch-sensitive surface in the direction, and into the perimeter, of the first hexagon or location, select another hexagon or location positioned in the same direction as the hexagon or location the user has just moved to by, without lifting such finger from the touch-sensitive surface, moving the finger clockwise on the touch-sensitive surface within the perimeter of the first hexagon or location without lifting the finger from the touch-sensitive surface at the end of the clockwise movement. This clockwise movement triggers the suppression by the software of the first hexagon and (of the six hexagons surrounding this hexagon if already displayed), or of the first location of the Ming Tang (or Second Floor), and the generation and display of another hexagon, or another location, with the finger being positioned within the perimeter of the other hexagon or location and with the six corresponding hexagons surrounding this hexagon being also immediately displayed.

The PUDASHU input method as described above with reference to FIGS. 7 to 11 can also be implemented on a numeric keypad where the numbers “1” to “9” are arranged in a 3×3 matrix, and each number “1” to “4” and “6” to “9” corresponds to a defined direction starting from “5” as a reference central or neutral position on a touch-sensitive surface. The numeric keypad may be a physical keypad or one which may be displayed as a GUI on a touch sensitive surface of a smart phone or tablet. In this embodiment of the present invention, the numbers “1” to “3” occupy a bottom row of the matrix; numbers “4” to “6” occupy the middle row of the matrix; and numbers “7” to “9” occupy the top row of the matrix. It will readily be appreciated that the numbers “1” to “3” and “7” to “9” may be interchanged so that the top row comprises the numbers “1” to “3” and the bottom row comprises the numbers “7” to “9”. However, irrespective of the allocated numbers to the keys, the central location (corresponding to the number “5”) is a validation key and forms a neutral position from which all movements are determined.

In this embodiment, keys “8” and “2” correspond respectively to movements ‘up’ and ‘down’; keys “4” and “6” correspond respectively to movements ‘left’ and ‘right’; and keys “7”, “9”, “1” and “3” correspond respectively to ‘up and left’, ‘up and right’, ‘down and left’ and ‘down and right’. Each of these keys can be considered to be a location in an irregular hexagon centred around the neutral position. In each instance, the user returns to the central or neutral position corresponding to the key “5” for validation of a selection of a sequence of keys to provide the targeted CC.

When a keypad is implemented on a touch-sensitive surface, lifting of the finger or object in contact with the surface from “5” provides the validation.

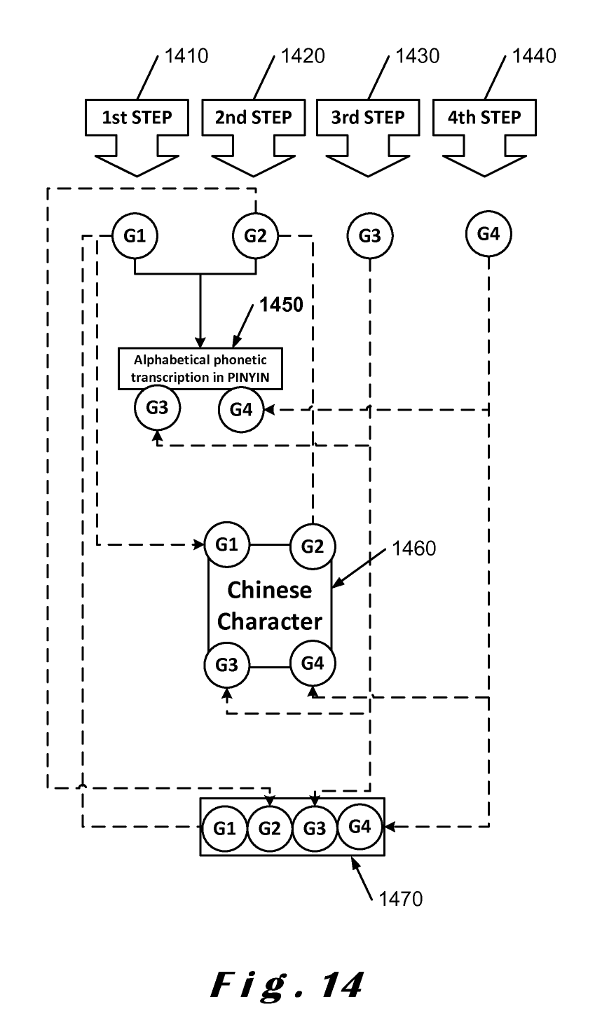

Referring now to FIG. 12, a table 1200 is shown which comprises four columns 1210, 1220, 1230, 1240, each column illustrating the following information for one of the classifications of CCs as described above:

Column 1210 illustrates a CC together with its alphabetical phonetic transcription in Pinyin;

Column 1220 illustrates a numerical sequence that can be entered using a keypad to provide the targeted CC using its unique PUDASHU code (the “O” indicating where no input is required to be input by the user) and the encoding tag;

Column 1230 illustrates the keys that need to be selected to provide the CCs shown in column 1210—the selection of “7”, “8”, “9”, “1”, “2” and “3” being possible directions at all steps; “4” and “6” being possible directions at the fourth input step only; and “5” being the validation key for selection of the targeted CC; and

Column 1240 illustrates a visualisation of a user traversing the input path on a touch sensitive surface with the block on the end indicating the end of the input path.

Rows 1250, 1255, 1260, 1265, 1270, 1275, 1280 and 1285 respectively illustrate examples of CCs which are categorised as being a “PRIC”, a “PRUC”, a “SUCu”, a “SICO”, a “DUCAMa”, a “BUCABa”, a “HUCa-6g” and a “HUCa-18y”, these categories having been described above. For each row 1250, 1255, 1260, 1265, 1270, 1275, 1280, 1285, column 1210 illustrates the simplified form of the CC and, when appropriate, the traditional form of the CC; column 1230 illustrates the keys of the keypad which need to be used; and column 1240 illustrates the movement on a touch-sensitive surface.

Row 1250 provides an example of a CC which is categorised as a PRIC, namely, [symbol] ( [symbol] ) (ge). For this CC, the traditional (fanti zi) form of the CC is also shown in parenthesis in column 1210; and the sequence of numbers which needs to be encoded is “935”, which corresponds to a movement ‘up and right’ followed by a movement ‘down and right’ and the validation of the selection is shown.

Row 1255 provides an example of a CC which is categorised as a PRUC, namely, [symbol] (neng). For this CC, the sequence of numbers which needs to be encoded is “3129”, which corresponds to a movement ‘down and right’ followed by movements ‘down and left’, ‘down’ and ‘up and right’ is shown.

Row 1260 provides an example of a CC which is categorised as a SUCu, namely, [symbol] (cai). For this CC, the sequence of numbers which needs to be encoded is “828387”, which corresponds to a movement ‘up’ followed by movements ‘down’, ‘up’, ‘down and right’, ‘up’ and ‘up and left’ is shown.

Row 1265 provides an example of a CC which is categorised as a SICO, namely, [symbol] (ban). For this CC, the sequence of numbers which needs to be encoded is “8382892”, which corresponds to a movement ‘up’ followed by movements ‘down and right’, ‘up’, ‘down’, ‘up’, ‘up and right’ and ‘down’ is shown.

Row 1270 provides an example of a CC which is categorised as a DUCAMa, namely, [symbol] (mo). For this CC, the sequence of numbers which needs to be encoded is “3237215”, which corresponds to a movement ‘down and right’ followed by movements ‘down’, ‘down and right’, ‘up and left’, ‘down’ and ‘down and left’ followed by the validation key is shown.

Row 1275 provides an example of a CC which is categorised as a BUCABa, namely, [symbol] (ling). For this CC, the sequence of numbers which needs to be encoded is “3993194”, which corresponds to a movement ‘down and right’ followed by movements ‘up and right’, ‘up and right’, ‘down and right’, ‘down and left’, ‘up and right’ and ‘left’ is shown.

Row 1280 provides an example of a CC which is categorised as a HUCa-6g, namely, [symbol] (xiao). For this CC, the sequence of numbers which needs to be encoded is “1231326”, which corresponds to a movement ‘down and left’ followed by movements ‘down’, ‘down and right’, ‘down and left’, ‘down and right’, ‘down’ and ‘right’ is shown.

Row 1285 provides an example of a CC which is categorised as a HUCa-18y, namely, [symbol] (yi). For this CC, the sequence of numbers which needs to be encoded is “91713218”, which corresponds to a movement ‘up and right’ followed by movements ‘down and left’, ‘up and left’, ‘down and left’, ‘down and right’ ‘down’, ‘down and left’ and ‘up’ is shown.

The logic of the PUDASHU input method is such that shortcuts can be designed for speeding up the encoding process of one or more CCs included in the PDS-db, as described above.

Shortcuts can also be designed, for example, by assigning an alternative (and faster) input path (based upon an alternative unique code) to a CC that can be used instead of the standard input path thereof (based upon its standard unique code). Assigning an alternative input code to a series of CCs and a corresponding alternative input path can be done when, instead of applying the PUDASHU input method to the 8,536 CCs and their 9,558 alphabetical phonetic transcriptions currently included in the PDS-db, the method is applied to a selection of such CCs and alphabetical phonetic transcriptions. The selection is made on the basis of the higher frequency of use of the CCs currently included in the PDS-db, which results in a “Reduced PDS-db” made of approximately 3,105 alphabetical phonetic transcriptions associated with CCs.

A first series of shortcuts that can be activated and used only when the PUDASHU input method is applied to the Reduced PDS-db relates to CCs having an alphabetical phonetic transcription identical to the alphabetical phonetic transcription of one of the 28 Alphabetical CCs. If one uses the current PDS-db, encoding the 1,375 CCs having an alphabetical phonetic transcription identical to the alphabetical phonetic transcription of one of the 28 Alphabetical CCs requires the activation of the NO1GO2 function for bypassing the first input step, which, in the preferred embodiment, is performed by a gesture in the direction of 7 ( [symbol] ) followed by a gesture in the direction of 1 ( [symbol] ). The indicated directions relate to the direction of movement from a central position 5 of a numeric keypad as described above with reference to FIG. 12. The Reduced PDS-db contains 481 CCs having an alphabetical phonetic transcription identical to the alphabetical phonetic transcription of one of the 28 Alphabetical CCs, that is, approximately 15% of the 3,105 CCs included in the Reduced PDS-db.

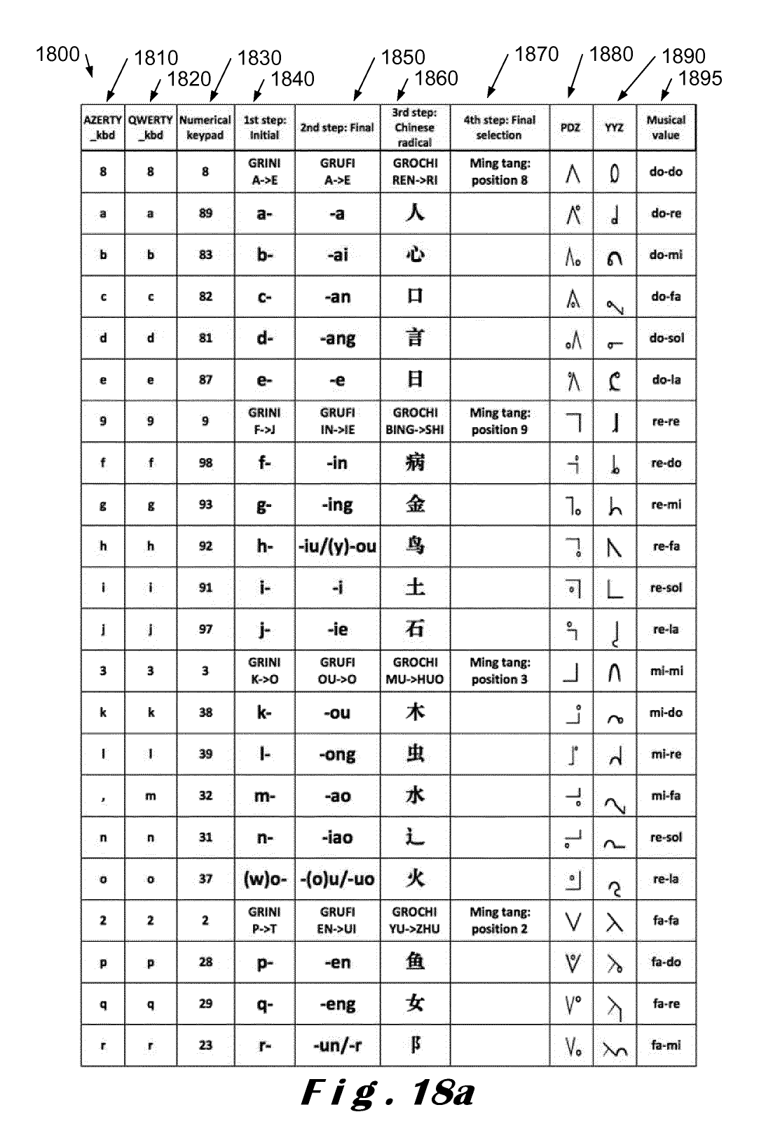

As a shortcut of this first series, each of the most frequently used CCs (hereinafter called “Alphabetical CC-7”) after each of the 28 Alphabetical CCs is assigned an alternative input path made of the input path of the alphabetical phonetic transcription of the relevant Alphabetical CC followed by a gesture in the direction of 7 ( [symbol] ) and then by the user removing his finger from the touch-sensitive surface (such removal being expressed by the number 5 on the numeric keypad as described above with reference to FIG. 12). The availability of an alternative input path for each Alphabetical CC-7 is identified by a “`” (grave accent) at the end of its Pinyin transcription or above its expression in one of the symbolic representation systems described below. For example, as shown in FIG. 16 and described in more detail below, the Alphabetical CC corresponding to the letter “d” is [symbol] , with “de” being its alphabetical phonetic transcription and “81500000” its unique code in the current PDS-db of 9,558 alphabetical phonetic transcriptions associated with 8,536 CCs. In the reduced PDS-db, the Alphabetical CC-7 corresponding to the letter “d” is [symbol] , with “de`” as its alphabetical phonetic transcription and “81750000” as its alternative unique code. In the current PDS-db of 9,558 alphabetical phonetic transcriptions associated with 8,536 CCs, the CC [symbol] , which has DUCABU in its encoding tag, has “81713150” as its standard unique code.

As another shortcut of this first series, the next most frequently used CC (hereinafter called “Alphabetical CC-71”) after each of the 28 Alphabetical CC-7s is assigned an alternative input path made of the input path of the alphabetical phonetic transcription of the relevant Alphabetical CC followed by a gesture in the direction of 7 ( [symbol] ), by a gesture in the direction of 1 ( [symbol] ) and then by the user removing his finger from the touch-sensitive surface (such removal being expressed by the number 5 on the numeric keypad as described above with reference to FIG. 12). The availability of an alternative input path for each Alphabetical CC-71 is identified by a “̂” (circumflex accent) at the end of its Pinyin transcription or above its expression in one of the symbolic representation systems described below. For example, as shown in FIG. 16 and described in more detail below, the Alphabetical CC-71 corresponding to the letter “d” is [symbol] , with “dê” as its alphabetical phonetic transcription and “81715000” as its alternative unique code in the Reduced PDS-db. In the current PDS-db of 9,558 alphabetical phonetic transcriptions associated with 8,536 CCs, the CC [symbol] , which has BUCABU in its encoding tag, has “81713140” as its unique code.

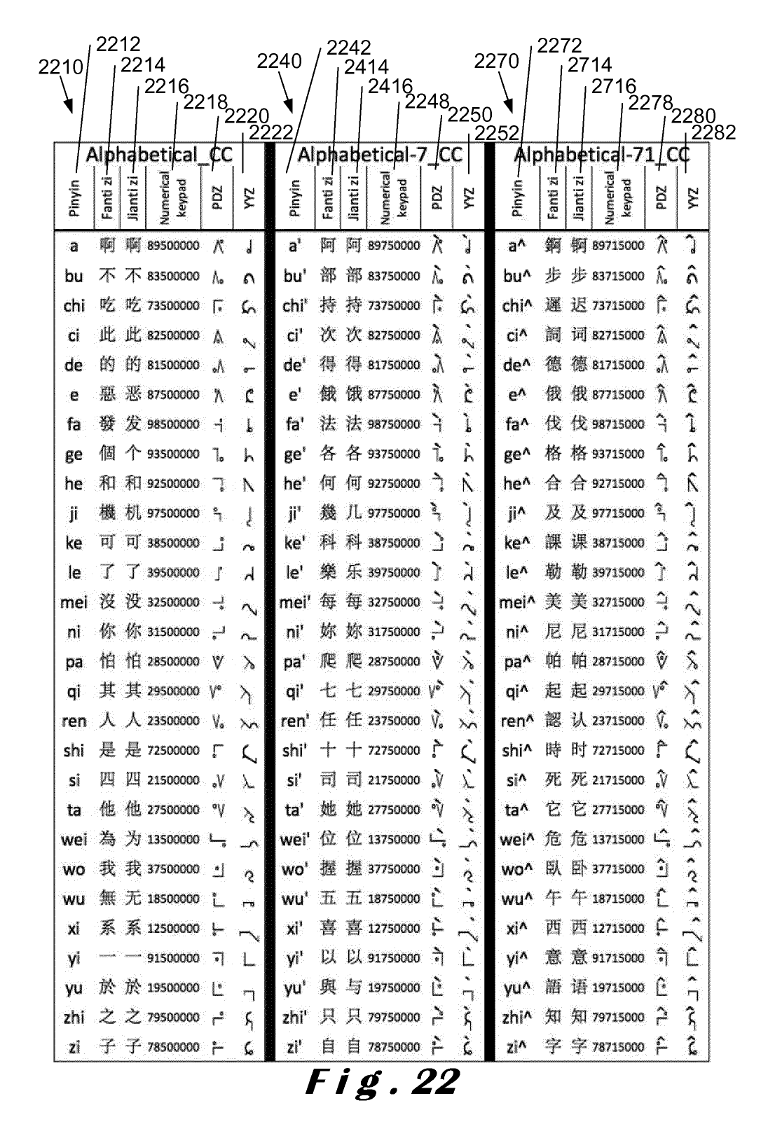

When the PUDASHU input method is applied to the Reduced PDS-db, each of the CCs, other than the Alphabetical CCs, the Alphabetical CC-7s and the Alphabetical CC-71s, having an alphabetical phonetic transcription identical to one of the 28 Alphabetical CC requires, for its encoding, the activation of the NO2GO3 function, which is indicated with a “̂” (circumflex accent) above the symbolic representation, as described below with reference to FIG. 22, of the initial component of its alphabetical phonetic transcription.

A second series of shortcuts that can be activated and used only when the PUDASHU input method is applied to the Reduced PDS-db relates to the third input step.

As a shortcut of this second series, one CC with a high frequency of use is assigned an alternative unique code triggering the display of such a CC by the software after the user at the third input step has moved his finger in the first direction of such third input step. If the CC so displayed corresponds to the targeted CC the user selects that CC by removing his finger from the touch-sensitive surface. For example, the CC [symbol] (fu) is assigned in the Reduced PDS-db an alternative input path identified by the unique code “98188500” instead of the standard input path identified by the unique code “98188990” that such a CC is assigned in the current PDS-db of 9,558 alphabetical phonetic transcriptions associated with 8,536 CCs.

As another shortcut of this second series, one CC with a high frequency of use is assigned an alternative unique code triggering the display of such a CC by the software after the user at the third input step has moved his finger in the second direction of such third input step. If the CC so displayed corresponds to the targeted CC the user selects that CC by removing his finger from the touch-sensitive surface. For example, the CC [symbol] (fu) is assigned in the Reduced PDS-db an alternative input path identified by the unique code “98188950” instead of the standard input path identified by the unique code “98188980” that such a CC is assigned in the current PDS-db of 9,558 alphabetical phonetic transcriptions associated with 8,536 CCs.

A third series of shortcuts that can be activated and used only when the PUDASHU input method is applied to the Reduced PDS-db relates to switching back to the PDS-db of 9,558 alphabetical phonetic transcriptions associated with 8,536 CCs in the course of the input sequence for a given targeted CC.

As a shortcut of this third series, if the user has not selected a CC at the third step, all CCs remaining in conflict are presented to the user in a simplified matrix where the user can make his final selection. If the targeted CC is not among the CCs presented in such simplified matrix, the user can access the PDS-db containing 9,558 alphabetical phonetic transcriptions associated with 8,536 CCs by activating a NORdb-GOCdb function (for “NOt in Reduced PDS-db, GO to Complete PDS-db”), which is done by performing a gesture in the direction of 7 ( [symbol] ) followed by a gesture in the direction of 1 ( [symbol] ), which triggers the display of a Ming Tang where all CCs still in conflict are displayed and positioned on the basis of the information already entered by the user at the first, second and third input steps. One or more of the CCs so displayed in the Ming Tang may have been already displayed at a previous step when the user was using the Reduced PDS-db, but they will be displayed in the Ming Tang in such a way that the user is notified that they also have been assigned an alternative code and therefore and alternative input path which the user can use instead of the standard input path when the CC is to be encoded again.

As another shortcut of this third series, the user can activate the NORdb-GOCdb function after having performed the second input step, such activation being done by performing a gesture in the direction of 7 ( [symbol] ) followed by a gesture in the direction of 1 ( [symbol] ), which triggers the display of the fifth set of hexagons where the user selects the GROCHI and then, in the sixth set of hexagons, selects the Chinese radical associated with the targeted CC.

As a further shortcut of this third series, the user can activate the NORdb-GOCdb function after having performed the first part of the third input step, such activation being done by performing a gesture in the direction of 7 ( [symbol] ) followed by a gesture in the direction of 1 ( [symbol] ), which triggers the display of the sixth set of hexagons where the user selects the Chinese radical associated with the targeted CC.

The Alphabetical CCs, the Alphabetical-7 CCs and the Alphabetical-71 CCs are described with reference to FIG. 22 below.

In one embodiment of the invention, the Reduced PDS-db can be merged into the PDS-db comprising 8,536 CCs and their 9,558 alphabetical phonetic transcriptions. As a consequence of the way the shortcuts associated with the Reduced PDS-db are structured, some of the CCs included in the Reduced PDS-db need to be assigned an alternative unique code that would be identical, and therefore would conflict with, a standard unique code assigned to another CC in the PDS-db comprising 8,536 CCs and their 9,558 alphabetical phonetic transcriptions. For example, the CC [symbol] ( [symbol] ) (ci), included in the Reduced PDS-db because of its high frequency of use needs, as a consequence of the shortcut used, to be assigned the alternative unique code “82718200” whereas its standard unique code would be “82718220”. The alternative unique code “82718200” is identical to, and would therefore conflict with, the standard unique code “82718250”, since “5” indicates that the user needs to validate and “O” indicates that the software in the computerised system will automatically validate. For avoiding conflicts of that nature, and with the aim of simplifying the input path of CCs with a high frequency of use, such CCs of which the unique codes would otherwise conflict have been each assigned the conflicting unique code of the other, which means that each of them is assigned in the Ming Tang the location that the other would have been assigned if no such shortcut had been applied. As a reminder of this exchange of unique codes and of this amended positioning in the Ming Tang, the encoding tag of each of such CCs is supplemented at the end by “sh” (for “shortcut”). In the example described above, the CC [symbol] ( [symbol] ) (ci) which has SICO as its encoding tag and should have been positioned in location 2 in the Ming Tang is positioned as the Emperor CC in location 5, with “82718250” as its unique code and with “SICOsh” as its encoding tag, whereas the CC [symbol] (ci) is positioned in location 2 in the Ming Tang, with “82718220” as its unique code and with “SICAsh” as its encoding tag.

If a user of the PUDASHU input method wishes to encode a targeted CC for which he/she does not know the alphabetical phonetic transcription in Pinyin, which prevents him/her from performing the Initial Phonetic step and the Final Phonetic step, the user can proceed as follows: the user first selects and activates the NO1GO2 function and then selects and activates the NO2GO3 function and the successive activation of these two functions triggers the shift by the computerised system to a set of special codes included in the PDS-db, one for each of the CCs included in the PDS-db and distinct from the standard unique code used by the PUDASHU input method for each of such CCs. Such special codes, called “Shape Codes” have been created by decomposing each CC included in the PDS-db into a sequence of Chinese radical shapes and/or components comparable to a shape, with each of such radicals and components being associated with a distinct letter of the Latin alphabet in accordance with the classification described above of the 214 classes of Chinese radicals. The order of decomposition of each CC for the purposes of determining the Shape Codes follows the traditional order of writing strokes when writing CCs, that is, from top to bottom and from left to right, it being understood that the units are not strokes but Chinese radical shapes or components comparable to shapes.

For encoding a targeted CC, the user selects the letter corresponding to the first Chinese radical shape or component comparable to shapes, which triggers the retrieval by the software in the PDS-db of a first subset of CCs having the same first Chinese radical shape or component comparable to shapes. If the first subset contains nine CCs or less than nine, the software displays them in a Ming Tang where the user can select the targeted CC.

If the first subset contains more than nine CCs, the user needs to proceed to the next step and selects the letter corresponding to the second Chinese radical shape or component comparable to shapes, which triggers the retrieval by the software in the first subset of CCs of a second subset of CCs having the same second Chinese radical shape or component comparable to shapes. If the second subset contains nine CCs or less, the software displays them in a Ming Tang where the user can select the targeted CC.

If the second subset contains more than nine CCs, the user needs to proceed to the next step and selects the letter corresponding to the third Chinese radical shape or component comparable to shapes, which triggers the retrieval by the software in the second subset of CCs of a third subset of CCs having the same third Chinese radical shape or component comparable to shapes.

If the third subset contains nine CCs or less, the software displays them in a Ming Tang where the user can select the targeted CC. If the third subset contains more than nine CCs, the user needs to proceed to the next step and selects the letter corresponding to the fourth Chinese radical shape or component comparable to shapes, which triggers the retrieval by the software in the third subset of CCs of a fourth subset of CCs having the same fourth Chinese radical shape or component comparable to shapes.

If the fourth subset contains nine CCs or less, the software displays them in a Ming Tang where the user can select the targeted CC. If the fourth subset contains more than nine CCs, the user needs to proceed to the next step and selects the letter corresponding to the fifth Chinese radical shape or component comparable to shapes, which triggers the retrieval by the software in the fourth subset of CCs of a fifth subset of CCs having the same fifth Chinese radical shape or component comparable to shapes.

If the fifth subset contains nine CCs or less, the software displays them in a Ming Tang where the user can select the targeted CC. If the fifth subset contains more than nine CCs, the user needs to proceed to the next step and selects the letter corresponding to the sixth Chinese radical shape or component comparable to shapes, which triggers the retrieval by the software in the fifth of a sixth subset of CCs having the same sixth Chinese radical shape or component comparable to shapes.

If the sixth subset contains nine CCs or less, the software displays them in a Ming Tang where the user can select the targeted CC. If the sixth subset contains more than nine CCs, the software displays them in a list where the user can select the targeted CC. When CCs are displayed in a Ming Tang, they are positioned in each of the nine locations in an order of priority based on the highest frequency of use, such order of priority being determined as follows for the nine locations (as shown in FIG. 1): 5 followed by 8 followed by 2 followed by 4 followed by 6 followed by 9 followed by 3 followed by 7 followed by 1.

If the user, after having gone through the process described above, does not find the targeted CC, he/she can select and activate successively the NO1GO2, the NO2GO3 function and a specific function (called “NOPDS-dbGOtoOM”, where “OM” stands for “Other Method”), which gives him access to a larger database of CCs where, using another input method, such as the “Four Corners” method described above, he/she can search for the targeted CC.

In addition to inputting CCs, the user can select punctuation or another symbol and insert it after a given CC once, as described above, the selection of the targeted CC is final, and, the targeted CC is stored by the computerised system in a computerised format for further processing. Such punctuation, and other symbols, are presented to the user in a group of punctuation and other symbols (hereinafter referred to as “GRUPU”) in further hexagon arrangements (not shown). A series of punctuation and other symbols are allocated from hexagon 860Y or hexagon 960Y associated with “y”, as described above, with reference to respective ones of FIGS. 8 and 9.

Although not illustrated, it will readily be appreciated that punctuation and other symbols can be selected from further hexagon arrangements (which may be termed “Punctuation Keyboard” or “Punctuation Hexagons” and levels in a similar way to the selection of the initial and final components (first and second input steps) and the first stage of the Chinese radical (third input step) as described above. For example, symbol “,” (comma) is assigned to hexagon 860Y or hexagon 960Y in the second level hexagons of the first input step, which when selected places the finger in a central hexagon around which a further hexagon arrangement is displayed with; symbols such as “ ” “(left-hand double quote or speech mark) and” “ ” (right-hand double quote or speech mark); “'” (apostrophe); “ [symbol] ” and “ [symbol] ”; “┌” and “┘”; “ [symbol] ” and “ [symbol] ”; “ [symbol] ” and “ [symbol] ”; “(” and “)”; “[” and “]”; “ [symbol] ” and “ [symbol] ”; “ [symbol] ” and “ [symbol] ”; “ [symbol] ” and “ [symbol] ”; “{” and “}”; “.” (full stop); “!” (exclamation mark); “ . . . ” (ellipses); “:” (colon); “?” (question mark); and “;” (semi-colon) being assigned to hexagons within one or more hexagon arrangement with hexagon 860Y as the central hexagon (compare with the start point of FIG. 8; the initial component of the alphabetical phonetic transcription of FIG. 10; and the complete alphabetical phonetic transcription of FIG. 11) with six hexagons arranged the central hexagon, selection of one of the six hexagons providing a different hexagon arrangement with more symbols or punctuation.

However, in contrast to the first and second level hexagons of the first input step (initial component of the alphabetical phonetic transcription of a targeted CC), the third and fourth level hexagons of the second input step (final component of the alphabetical phonetic transcription of a targeted CC), and the fifth and sixth level hexagons of the third input step (Chinese radical associated with the alphabetical phonetic transcription of a targeted CC), all of the seven hexagons of the punctuation keyboard may be used. The most used punctuation may be allocated to the central hexagon for its easy selection.

For example, commonly used symbols or punctuation may be assigned to the six first level punctuation hexagons and the central hexagon with the less frequently used symbols or punctuation being positioned in second level punctuation hexagons (compare with the GRUFI of the final phonetic component of FIG. 10 and the GROCHI of the Chinese radicals of FIG. 11).

In one embodiment of the present invention, the allocation of the punctuation and other symbols is made to form three distinct GRUPUs as follows: GRUPU A includes ““” and “””, “'”, “ [symbol] ” and “ [symbol] ”, “┌” and “┘”, “ [symbol] ” and “ [symbol] ” “ [symbol] ” and “ [symbol] ” and is assigned to one of the first level punctuation hexagons; GRUPU B includes “.”, “!”, “ . . . ”, “:”, “?”, “;” and is assigned to another one of the first level punctuation hexagons; and GRUPU C includes “(” and “)”, “[” and “]” “ [symbol] ” and “ [symbol] ”, “ [symbol] ” and “ [symbol] ”, “ [symbol] ” and “ [symbol] ”, “{” and “}” and is assigned to a further one of the first level punctuation hexagons.

Hexagons may be kept empty and inactive if not needed, and in each second level punctuation hexagons, hexagons positioned in the same direction as the first movement made from the central hexagon of the first level punctuation hexagons of the Punctuation Keyboard are not assigned any function and are empty and inactive. In a similar way to that described above with reference to FIGS. 8, 10 and 11, the software will register movement into these empty and inactive hexagons as an extension of the movement made by the user in the same direction from the central hexagon of the first level punctuation hexagons and not as a different movement. It will readily be appreciated that, in a variation of this embodiment or in other embodiments of the invention, one or more of such empty and inactive hexagons can be made active and assigned a function that the user can select.

The selection by the user of one of the punctuation or other symbols is made by establishing an initial finger contact with the touch-sensitive surface, which triggers the activation and the display, around the position of the initial finger contact, of the first level hexagons corresponding to the initial component as indicated by hexagons 820′, 830′, 840′, 850′, 860′, 870′ as shown in FIG. 8, and, by moving the finger, without lifting it from the touch-sensitive surface, in the direction of arrow 815, into the perimeter of hexagon 860′ to activate and display the second level hexagons including hexagon 860Y, and then into the perimeter of hexagon 860Y to which “y” has been assigned, which triggers the activation and the display around the position of the finger of the first level punctuation hexagons, with the finger automatically positioned within the perimeter of hexagon 860Y, and then by proceeding as follows, in each case below, lifting of the finger from the touch-sensitive surface is detected by the software which then, retrieves in the PDS-db the relevant symbol and stores it in the computerised system in a computerised format for further processing, and, displays the selected symbol in the Output Window next to the previous targeted CC or symbol retrieved and stored for further processing purposes and displayed in the Output Window:

for selecting the “,” symbol, the user lifts such finger from the touch-sensitive surface from within the perimeter of hexagon 860Y to which the “,” symbol has also been assigned;

for selecting symbols in GRUPU B, the user moves the finger on the touch-sensitive surface from hexagon 860Y in the direction, and within the perimeter, of the hexagon corresponding to GRUPU B, which triggers the activation and the display around the position of such finger of the corresponding layout of the second level punctuation hexagons, with the finger being automatically positioned within the perimeter of the central hexagon, and lifts such finger from the touch-sensitive surface from within the perimeter of the hexagon, to which the relevant symbol has been assigned;

for selecting the “(” symbol, the user moves such finger on the touch-sensitive surface from hexagon 860Y in the direction, and within the perimeter, of the hexagon corresponding to GRUPU C, which triggers the activation and the display around the position of the finger of the corresponding layout of the second level punctuation hexagons, with the finger being automatically positioned within the perimeter of the central hexagon, and by lifting such finger from the touch-sensitive surface from within the perimeter of the hexagon, to which the “(” and the “)” symbols have been assigned, and, if the “(” symbol has not been previously selected, retrieved in the PDS-db and stored, the selection triggers the retrieval by the software in the PDS-db of the “(” symbol; and

for selecting the “)” symbol, the user moves the finger as described above for the “(” symbol, and by lifting the finger from the touch-sensitive surface from within the perimeter of the central hexagon, to which the “(” and the “)” symbols have been assigned, and, if the “(” symbol has been previously selected and retrieved from the PDS-db and stored, this selection triggers the retrieval by the software in the PDS-db of the “)” symbol.

The selection of other “paired” symbols, such as, “[” and “]”, “ [symbol] ” and “ [symbol] ”, “ [symbol] ” and “ [symbol] ”, “ [symbol] ” and “ [symbol] ”, “{” and “}”, ““” (left-hand double quote or speech mark) and “”” (right-hand double quote or speech mark), “ [symbol] ” and “ [symbol] ”, “┌” and “┘”, “ [symbol] ” and “ [symbol] ” “ [symbol] ” and “ [symbol] ” is performed the same way as both of the paired symbols are allocated to the same hexagon within the second level punctuation hexagons.

When the selection of the punctuation or other symbol is final as described above, the software automatically suppresses the display of the second level punctuation hexagons and automatically returns the touch-sensitive surface to a starting position and the user can establish a new initial finger contact with the touch-sensitive surface to initiate another input sequence for encoding another targeted CC or symbol, as described above.

Once, as described above, a CC or punctuation or other symbol has been retrieved in the PDS-db and stored in the computerised system in a computerised format for further processing and displayed in the Output Window, the user can insert a space after the last of these CC(s) or symbol(s) by tapping once on the touch-sensitive surface, this single tap being detected by the software, which automatically inserts a space and displays the space in the Output Window. After a single tap, the software automatically returns the touch-sensitive surface to a starting position and the user can establish a new initial finger contact with the touch-sensitive surface to initiate another input sequence for encoding another targeted CC, as described above.

As a variation, the single tap can be replaced by a finger movement on the touch-sensitive surface in the direction of arrow 813 (FIG. 8), followed by the lifting of the finger from the touch-sensitive surface.

Once, as described above, a CC, punctuation or other symbol has been retrieved in the PDS-db and stored in the computerised system in a computerised format for further processing and displayed in the Output Window, the user can delete the last of these CC(s) or symbols by tapping twice on the touch-sensitive surface. The software detects the double tap and automatically stops storing the CC, punctuation or symbol for further processing and no longer displays the CC, punctuation or symbol in the Output Window, and, automatically returns the touch-sensitive surface to a starting position and the user can establish a new initial finger contact with the touch-sensitive surface to initiate another input sequence for encoding another targeted CC, as described above.

As a variation, the single tap can be replaced by a finger movement on the touch-sensitive surface in the direction of arrow 815 (FIG. 8), followed by the lifting of the finger from the touch-sensitive surface.

As an alternative for deleting a CC, punctuation or other symbol at the end of a string of CCs or punctuation (or other symbol), the user can use the method described below for deleting a CC, punctuation or other symbol positioned anywhere within a string of CC and/or symbols.

If the user wishes to delete a CC, punctuation, other symbol or a space positioned anywhere within a string of CCs and/or symbols already retrieved, stored and displayed in the Output Window, the user establishes finger contact within the Output Window between the CC, punctuation, symbol or the space that the user wishes to delete, and, the next CC, punctuation, symbol or space displayed in the Output Window. The software detects such a contact and displays a blinking cursor where the finger is positioned, and the user, who can adjust the location of the blinking cursor by moving such finger on the touch-sensitive surface within the Output Window, then lifts the finger from the touch-sensitive surface and the software detects the lifting and returns to a starting position, and, the user can delete the CC, punctuation, symbol or space positioned at the left of the blinking cursor by tapping twice on the touch-sensitive surface, or by moving the finger in the direction of arrow 815 as described above. The software detects the double tap and automatically stops storing the CC, punctuation, symbol or space for further processing and automatically stops displaying the CC, punctuation, symbol or space in the Output Window and maintains the cursor where the deleted CC, punctuation, symbol or space was positioned, and, then automatically returns the touch-sensitive surface to a starting position and the user can establish a new initial finger contact with the touch-sensitive surface to initiate another input sequence for encoding another targeted CC, punctuation or other symbol, as described above, and, the new targeted CC or punctuation or other symbol, once encoded, is displayed at the left of the cursor. If the user wishes to encode another targeted CC, punctuation or other symbol for display at another position than the left of the cursor where such cursor is positioned, the user proceeds as described below for inserting a targeted CC, punctuation or other symbol.

If the user wishes to insert a targeted CC, punctuation, other symbol or a space anywhere within a string of CCs and/or symbols already retrieved, stored and displayed in the Output Window, the user establishes a finger contact within the Output Window where he/she wishes to insert a new targeted CC etc., and, the software detects the finger contact and displays a blinking cursor where the finger is positioned, and, the user, who can adjust the location of the blinking cursor by moving his/her finger on the touch-sensitive surface within the Output Window, then lifts the finger from the touch-sensitive surface and the software automatically returns the touch-sensitive surface to a starting position having detected the lifting of the finger from the touch-sensitive surface, and, the user can establish a new initial finger contact with the touch-sensitive surface to initiate another input sequence for encoding another targeted CC, punctuation or other symbol, as described above, and this new targeted CC, punctuation or other symbol, once encoded, is displayed to the left of the cursor, which has been automatically moved to the right of the new targeted CC, punctuation, or other symbol, once encoded.

The user can insert one or more figures by activating a switch function assigned to a hexagon, for example, the display of the Punctuation Keyboard or other elements, for switching from inputting CCs to provide the user with access to a numeric keypad, and, such a numeric keypad can be specifically designed for use with the four input steps of the present invention or a numeric keypad provided by another software installed on the same computerised system. Once the figure or figures have been inserted, the user activates the switch function for returning to the starting position for inputting a new targeted CC, punctuation or other symbol, and, the user can establish a new initial finger contact with the touch-sensitive surface to initiate another input sequence for encoding another targeted CC, as described above.

Once, as described above, a CC, punctuation or other symbol has been retrieved in the PDS-db and stored in the computerised system in a computerised format for further processing and displayed in the Output Window, the user can insert next to such a CC, punctuation or other symbol, one or more letters or symbols in another language by activating another switch function that provides the user access to the one or more arrangements relevant for the other written language. Once the letters or symbols in the other written language have been inserted, the user activates the switch function for returning to the starting position and the user can establish a new initial finger contact with the touch-sensitive surface to initiate another input sequence for encoding another targeted CC, as described above.

If the user wishes to insert one or more letters (or symbols) in another written language anywhere within a string of CCs and/or symbols already retrieved, stored and displayed in the Output Window, the user establishes a finger contact within the Output Window where he/she wishes to insert such letters or symbols, and, the software detects the contact and displays a blinking cursor where the finger is positioned, and the user, who can adjust the location of the blinking cursor by moving such finger on the touch-sensitive surface within the Output Window, then lifts the finger from the touch-sensitive surface and activates a switch function providing access to the letters or symbols relevant for the other written language, and, the user then proceeds, as described above in relation to the insertion of numbers or spaces, for inserting one or more letters or symbols in another written language.

For the purposes of speeding up the input process, when the user, after having encoded a targeted CC which, at the end of the input process, is displayed in the Output Window wishes to encode once again the same targeted CC, a shortcut function is provided that allows the user to encode again such same targeted CC without having to go again through the same whole input sequence. Such a shortcut function is operated as follows: after the software has returned to a starting position, the user establishes and maintains an initial finger contact with the touch-sensitive surface, which triggers the activation and display, around the position of the finger, of the first level hexagons of the initial component, with the finger being automatically positioned in the central hexagon of first level hexagons; the user then, within the perimeter of the central hexagon, moves the finger on the touch-sensitive surface, without lifting the finger from the touch-sensitive surface during a horizontal movement from right to left and then from left to right. The software detects such movement and retrieves in the PDS-db the same targeted CC and stores it in the computerised system in a computerised format for further processing and displays the same targeted CC in the Output Windows, and, returns to a starting position allowing the user to begin a new input sequence for encoding another targeted CC.

As described above, there are currently two main systems for encoding CCs into a computerised system and for storing them in a computerised format for further processing which are based on “physical” input devices, namely:

(i) using a physical keyboard or a touch-sensitive surface (which may display a virtual keyboard) as an input device with a phoneme-based or a shape-based input method; and

(ii) using a touch-sensitive surface with a handwriting recognition system as an input device. (As an alternative to input methods based on “physical” input devices, CCs can also be encoded using speech recognition systems.)

Current phoneme-based input methods use letters of the Latin alphabet and other symbols found on a Latin keyboard (for example a QWERTY keyboard) or “letters” of a non-Latin alphabet (for example Zhuyin Fuhao) found on a specifically designed keyboard. Current shape-based methods use “standard shapes” based on a mostly geometric decomposition of the graphological structure of each CC into components or elements and such “standard shapes” are found on a specifically designed keyboard, a QWERTY keyboard with a specific mapping to various “standard shapes”, or a touch-sensitive surface on which such “standard shapes” can be drawn. Handwriting recognition systems use the traditional “pen and paper” Chinese handwriting performed on a touch-sensitive surface.

Each of such current input methods allows, with its own limitations as to speed, accuracy and user-friendliness, the encoding of CCs, that is, the “production” of the computerised format of a targeted CC.

In each of the current phonetic-based and shape-based methods, the successive input steps required for “producing” the computerised format of a targeted CC with a given input device constitute together a unique input sequence. However, since in any of such methods (and their numerous variations) the complete input sequence for a given CC is the mere reproduction of a series of input steps on a specific input device, each of such unique input sequences cannot be used for anything else than “producing” the computerised format of such targeted CC with such given method and with such same input device. Moreover, the “record” of such an input sequence, if stored, does not constitute anything else than a “record” of the “production” sequence and cannot be used for other processing purposes than for repeating the input sequence with the same input method and with the same input device.

In handwriting recognition systems, the input sequence is identical to the sequence for the “pen and paper” handwriting and therefore cannot, when stored, be used for other processing purposes than for “producing” again the computerised format of the same targeted CC.

The PUDASHU input method has the following differences and advantages when compared to the current input methods:

a. Unique code for each alphabetical phonetic transcription—Each of the steps in the input sequence for each alphabetical phonetic transcription of the CCs included in the PUDASHU database (that is, currently 8,536 CCs and 9,556 alphabetical phonetic transcriptions, but there are no limits to expanding the number of CCs and alphabetical phonetic transcriptions) is assigned a distinct code (also included in the PUDASHU database), and, the sequential combination of each of the distinct codes associated with each step in the sequence constitutes a unique code for the alphabetical phonetic transcription of the CC with which it is associated and, as a consequence, for the “production” of the computerised format of such CC;

b. Reference geometrical structure—Since the input sequence for each of the alphabetical phonetic transcriptions in the PUDASHU database is based on a reference geometrical structure, each unique code is by definition governed by the logic (independent of the input device used for encoding the targeted CC) inherent to such geometrical structure and can therefore be used for encoding any CC included in the database with any input device (touch-sensitive surface of any size or physical or virtual keypad as described above, or gesture recognition system as described below, etc.) as long as such an input device is configured on the basis of the logic of such a reference geometrical structure;

c. Unique input path—On touch-sensitive devices, using the input sequence of the PUDASHU input method for encoding a CC amounts to traversing an input path on the touch-sensitive surface, and, such an input path is as unique as the unique code for the alphabetical phonetic transcription of the CC;

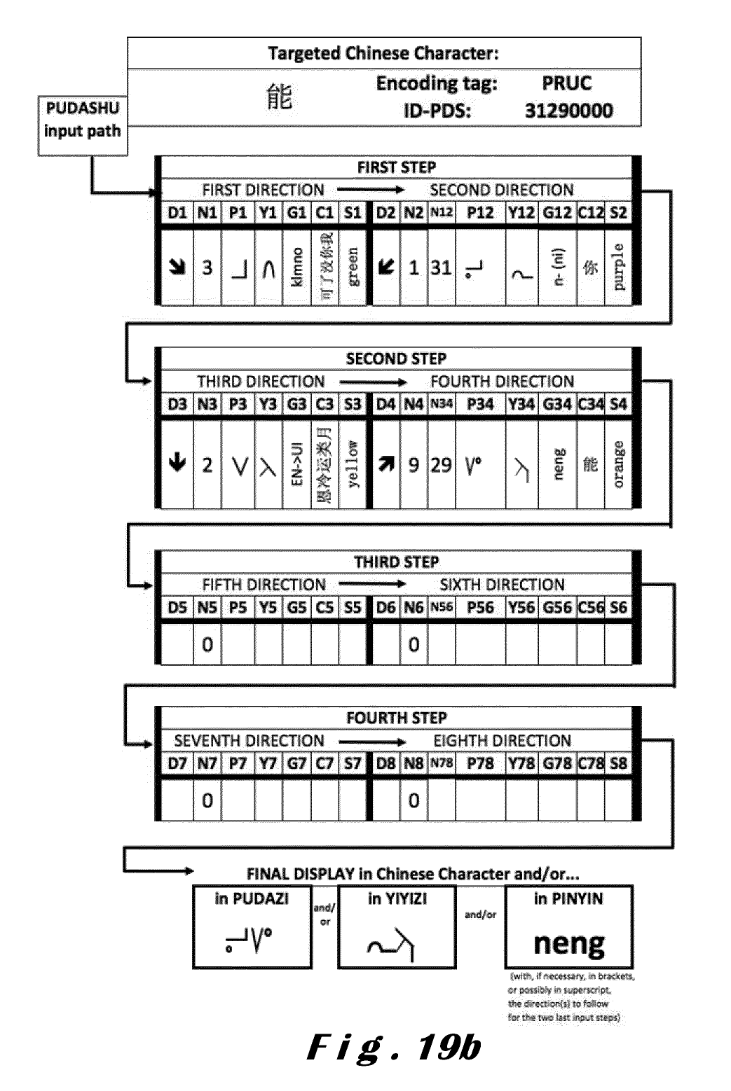

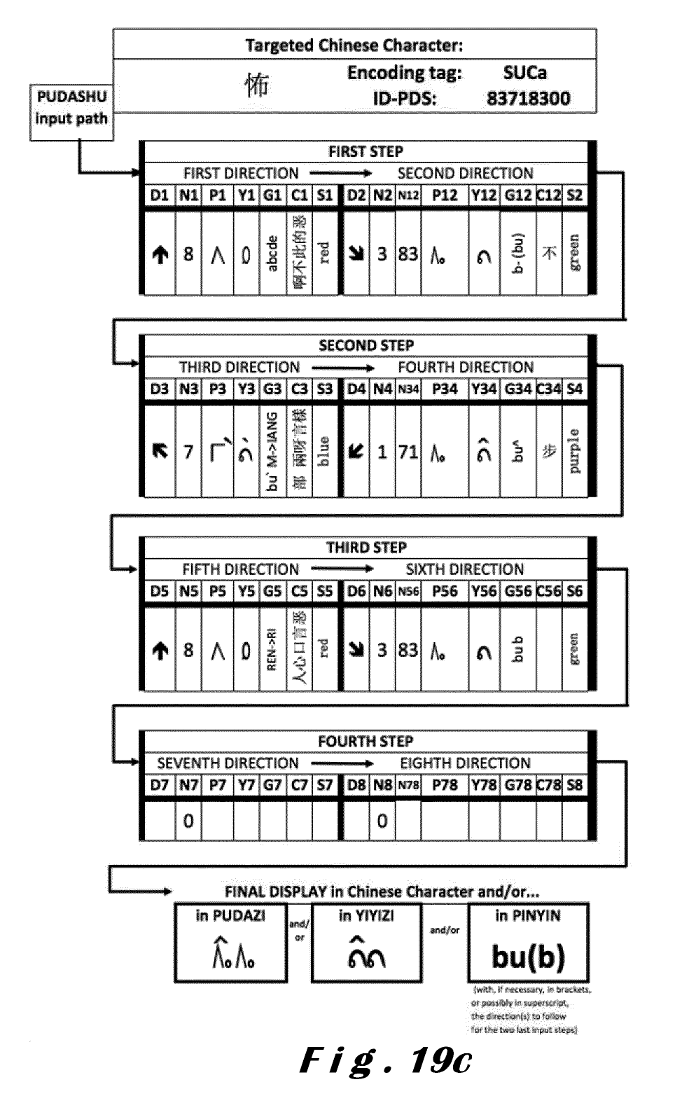

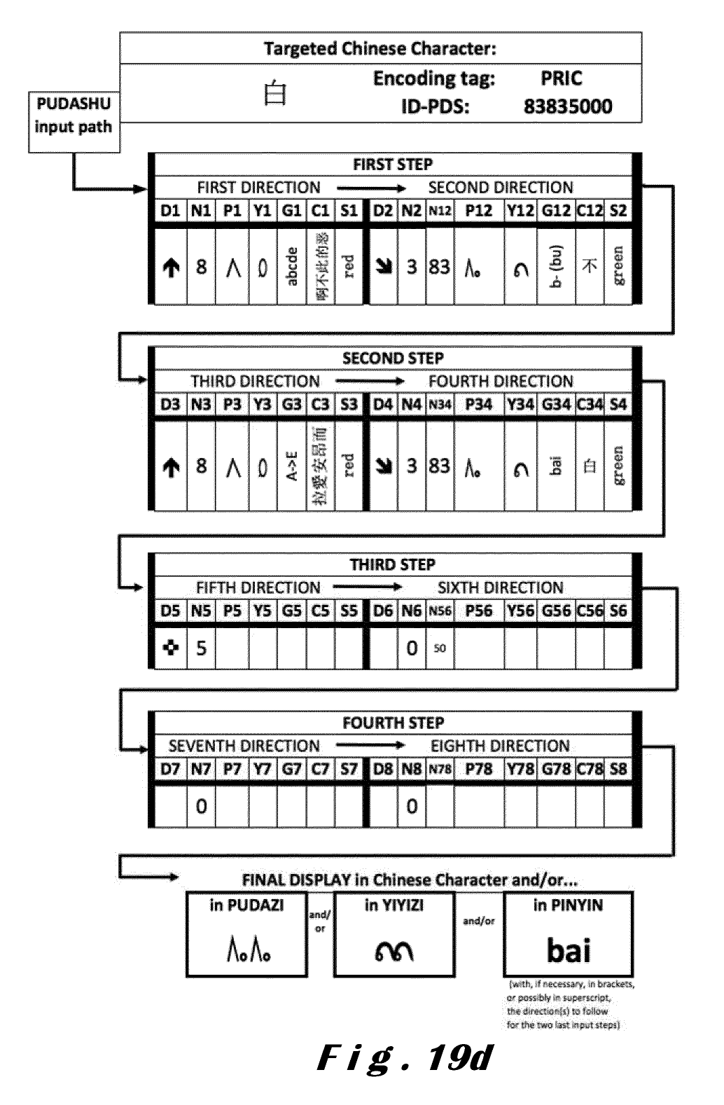

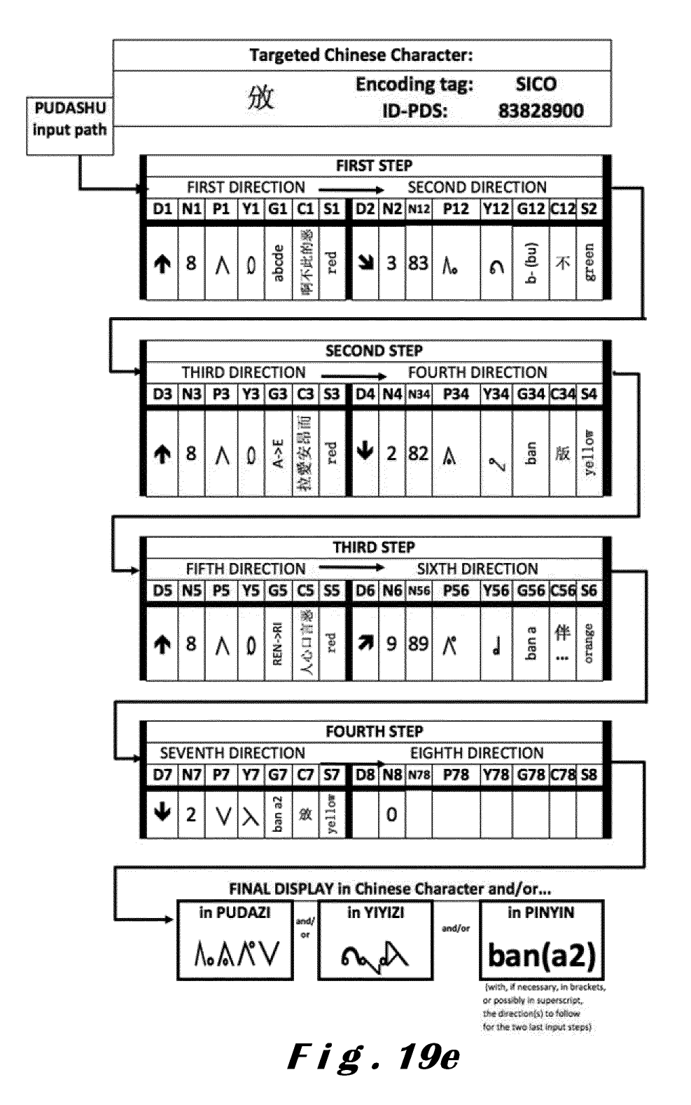

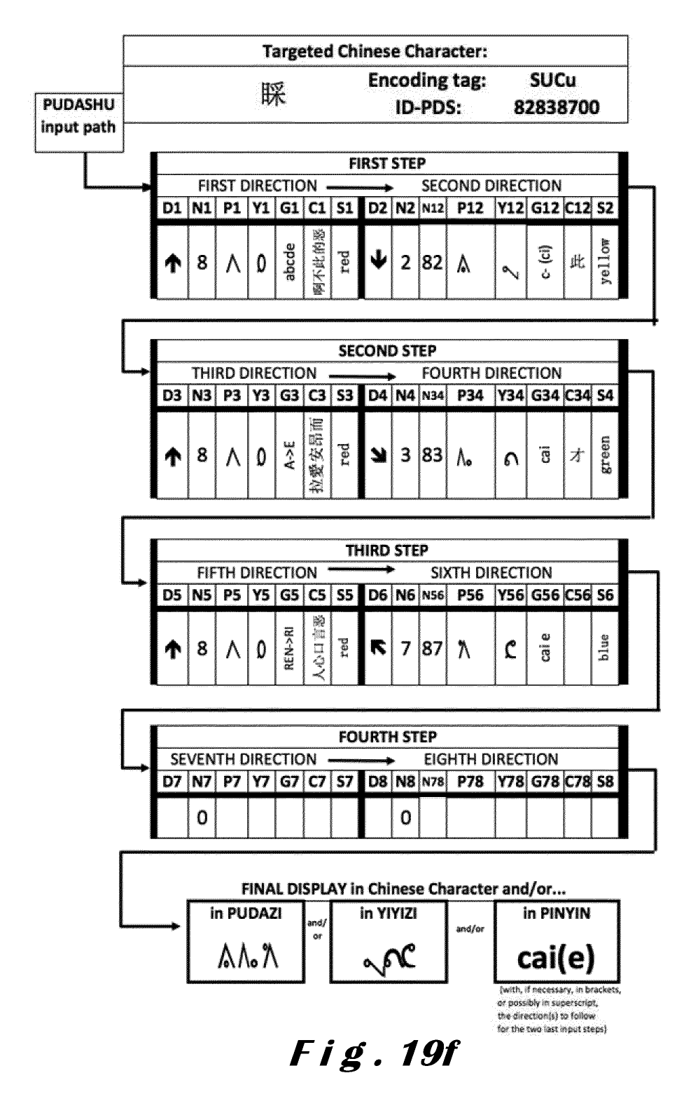

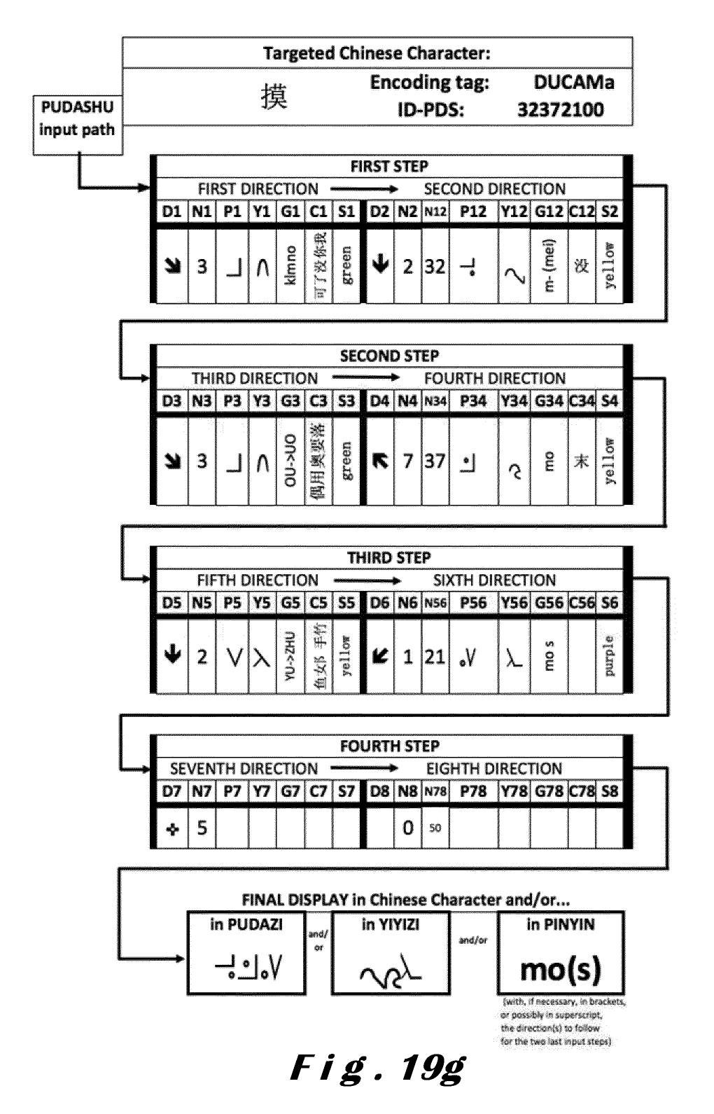

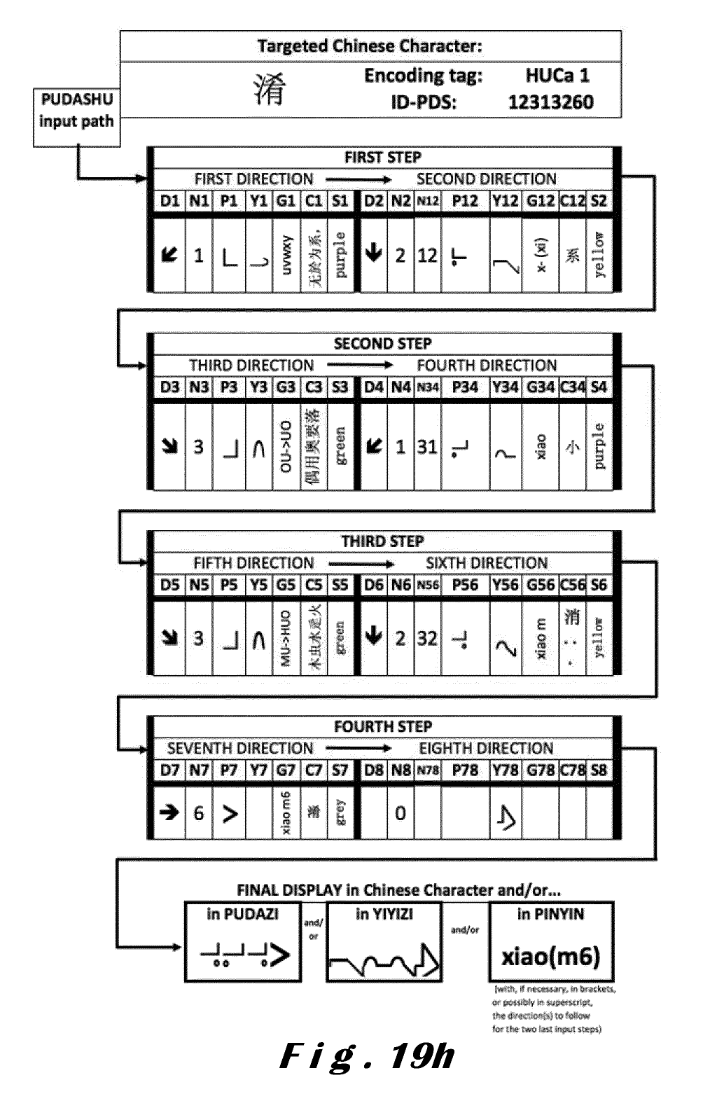

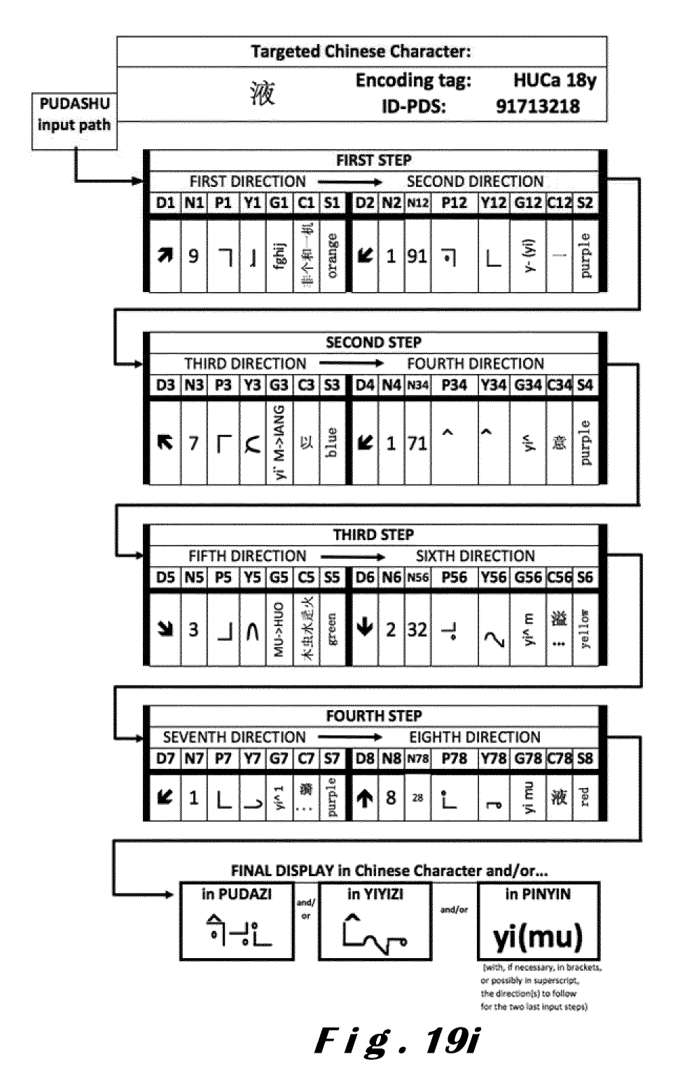

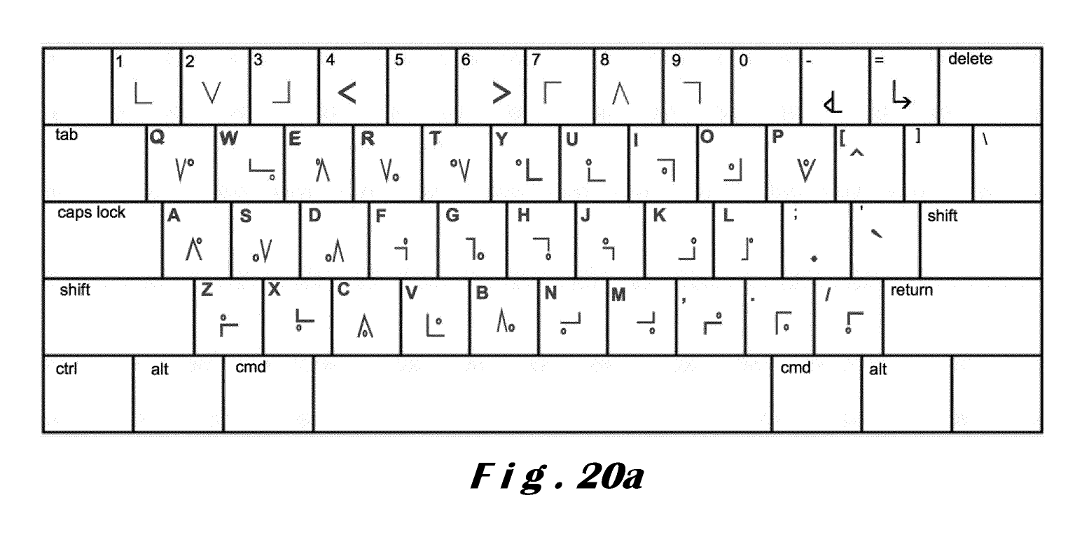

d. Unique symbolic representation of a CC—Traversing a unique input path on a touch-sensitive surface also amounts to tracing a unique symbolic representation of the CC corresponding to the unique code associated with this unique input path. This new unique symbolic representation can take the form of the unique input path traversed with a finger on a touch-sensitive surface, as shown in FIGS. 12, 15, 21a and 21b and described in more detail below. A more user-friendly unique symbolic representation consists, as shown in FIGS. 19a to 19i and as described in more detail below, of representing each of the maximum four input steps along the unique input path for a given CC by a distinct glyph representing a direction in the reference geometrical structure or, when two directions are required for a given input step, by a combination of two such distinct glyphs. It should be noted that the unique symbolic representation of a given CC is based upon a succession of directions of a continuous finger movement on a touch-sensitive surface and not on the combination of the strokes of which such CC is made in its traditional or simplified form of writing;

e. Heteronymous CCs and their meanings—Since heteronymous CCs, which have more than one alphabetical phonetic transcription, have as a consequence more than one unique input path (one for each of such alphabetical phonetic transcriptions) and corresponding input code, each of such heteronymous CCs also has a distinct unique symbolic representation for the specific meaning associated with each of its alphabetical phonetic transcriptions. This is in sharp contrast to a symbolic representation that would merely refer to the shape of a heteronymous CC, without distinguishing from its various meanings dictated by its various alphabetical phonetic transcriptions;

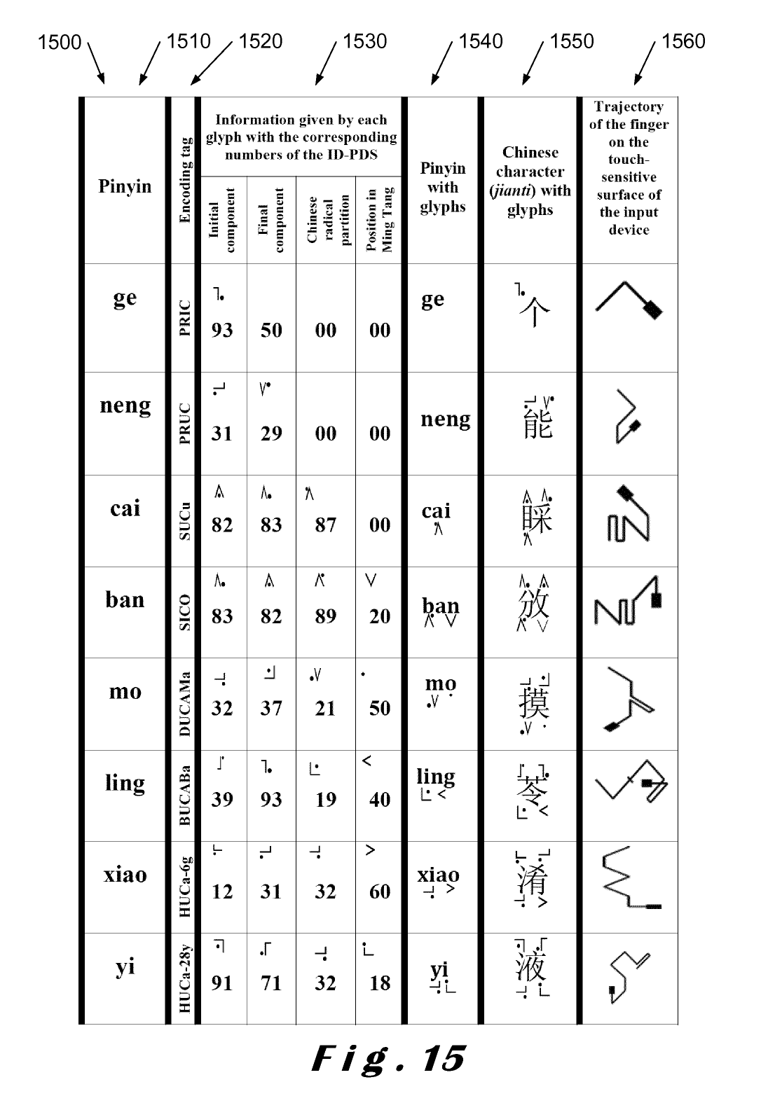

f. New symbolic representation system of CCs—The unique symbolic representation of a CC (or of each alphabetical phonetic transcription associated with a heteronymous CC) can be used, in the form of the traversing of the input path with a finger or in the form of glyphs as shown in FIGS. 13, 15, 18 and 22 and as described in more detail below, independently from the encoding process of the CC with which it is associated, and, together with the unique symbolic representations of the alphabetical phonetic transcription(s) of all the other CCs included in the PUDASHU database, constitutes therefore a new symbolic representation system for such CCs. Since any CC not yet included in the PDS-db can be added to such database, the new symbolic representation system can, in principle, cover all existing CCs;

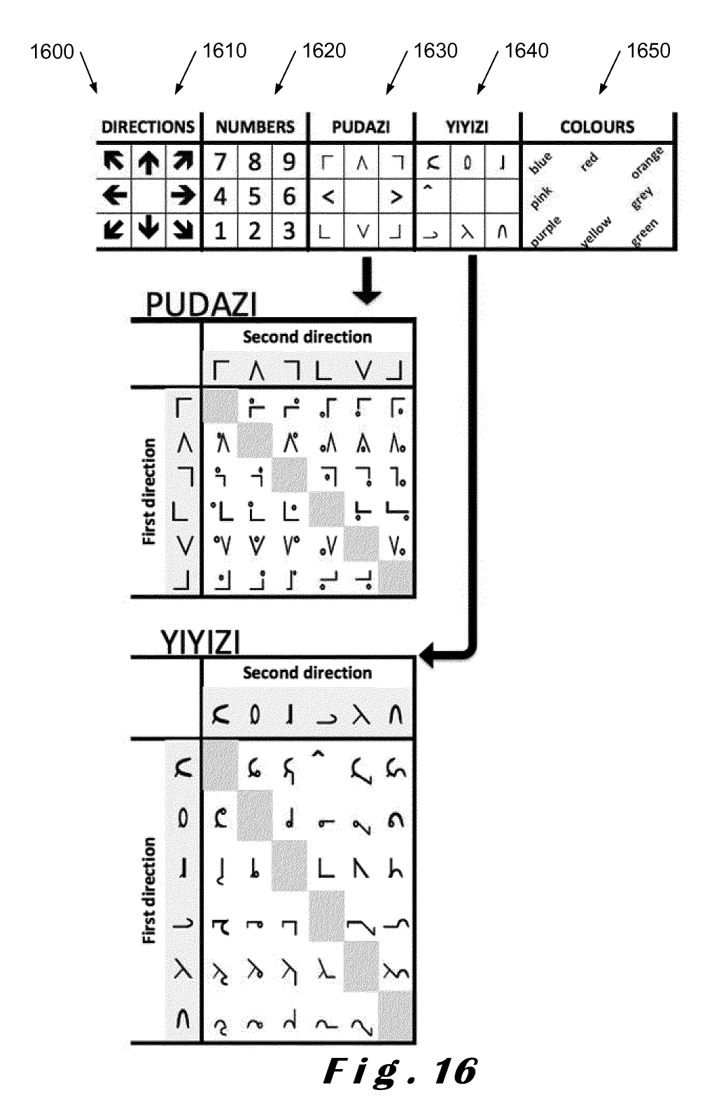

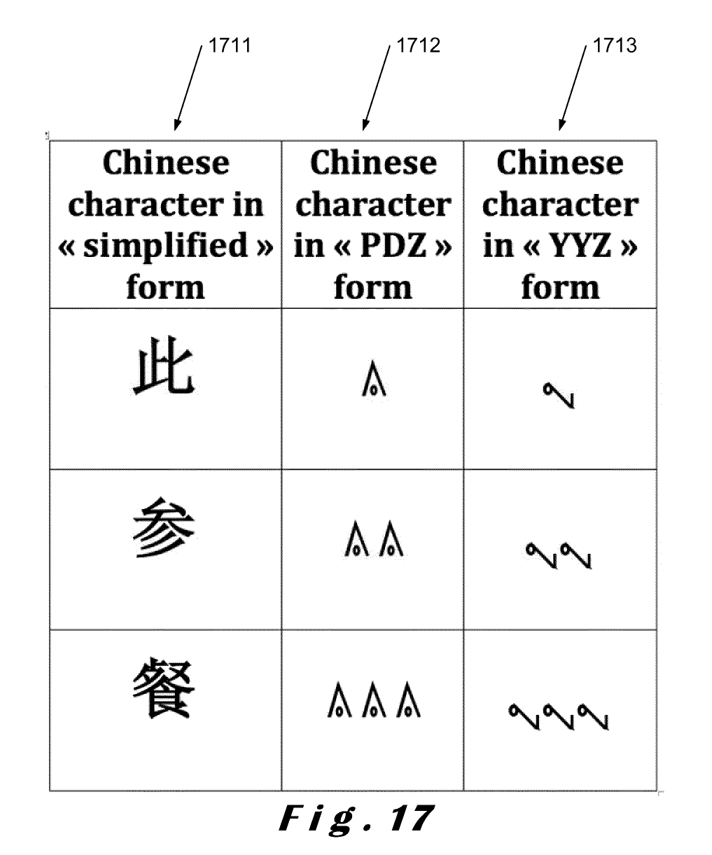

g. Symbolic representation as a guide for encoding—Since each of such symbolic representations is not only identical to the input path on a touch-sensitive device but also expresses, clearly and without ambiguity, the input sequence itself (and therefore the underlying unique code for each alphabetical phonetic transcription), a user can, by looking at a printout or at a “pen and paper” drawing of the symbolic representation of a given CC, use it as a guide for the successive encoding steps of such a CC in a computerised system with any input device, provided the computerised system and the input device are configured on the basis of the PUDASU input method. Each step of the input sequence for a given CC (or, in the case of a heteronymous CC, for a given alphabetical phonetic transcription of such a CC), taken in isolation, can also be represented by a distinct glyph (for example, a graphic or other representation of a direction in the reference geometrical structure) or a combination of two such distinct glyphs. Examples of such glyphs and the notation system that they together constitute are described below with reference to FIGS. 13, 15 and 16. When in a text made of CCs made available in printed form or displayed on a screen in a computerised system (as shown in FIG. 15) each of such CCs (in their simplified form—jianti zi or in their traditional form—fanti zi) is accompanied, as shown in FIG. 15, by the glyphs relevant for the symbolic representation of such CC (displayed below, above, next to or around such CC as a sequence mirroring the input sequence as described below with reference to FIG. 14), a reader of the text is simultaneously presented with a guide for the successive encoding steps for each CC of the whole text (and when a CC is heteronymous, with the successive encoding steps for the specific meaning associated with such CC). Glyphs representing the third input step (“Chinese Radical step”) and the fourth input step (“Ming Tang step”) can also be displayed, as described with reference to FIGS. 14 and 15 below, as the Pinyin alphabetical phonetic transcription of a given CC.

When in a text in Pinyin, each of the alphabetical phonetic transcriptions is accompanied by glyphs (displayed as a sequence mirroring the input sequence) representing the third and fourth input steps relevant for such CC, a reader of the text is presented with a guide for the successive encoding steps of the CC associated with each alphabetical phonetic transcription. Since the text in Pinyin and the accompanying glyphs together provide an unambiguous transliteration of the corresponding text in CCs, this allows a reliable form of Chinese digraphia using the Latin alphabet;

Examples of glyphs which can be positioned below alphabetical phonetic transcriptions and both above and below CCs are shown in FIG. 13. FIG. 13 illustrates a table 1300 of directions of movement and their associated glyphs. In columns 1310a and 1310b, each of numbers 8, 2, 9, 3, 7, 1, 4 and 6 expresses one direction on a numeric keypad as described above with reference to FIG. 12, and, each such direction can also be expressed by a distinct glyph as shown in columns 1320a and 1320b with the direction being indicated by the corner of the glyph starting from the centre of the glyph, that is, in the directions of keys “1” to “9” as described above with reference to FIG. 12. Each of numbers 89, 83, 82, 81, 87, 28, 29, 23, 21, 27, 98, 93, 92, 91, 97, 38, 39, 32, 31, 37, 78, 79, 73, 71, 18, 19, 13, 12, 17, 14 and 16 in columns 1310a, 1310b expresses two successive directions on a numeric keypad as described above with reference to FIG. 12, and, each the two successive directions can also be expressed by a distinct combination of two glyphs as shown in columns 1320a and 1320b: the first direction is indicated by the corner of the first glyph starting from the centre of the first glyph, that is, in the directions of keys “1” to “9” as described above with reference to FIG. 12; and the second direction is indicated by the second glyph, that is, the dot starting from the corner of the first glyph, that is, in the directions of keys “1” to “9” (excluding “4” and “6”) as described above with reference to FIG. 12. For directions “4” and “6”, the second glyph is not a dot but an arrow indicating the direction as described above with reference to FIG. 12. Number 5 in column 1310b expresses a validation function on a numeric keypad as described above with reference to FIG. 12 and can also be expressed by the distinct glyph shown in column 1320b.

As used herein, the term “glyph” is intended to include both the individual glyphs as described above and a combination of two (or possibly more) glyphs for the input path. As shown in FIG. 13, the illustrated glyphs may be single glyphs for directions comprising a single number and a combination glyph (first and second glyph) for directions comprising two numbers.

In FIG. 14, a table 1400 is shown which illustrates the four input steps 1410, 1420, 1430, 1440 together with the positioning of each glyph or combination of glyphs with respect to the alphabetical phonetic transcription in Pinyin and the CC. Glyphs “G1”, “G2”, “G3” and “G4” refer to glyphs associated with each of the four input steps, that is, “G1” refers to the first input step, “G2” refers to the second input step, “G3” refers to the third input step and “G4” refers to the fourth input step. Glyphs “G1” and “G2” together provide the alphabetical phonetic transcription in Pinyin with the glyphs “G3” and “G4” being positioned below the alphabetical phonetic transcription in Pinyin as shown at 1450. For a CC, the glyphs are positioned at the four corners as shown at 1460. The glyphs can also be displayed independently from the alphabetical phonetic transcription or the CC to which they relate as shown at 1470.

In FIG. 15, a table 1500 is shown which illustrates, in column 1510, examples of alphabetical phonetic transcriptions (in this case, Pinyin); column 1520 illustrates the encoding tags associated with the CCs corresponding to the alphabetical phonetic transcriptions; and column 1530 illustrates the information provided by each glyph with the corresponding numbers for input using a numeric keypad for each of the input steps associated with the unique input path for the PUDASHU input method and the associated unique input code, all as described above with reference to FIG. 12. In column 1530, as described above with reference to FIG. 12, the “0” do not need to be input by the user for encoding and are automatically completed by the computerised system. In column 1540, the Pinyin alphabetical phonetic transcription is shown with the associated glyphs where required. In column 1550, the CC is shown which corresponds to the Pinyin together with the associated glyphs. In column 1560, trajectories of an object on a touch-sensitive surface of an input device is shown which is similar to that shown in FIG. 12.

As shown in FIG. 15, for the CC [symbol] (ge), which is a CC having “PRIC” as its encoding tag and which is also an Alphabetical CC and therefore does not require any of a Final Phonetic Step, a Chinese Radical step and a Ming Tang step to be encoded, there is no glyph associated with the alphabetical phonetic transcription in Pinyin in column 1540 since such transcription contains all the information needed for performing the Initial Phonetic step for encoding the CC associated with it. In this case, the ‘93’ for the initial component of the alphabetical phonetic transcription is validated by the selection of ‘5’ with all other numbers not being required and which are automatically completed by the computerised system after inputting ‘5’. As shown for the initial component of the alphabetical phonetic transcription, there is a glyph associated with the numeric input, this glyph being the same at that shown for the CC in column 1550.

For the CC [symbol] (neng), which has “PRUC” as its encoding tag and therefore does not require a Chinese Radical step and a Ming Tang step to be encoded, there is no glyph associated with the alphabetical phonetic transcription in Pinyin in column 1540 since such transcription contains all the information needed for performing the Initial Phonetic step for encoding the CC associated with it. There are two glyphs associated with the CC in column 1540 indicative of respective ones of the initial and final components of the alphabetical phonetic transcription. In this case, the input of ‘31’ followed by ‘29’ provides the input path for a numeric keypad as the computerised system will automatically complete the path for the ‘0’ as shown. As shown, a first glyph is associated with the initial component and a second glyph is associated with the final component.

For the CC [symbol] (cai), which has “SUCu” as its encoding tag and therefore does not require a Ming Tang step, its alphabetical phonetic transcription in Pinyin in column 1540 contains all the information needed to perform the Initial Phonetic step and the Final Phonetic step and the glyph positioned below the alphabetical phonetic transcription provides the information needed to perform the Chinese Radical step. The two glyphs positioned above the CC in column 1550 provide the information for performing the Initial Phonetic step and the Final Phonetic step and the single glyph positioned below the CC provides the information needed to perform the Chinese Radical step. In this case, the input of ‘82’ followed by ‘83’ provide the initial and final components and ‘87’ provides the Chinese radical. The same glyphs are used with the input numbers as shown on the CC.

For the CC [symbol] (ban), which has “SICO” as its encoding tag and therefore requires all four input steps, its alphabetical phonetic transcription in Pinyin in column 1540 contains all the information needed to perform the Initial Phonetic step and the Final Phonetic step and the two glyphs positioned below the alphabetical phonetic transcription provide the information needed to perform the Chinese Radical step and the Ming Tang step. The two glyphs positioned above the CC in column 1550 provide the information for performing the Initial Phonetic step and the Final Phonetic step and the two glyphs positioned below the CC provide the information needed to perform the Chinese Radical step and the Ming Tang step. In this case, the input of ‘83’ followed by ‘82’ provide the initial and final components, ‘89’ provides the Chinese radical and ‘20’ provides CC location in the Ming Tang. The same glyphs are used with the input numbers as shown on the CC.

For the CC [symbol] (mo), which has “DUCAMa” as its encoding tag and therefore requires all four input steps, its alphabetical phonetic transcription in Pinyin in column 1540 contains all the information needed to perform the Initial Phonetic step and the Final Phonetic step and the two glyphs positioned below the alphabetical phonetic transcription provide the information needed to perform the Chinese Radical step and the Ming Tang step. The two glyphs positioned above the CC in column 1550 provide the information for performing the Initial Phonetic step and the Final Phonetic step and the two glyphs positioned below the CC provide the information needed to perform the Chinese Radical step and the Ming Tang step. In this case, the input of ‘32’ followed by ‘37’ provide the initial and final components, ‘21’ provides the Chinese radical and ‘5’ provides the Ming Tang where the ‘0’ is automatically encoded by the computerised system after the selection of a CC in location 5 as described above. The same glyphs are used with the input numbers as shown on the CC.

For the CC [symbol] (ling), which has “BUCABa” as its encoding tag and therefore requires all four input steps, its alphabetical phonetic transcription in Pinyin in column 1540 contains all the information needed to perform the Initial Phonetic step and the Final Phonetic step and the two glyphs positioned below the alphabetical phonetic transcription provide the information needed to perform the Chinese Radical step and the Ming Tang step. The two glyphs positioned above the CC in column 1550 provide the information for performing the Initial Phonetic step and the Final Phonetic step and the two glyphs positioned below the CC provide the information needed to perform the Chinese Radical step and the Ming Tang step. In this case, the input of ‘39’ followed by ‘93’ provide the initial and final components, ‘19’ provides the Chinese radical and ‘4’ provides the selection of the CC in location 4 of the Ming Tang, and the ‘0’ is automatically encoded by the computerised system after the selection of a CC in location 4 of the Ming Tang as described above. The same glyphs are used with the input numbers as shown on the CC.

For the CC [symbol] (xiao), which has “HUCa-6g” as its encoding tag and therefore requires all four input steps, its alphabetical phonetic transcription in Pinyin in column 1540 contains all the information needed to perform the Initial Phonetic step and the Final Phonetic step and the two glyphs positioned below the alphabetical phonetic transcription provide the information needed to perform the Chinese Radical step and the Ming Tang step. The two glyphs positioned above the CC in column 1550 provide the information for performing the Initial Phonetic step and the Final Phonetic step and the two glyphs positioned below the CC provide the information needed to perform the Chinese Radical step and the Ming Tang step. In this case, the input of ‘12’ followed by ‘31’ provide the initial and final components, ‘32’ provides the Chinese radical and ‘6’ provides the selection of the CC in location 6 of the Ming Tang, and the ‘0’ is automatically encoded by the computerised system after the selection of a CC in location 6 of the Ming Tang as described above. The same glyphs are used with the input numbers as shown on the CC.

For the CC [symbol] (yi), which has “HUCa-18y” as its encoding tag and therefore requires all four input steps, its alphabetical phonetic transcription in Pinyin in column 1540 contains all the information needed to perform the Initial Phonetic step and the Final Phonetic step and the two glyphs positioned below the alphabetical phonetic transcription provide the information needed to perform the Chinese Radical step and the Ming Tang step. The two glyphs positioned above the CC in column 1550 provide the information for performing the Initial Phonetic step and the Final Phonetic step and the two glyphs positioned below the CC provide the information needed to perform the Chinese Radical step and the Ming Tang step. In this case, the input of ‘91’ followed by ‘71’ provide the initial and final components, ‘32’ provides the Chinese radical and ‘18’ provides the selection of the CC in location 18 of the Second Floor of the Ming Tang. The same glyphs are used with the input numbers as shown on the CC.

h. New Chinese writing—Glyphs expressing the new symbolic representation system can also be used in sequential order on their own (that is, without the CCs or the Pinyin transcriptions with which they are associated) for providing a unique sequence of input steps that, when performed, results in the encoding and the display of the CC to which such unique sequence corresponds. Glyphs expressing the new symbolic representation system can also be used in sequential order on their own for printing Chinese or for writing Chinese with “pen and paper”, as an alternative to printing or writing the CCs themselves or their Pinyin transcription, with the additional significant benefit that each distinct sequence of such glyphs is a true copy of the input sequence for encoding the corresponding CC in a computerised system in accordance with the present invention. People familiar with the writing of CCs can use the new symbolic representation system as an additional way of writing the Chinese spoken language. In addition, people unfamiliar with the Chinese writing and also not willing to learn how to write CCs can decide to learn such symbolic representations instead and use them as a way to write the Chinese spoken language.

One means of expressing the new symbolic representation system with glyphs is to use the glyphs shown in FIG. 16 which forms a new notation system called PUDAZI (or “PDZ”—in Chinese, “ [symbol] ”, the abbreviated form of “ [symbol] [symbol] ” or PUshi DAZI de shuru xiefa, meaning “way of writing the encoding (allowing) the whole world to reach (Chinese) characters”). Each single glyph (or glyph component as described above) corresponds to a direction of the movement of a finger on a touch-sensitive surface for performing one of the four input steps for a given CC and such direction also corresponds to a number on a numeric keypad as shown in FIG. 12. Six glyphs are assigned to directions corresponding to numbers 8, 9, 3, 2, 1 and 7 on the numeric keypad, which are used in the first, second and thirds input steps, with glyph “8” being assigned to direction number 8; glyph “9” being assigned to direction number 9; glyph “3” being assigned to direction number 3; glyph “2” being assigned to direction number 2; glyph “1” being assigned to direction number 1; and glyph “7” being assigned to direction number 7. Two glyphs are assigned to directions numbers 4 and 6, which are used in the fourth input step for some CCs having an encoding tag beginning with “B” or “H”, with glyph “4” being assigned to direction number 4 and glyph “6” being assigned to direction number 6.

When using PDZ, it is possible to add tonal information in the form of additional glyphs similarly to what is currently implemented in Pinyin.

When a given input step requires a movement of the finger on a touch-sensitive surface in two successive directions, such a movement is represented by a combination of two glyphs, where the second glyph is replaced by a dot positioned as follows: the first direction is indicated by the corner of the first glyph starting from the centre of the first glyph, that is, in the directions of keys “1” to “9” as described above with reference to FIG. 12 and the second direction is indicated by the second glyph, that is, the dot starting from the corner of the first glyph, that is, in the directions of keys “1” to “9” (excluding “4” and “6”) as described above with reference to FIG. 12. For directions “4” and “6”, the second glyph is not a dot but an arrow indicating the direction as described above with reference to FIG. 12.

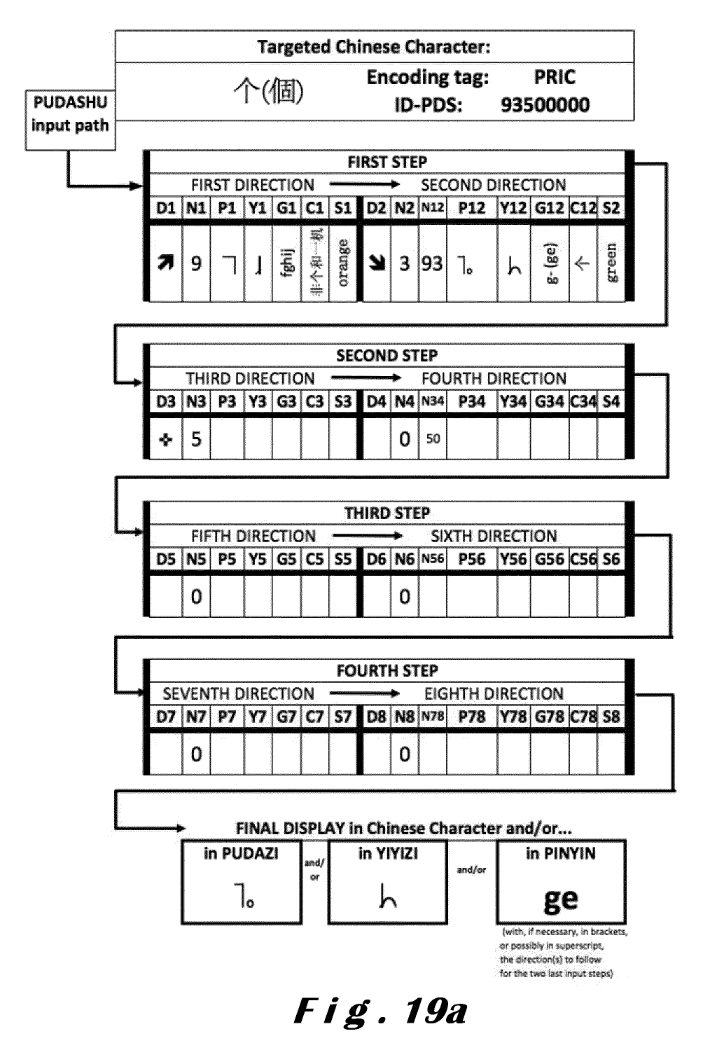

Another way of expressing the new symbolic representation system with glyphs is to use another notation system, also shown in FIGS. 16, 18a and 18b, where each single glyph also corresponds to a direction of the movement of a finger on a touch-sensitive surface for performing one of the four input steps for a given CC and where such direction also corresponds to a number on a numeric keypad as shown in FIG. 12. Such a notation system, which can also be used as a cursive handwriting notation system, is called YIYIZI (or “YYZ”—in Chinese “ [symbol] ” or YiYiZi, meaning “meaningful characters”). It is inspired by, but is not identical to, the “SOLRESOL” notation system for the artificial language invented by François Sudre (1787-1862) and assigns the following glyphs to the following direction numbers.

As shown in FIGS. 18a and 18b, six glyphs and six sounds are assigned to directions numbers 8, 9, 3, 2, 1 and 7, which are used in the first, second and thirds input steps, with:

the glyph shown in column 1890 on the same row as direction number 8 (shown in column 1830) being assigned to such direction number 8;

the glyph shown in column 1890 on the same row as direction number 9 (shown in column 1830) being assigned to such direction number 9;

the glyph shown in column 1890 on the same row as direction number 3 (shown in column 1830) being assigned to such direction number 3;

the glyph (written “A” when handwritten) shown in column 1890 on the same row as direction number 2 (shown in column 1830) being assigned to such direction number 2;

the glyph shown in column 2890 on the same row as direction number 1 (shown in column 2830) being assigned to such direction number 1; and

the glyph shown in column 2890 on the same row as direction number 7 (shown in column 2830) being assigned to direction number 7.

Two additional glyphs are assigned to directions numbers 4 and 6 as before, which are used in the fourth input step for some CCs having an encoding tag beginning with “B” or “H”, with the glyph shown in column 2890 on the same row as direction number 4 (shown in column 2830) being assigned to such direction number 4 and the glyph shown in column 2890 on the same row as direction number 6 (shown in column 2830) being assigned to such direction number 6.

Two more glyphs are assigned to directions numbers 14 and 16 as before, which are used in the fourth input step for some CCs positioned in the Second Floor at locations 14 and 16 respectively, with the glyph shown in column 2890 on the same row as direction number 14 (shown in column 2830) being assigned to such direction number 14 and the glyph shown in column 2890 on the same row as direction number 16 (shown in column 2830) being assigned to such direction number 16.

Two further glyphs are assigned to directions 75 and 71 as before, which are used in the second input step for the Alphabetical CC-7s and the Alphabetical CC-71s respectively, with the glyph shown in column 2890 on the same row as direction number 75 (shown in column 2830) being assigned to such direction number 75 and the glyph shown in column 2890 on the same row as direction number 71 (shown in column 2830) being assigned to such direction number 71.

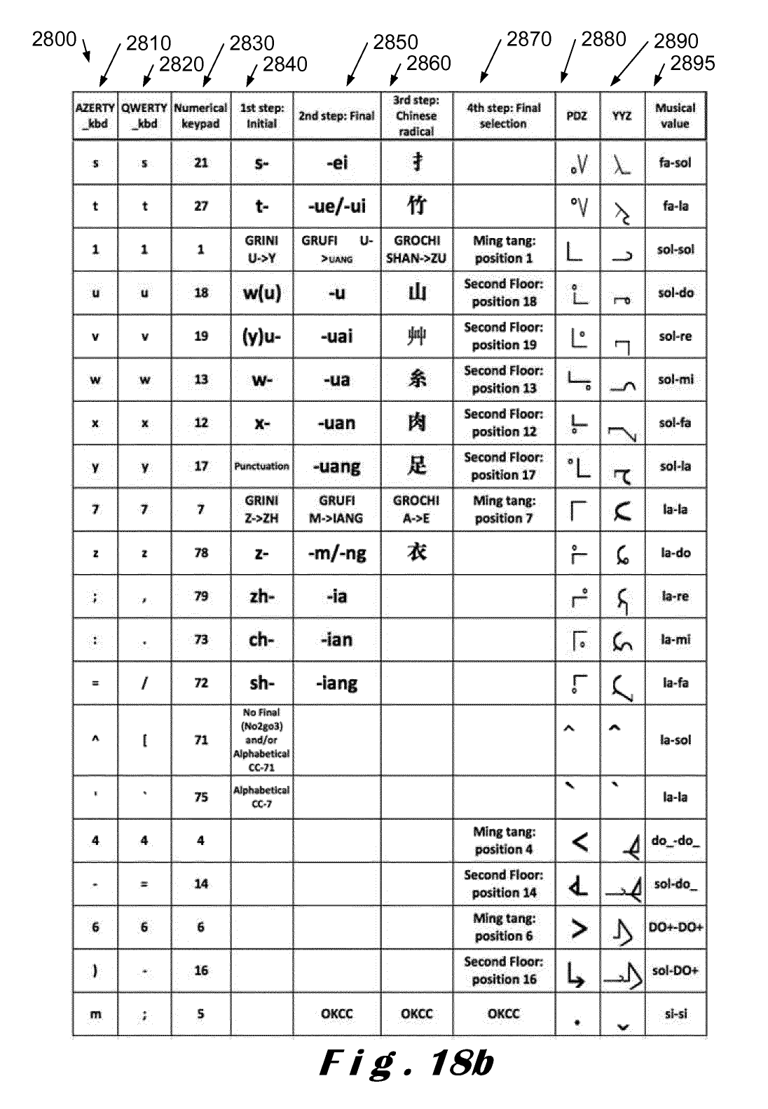

Glyph “inverted circumflex accent” as shown in FIG. 18b in the last row (beginning with “5” in column 2810) of column 2890, when inserted between the symbolic representations of two or more CCs, is assigned a function indicating that two or more such CCs together form a word. For example, as shown in column 1713 in FIG. 17, the combination of the glyph associated with direction number 8 and of the glyph associated with direction number 2 (resulting in the combined glyph shown in column 1890 of FIG. 18a in the row corresponding to direction number 82 in column 1830) means “ci” when used on its own with the Alphabetical CC [symbol] (ci). The same combination, when used twice in a sequence, means “can”, which is the alphabetical phonetic transcription of the CC [symbol] (can) with “PRIC” as its encoding tag and where the first instance means “c-”, used as a reference to the initial component at the first input step, and the second instance means “-an”, used as a reference to the final component at the second input step. The same combination, when used three times in a sequence, refers to the CC [symbol] (can), with the two first instances of the combination meaning “can” as explained above and the third instance of the combination referring to the head of partition of Chinese radicals “ [symbol] ” (kou), partition which includes the Chinese radical “ [symbol] ” (shi), which is the Chinese radical of the CC [symbol] (can).

When using YYZ, it is possible to add tonal information in the form of additional glyphs similarly to what is currently implemented in Pinyin.

FIG. 16 also shows a table 1600 which illustrates correlations between the directions 1610, the numbers 1620 of a numeric keypad, the PDZ notation system 1630, the YYZ notation system 1640, and colours 1650 which can be used as a visual display for the directions. In relation to the colours, “blue” is assigned to the direction indicated by number “7”, “red” to the direction indicated by number “8”, “orange” to the direction indicated by number “9”, “purple” to the direction indicated by number “1”, “yellow” to the directing indicated by number “2”, “green” to the direction indicated by number “3”, “pink” to the direction indicated by number “4” and “grey” to the direction indicated by number “6”. Naturally, the colours can be assigned to the directions/numbers in any other order, and, other colours than those described above may be used. In addition, although not illustrated in FIG. 16, musical notes or sounds may be assigned to the directions/numbers.

i. Sounds and colours—As described above, sounds and colours can also be associated with each of the directions of the movement of the finger on a touch-sensitive surface when performing one of the four input steps and can be used as further guides for the encoding process. For example, as shown in FIG. 18, music note “la” can be associated with direction number 7, music note “do” (normal musical scale) can be associated with direction number 8, music note “re” can be associated with direction number 9, music note “DO₊” (high musical scale) can be associated with direction number 4, music note “do₋” (low musical scale) can be associated with direction number 6, music note “sol” can be associated with direction number 1, music note “fa” can be associated with direction number 2 and music note “mi” can be associated with direction number 3.

In FIGS. 18a and 18b, tables 1800 and 2800 are shown which illustrate the relationship between entries on an AZERTY keyboard (columns 1810 and 2810), a QWERTY keyboard (column 1820), a numeric keypad (columns 1830 and 2830), the PDZ representation or writing (columns 1880 and 2880) and the YYZ representation or writing (columns 1890 and 2890), as described above, together with the Initial Phonetic step (in columns 1840 and 2840), the Final Phonetic step (in columns 1850 and 2850), the Chinese radical step (in columns 1860 and 2860), the final selection in the Ming Tang or the Second Floor (columns 1870 and 2870) and the musical value (columns 1895 and 2895) for the 26 letters of the Latin alphabet, the initial components “zh-”, “ch-” and “sh-” digits “0” to “9” and other symbols.

It will readily be appreciated that as locations in the Ming Tang are not assigned to letters of the Latin alphabet in the same way as the initial components, final components and Chinese radicals but are assigned to numbers and as locations in the Second Floor are assigned only to letters “u”, “v”, “w”, “x”, “y”, columns 1885 and 2885 are effectively partially unpopulated.

i. Meaningful input units—For writing CCs with “pen and paper” in their simplified form (jianti zi) and in their traditional form (fanti zi), one or more strokes, taken from a set of standard strokes of various shapes and orientations, are used as “input units” and combined. Whereas each written CC carries a meaning, each of the strokes constituting a CC carries no meaning by itself, except when one single stroke is needed to write a given CC but, in this case, it is the CC that carries a meaning and not the single stroke itself. In contrast, the PUDASHU input method, which provides for each CC a unique sequence of input steps, provides a means of encoding CCs in a computerised system, that is, of writing them with a computerised system, where each input unit carries a meaning which is to give the user, by way of feedback, specific and distinct information on each portion of the input path.

As shown on FIGS. 19a to 19i, in accordance with the encoding tag assigned to the CCs, this information can be, for example:

the direction of a movement on a touch-sensitive surface (indicated by columns D1 to D8);

a figure expressing such direction (as indicated by columns N1 to N8);

a number expressing the combination of two successive directions (as indicated by columns N12, N34, N56 and N78);

the PUDAZI symbol expressing such direction (as indicated by columns P1, P3, P5 and P7) or combination of two directions (as indicated by columns P12, P34, P56 and P78);

the YIYIZI symbol expressing such direction (as indicated by columns Y1, Y3, Y5 and Y7) or combination of two directions (as indicated by columns Y12, Y34, Y56 and Y78);

the GRINI (as indicated by columns G1 in Pinyin and by column C1 in CCs);

the initial component (as indicated by column G12 in Pinyin and by column C12 in CCs);

the GRUFI (as indicated by column G3 in Pinyin and by column C3 in CCs);

the complete alphabetical phonetic transcription (as indicated by column G34 in Pinyin and by column C34 in CCs, except for the Alphabetical CC [symbol] ( [symbol] ) (ge) for which the complete alphabetical phonetic transcription is indicated by column G12 in Pinyin and by column C12 in CC);

the GROCHI (as indicated by column G5 in Pinyin and by column C5 in CCs);

the Chinese radical expressed by the PUDAZI glyphs positioned next to the alphabetical phonetic transcription of the Emperor CC in the centre of the Ming Tang (as indicated by column G56 in Pinyin and by column C56 in CCs);

the targeted CC, unless it is positioned in the Second Floor and in such case the CC positioned in the Ming Tang in location 1, as indicated: by column G7 in Pinyin followed by the alphanumeric expression of the direction of the movements to be performed for the third step (a letter representing two successive directions) and of the movement to be performed for the first part of the fourth step (a number representing a single direction); and by column C7 in CCs;

the complete alphabetical phonetic transcription accompanied by the PUDAZI glyphs corresponding to the fourth input step when the targeted CC is positioned in the Second Floor, as indicated by column G78 in Pinyin followed by the alphanumeric expression of the direction of the movements to be performed for the third step (a letter representing two successive directions) and of the movement to be performed for the fourth step (another letter representing two successive directions); and by column C78 in CCs; and/or the colour associated with a given direction (as indicated by columns S1 to S8).

In particular, FIG. 19a illustrates a “PRIC” which is also an Alphabetical CC, FIG. 19b illustrates a “PRUC”, FIG. 19c illustrates a “SUCa”, FIG. 19d illustrates a “PRIC” which is not an Alphabetical CC, FIG. 19e illustrates a “SICO”, FIG. 19f illustrates a “SUCu”, FIG. 19g illustrates a “DUCAMa”, FIG. 19h illustrates a “HUCa-1”, and FIG. 19i illustrates a “HUC a-18y”.

Likewise, in the new Chinese writing described above where glyphs, taken from a coherent and finite set of standard glyphs governed by the logic inherent to the geometrical structure from which they originate, are used as “input units” on their own (that is, without the CCs or the Pinyin transcription with which they are associated), not only does the succession of glyphs expressing the unique sequence of input steps of a given CC carry the meaning of such CC (even though the CC itself is not written) but each of such glyphs, or each combination of two such glyphs as the case may be, used as “input units” does itself carry a meaning which is to give the user specific and distinct information on each portion of the input path for encoding such CC.

j. Machine transliteration—A text made of CCs which are each accompanied, or are not accompanied, by the relevant PUDAZI or YIYIZI glyphs can be transliterated by a computer program into a text in Pinyin, (and the computer program can also add to the Pinyin transliteration the relevant PUDAZI or YIYIZI glyphs representing the third and fourth input steps) or into a sequence of PUDAZI or YIYIZI glyphs on their own (that is, without the CCs or the Pinyin transcription with which they are associated). In addition, a text in Pinyin where each of the alphabetical phonetic transcriptions is accompanied by the PUDAZI or YIYIZI glyphs representing the third and fourth input steps can be transliterated by a computer program into a text made of CCs, (and the computer program can also add to each of the CCs in the text the relevant PUDAZI or YIYIZI glyphs) or into a sequence of PUDAZI or YIYIZI glyphs on their own (that is, without the CCs or the Pinyin transcription with which they are associated).

In addition, a sequence of PUDAZI or YIYIZI glyphs on their own (that is, without the CCs or the Pinyin transcription with which they are associated), can be transliterated by a computer program, for example by means of a handwriting recognition system, into a text in Pinyin, (and the computer program can also add to the Pinyin transliteration the relevant PUDAZI or YIYIZI glyphs representing the third and fourth input steps) or into a text made of CCs, (and the computer program can also add to each of the CCs in the text the relevant PUDAZI or YIYIZI glyphs).

The same transliteration capabilities can be said of any symbolic representation system similar to PUDAZI and YIYIZI.

k. Application to alphabet systems and numbers—The PUDASHU input method can also be used for encoding letters of the Latin alphabet (or of non-Latin alphabets) and numbers (from 0 to 9) into a computer for storing them in a computerised format for further processing. This can be done by regrouping the letters (and numbers) in series in accordance with a geometric structure identical to the structure used for encoding such CCs. For encoding a given letter, the user first selects a series of letters and then selects the targeted letter among the letters of the series. When such selection is performed on a touch-sensitive surface, each letter can thus be selected by means of two successive movements, each one in one direction (and the two successive movements can be combined in a single continuous movement following two successive directions). For each letter (and the same approach can be applied to numbers from 0 to 9), the directions are dictated by the geometric structure, and, as a result each letter is assigned a unique input path (and a corresponding unique code). The unique input path, when drawn on a touch-sensitive surface on the basis of the reference geometric structure, provides a new distinct symbolic representation for each letter (and each number from 0 to 9), and, consequently a new and coherent symbolic representation system for a whole alphabet (and for all numbers from 0 to 9). This provides a situation where an alphanumeric keyboard (such as a QWERTY keyboard) can be dispensed with as a particularly useful encoding method of letters of an alphabet and of numbers on small touch-sensitive surfaces (such as, the surface of a smart watch), which is a breakthrough innovation. Such new symbolic representation system can also be used for writing with “pen and paper” letters of the alphabet and numbers as an alternative to writing the letters or numbers themselves (that is, allowing a form of digraphia), with the additional benefit that each of such symbolic representations is a true copy of the input sequence for encoding the same letter or number in a computerised system using a touch-sensitive surface.

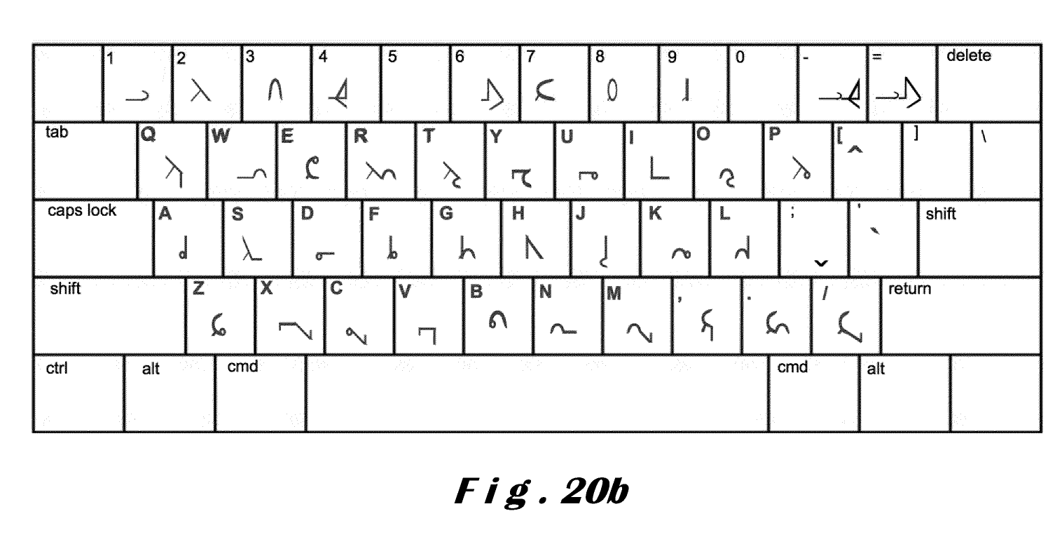

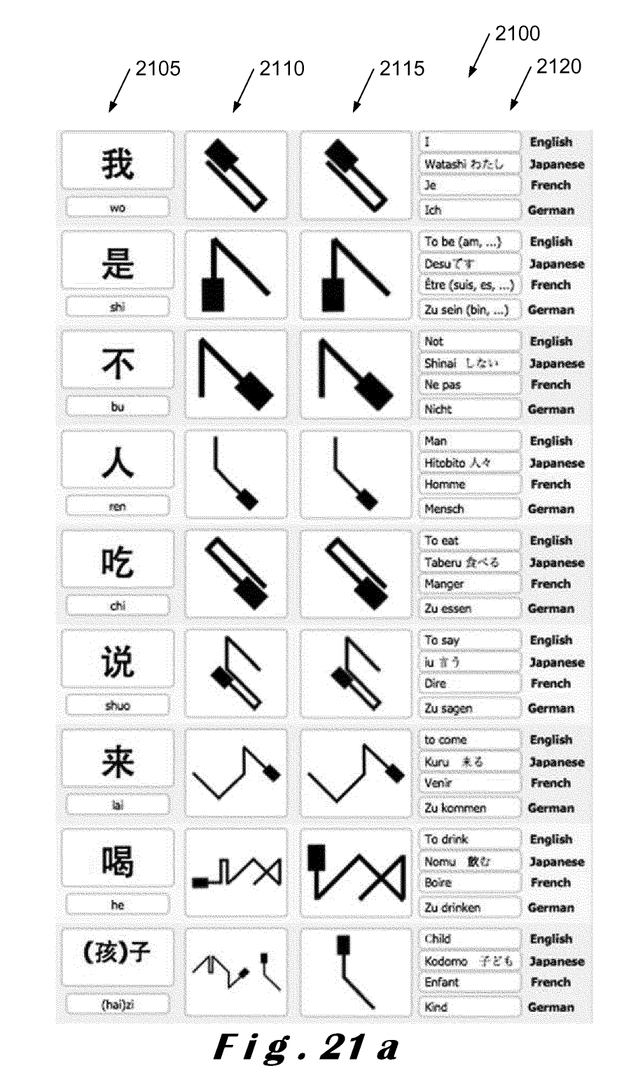

FIGS. 20a and 20b respectively illustrate the application of PUDAZI and YIYIZI to a QWERTY keyboard where the alphabetical characters as well as the numbers and other symbols are utilised. It will readily be appreciated that other layouts are also possible.

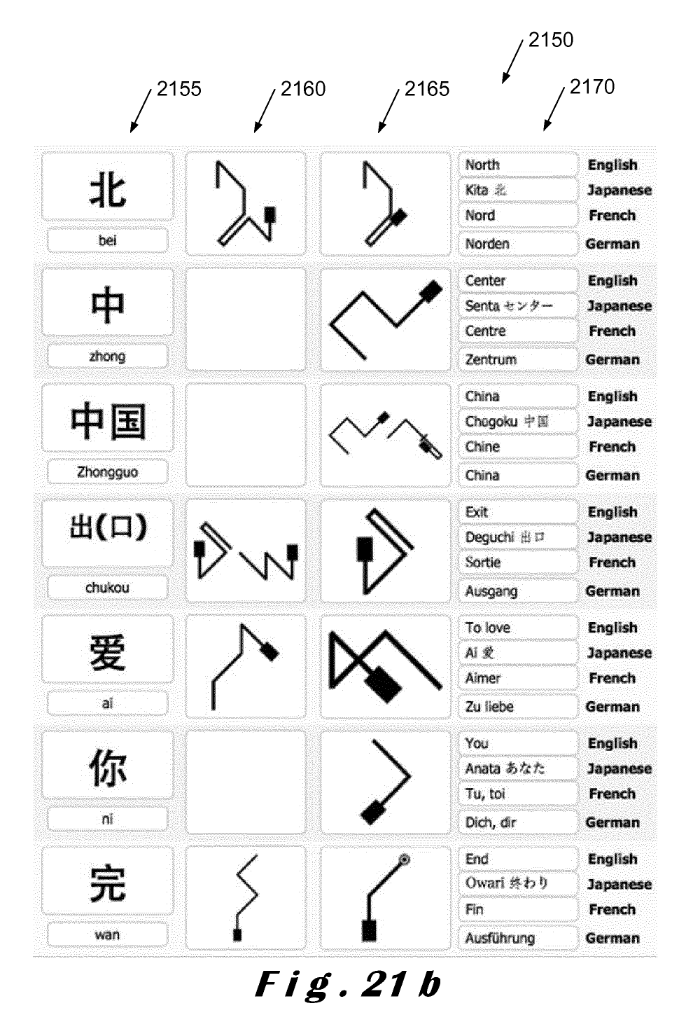

l. Meaning-based e-writing—Since each CC or, for a heteronymous CC, each of its alphabetical phonetic transcriptions, carries a distinct meaning, the symbolic representation of such a CC or alphabetical phonetic transcription carries exactly the same distinct meaning, which can be associated with such symbolic representation without the need, for the purposes of such association, to refer again to the CC with which it is associated. As explained above, this form of Chinese digraphia using new symbolic representations for the CCs may be useful to people already familiar with writing CCs and possibly to people unfamiliar with CCs but using such symbolic representation system for writing spoken Chinese. As a further development, each of such symbolic representation, detached from the CC with which it is associated but remaining associated with the meaning of such a CC, can, together with all other such symbolic representations, form a symbolic representation system of all such meanings and such a system can evolve towards a universal written communication system based upon meanings only. Users of different languages could start communicating in writing through such symbolic representation system of meanings, with the additional significant benefit that each such symbolic representation provides to each of such users the input sequence for encoding the corresponding CC in a computerised system, as shown in FIGS. 21a and 21b.

FIGS. 21a and 21b are tables 2100, 2150 which illustrate examples of further CCs with their respective alphabetical phonetic transcriptions into Pinyin (columns 2105 and 2155 respectively), their associated input paths for use with a touch-sensitive surface and the current PDS-db comprising 8,536 CCs and 9,558 alphabetical phonetic transcriptions (columns 2110 and 2160 respectively), their associated input paths for use with a touch-sensitive surface and the Reduced PDS-db described below (columns 2125 and 2165 respectively), and the translation of the respective CCs into four different languages (English, Japanese, French and German) (columns 2120 and 2170 respectively). In each case in columns 2110, 2160, 2125 and 2165 the black rectangle indicates the end of the input path.

As shown in FIG. 21a, the CC [symbol] (wo) corresponds to “I” in English, “watashi” in Japanese, “je” in French and “ich” in German. Similarly, the CC [symbol] (shi) corresponds to the verb “to be” in English, “desu” in Japanese, “etre” in French and “zu sein” in German, etc. as shown.

Although FIGS. 13, 14, 21a and 21b have been described with reference to Pinyin, other alphabetical phonetic transcriptions are also possible.

In addition, although four languages are described and illustrated with respect to FIGS. 21a and 21b, it will readily be appreciated that the translation can be extended to other languages.

m. New keyboards—As can be seen in FIGS. 20 and 20b, 30 distinct combinations of two single glyphs where each such combination represents the two successive directions associated with a given input step and 10 distinct single glyphs where each such glyph represents the direction associated with a given input step and glyph “inverted circumflex accent”, as shown in FIG. 18b in the last row (beginning with “5” in column 2810) of column 2890, sufficient to represent what is to be performed for the first input step (initial component), the second input step (final component), the third input step (Chinese radical) and the fourth input step (Ming Tang) as well as the other functions and shortcuts. Alternatively, a user can also enter such 30 distinct combinations of two glyphs and 10 distinct single glyphs and glyph “inverted circumflex accent” as shown in FIG. 18b in the last row (beginning with “5” in column 2810) of column 2890 by pressing the corresponding letter or symbol key shown in FIG. 18 on a standard physical or virtual QWERTY or AZERTY keyboard previously mapped to the PUDASHU input method (as described above).

As shown in FIGS. 20a and 20b, each of the 30 distinct combinations of two glyphs and each of the 10 single distinct glyphs can also be displayed on the relevant key, next to the corresponding letter or symbol, on a standard physical or virtual QWERTY or AZERTY keyboard previously mapped to the PUDASHU input method. Specific physical or virtual keyboards can also be designed where only glyphs are displayed, without the display of letters of the Latin alphabet and other symbols. It will readily be appreciated that the glyphs can also be applied to other keyboards or keyboard layouts.

As an alternative to using a touch sensitive surface for the input, the present invention can be implemented using a gesture recognition system. In this case, a user interacts with a three-dimensional imaging system to move through the input path for a targeted CC. The three-dimensional imaging system detects movement within its frustum and provides signals indicative of movement for the computerised system.

Such a three-dimensional imaging system may comprise a depth sensing or time-of-flight (TOF) camera which detects movements within its frustum to provide information relating to the position of an object in an x-y plane as well as its position in a z-direction, that is, the distance from the depth sensing or TOF camera.

Available components and/or characters for selection may be displayed on a surface or GUI by the computerised system, the user interacting with the surface or GUI to select the appropriate components and/or characters.

The movements required for interaction may be the same as described above, that is, moving through at least one input step to select a targeted CC for encoding. The z-direction may be used for validation by the detection of specific movements in that direction and normal to the x-y plane, for example, a push or click.

It will readily be appreciated that the PUDASHU input method comprises a process which, when applied to a specific input device (such as, a touch-sensitive surface of tablet, smart phone or smart watch) or a specific input system (such as, a gesture-based recognition system), and using a computerised system as described above, provides a new coherent symbolic representation system which, in itself, constitutes a specific representation of the input path which can stand alone irrespective of the CC to be encoded in the computerised system, the symbol-based written language used for such encoding, the input device used for the encoding, and the software running on the computerised system used for the encoding. The “coherence” of the input path is graphically materialised in the new symbolic representation system.

The “materiality” of the input path produced by the PUDASHU input method applied by a suitable input device with the assistance of software running on a computerised system is confirmed by the portability and the divisibility of such a product, for example: as the continuous sequence of movements visualised by two strokes can be either divided into two successive strokes (as an alternative to the continuous movement described above) or replaced by one single movement going directly towards its target, the product produced by the PUDASHU input method could also become an object of manipulation of other computerised systems which would produce the same figure without having to follow directly such a continuous movement (for example, a keyboard could produce related input paths figures instead of letters etc.) or even stand alone independently of any computerised system as an alternative writing system (as described above). Such figures would even stand alone in the spoken language used to produce them: the input path figure for “wo” meaning “I” in Chinese could be used by another computerised system for “watashi” meaning also “I” but in Japanese as described above with reference to FIGS. 21a and 21b.

FIG. 22 illustrates a table 2200 of Alphabetical CCs in block 2210, Alphabetical-7 CCs in block 2240 and Alphabetical-71 CCs in block 2270. Each block 2210, 2240 and 2270 has six columns which provide: the Pinyin (columns 2212, 2242, 2272); the fanti zi (columns 2214, 2414, 2714); the jianti zi (columns 2216, 2416, 2716); the entries on the numeric keypad (columns 2218, 2248, 2278); the PDZ (columns 2220, 2250, 2280); and the YYZ (columns 2222, 2252, 2282). The PDZ and YYZ comprise two new symbolic representations and/or alternative writing systems derived from the input path for each targeted CC as described above.

Such new symbolic representation system, alternative writing system, stand alone figures and any other manipulation by computerised systems or otherwise of the input path produced by the PUDASHU input method are in all material respects each a “product” of the PUDASHU input method, without which they would never have come to existence. Moreover, such new symbolic representation system, alternative writing system, stand alone figures and other manipulations could not continue to exist without the PUDASHU input method, since it is such input method only and exclusively that generates them and therefore provides their rationale and the means of interpreting them. Without a reference to the PUDASHU input method, such new symbolic representation system, stand alone figures and other manipulations have no meaning by themselves, cannot be interpreted, cannot be taught and cannot be used as a communication tool or otherwise.

It will be appreciated that although the present invention has been described with respect to specific embodiments and arrangements of elements for performing the maximum of four input steps, where needed, the present invention can be implemented in different ways with different arrangements of elements for performing the four input steps.

1. A method of inputting a character in a symbol-based written language for encoding in a computerised system using at least phonetic information relating to the character to be input in no more than four input steps, the four input steps defining an input path and each input step resolving ambiguity associated with the encoding of the character, the method comprising performing at least one input step for selecting an alphabetical phonetic transcription related to the character from a plurality of alphabetical phonetic transcriptions in the symbol-based written language.

2. A method according to claim 1, wherein said at least one input step comprises displaying an array of possible components for selection in accordance with the input path of the character to be encoded.

3. A method according to claim 2, wherein the alphabetical phonetic transcription comprises at least an initial component for the character, and said at least one input step comprises selecting an initial component of an alphabetical phonetic transcription, the array comprising a plurality of first level elements arranged around a start position, each of the first level elements providing at least a group of initial alphabetical phonetic components.

4. A method according to claim 3, wherein the selection of a first level element corresponding to a group of initial components generates a nested sub-array.

5. A method according to claim 4, wherein each nested sub-array comprises a plurality of second level elements, each second level element including at least one initial component.

6. A method according to claim 5, wherein each array comprises six first level hexagons and each nested sub-array comprises six second level hexagons arranged around a central first level hexagon, each of the six second level hexagons corresponding to at least one initial component of the alphabetical phonetic transcription.

7. A method according to claim 6, further comprising displaying initial components in each second level hexagon in accordance with the selection of a group of initial components in the first level hexagon with which the second level hexagons are associated.

8. A method according to claim 7, further comprising validating the selected initial component.

9. A method according to claim 7, further comprising automatically validating the selected initial component.

10. A method according to any one of claims 3 to 9, wherein the initial component comprises a complete alphabetical phonetic transcription for the character which is unambiguous and is used for encoding the character.

11. A method according to claim 10, wherein the initial component is linked to a specific character which is used for encoding.

12. A method according to claim 1 or 2, wherein the alphabetical phonetic transcription comprises at least a final component for the character to be encoded and said at least one input step comprises selecting a final component of an alphabetical phonetic transcription, and the array comprises a plurality of third level elements arranged around a start position, each of the third level elements providing at least a group of final alphabetical phonetic components.

13. A method according to claim 12, wherein the selection of a third level element corresponding to a group of final components generates a nested sub-array.

14. A method according to claim 13, wherein each nested sub-array comprises a plurality of fourth level elements, each fourth level element including at least one final component of the alphabetical phonetic transcription.

15. A method according to claim 14, wherein each array comprises six third level hexagons and each nested sub-array comprises six fourth level hexagons arranged around a central third level hexagon, each of the six fourth level hexagons corresponding to at least one final component of the alphabetical phonetic transcription.

16. A method according to claim 15, further comprising displaying final components in each fourth level hexagon in accordance with the selection of a group of final components in the third level hexagon with which the fourth level hexagons are associated.

17. A method according to claim 16, further comprising validating the selected final component.

18. A method according to claim 16, further comprising automatically validating the selected final component.

19. A method according to any one of claims 12 to 18, wherein the final component comprises a complete alphabetical phonetic transcription for the character which is unambiguous and is used for encoding the character.

20. A method according to claim 19, wherein the final component is linked to a specific character which is used for encoding.

21. A method according to claim 1 or 2, further comprising bypassing a first input step using a shortcut to a second input step, the first input step and the second input step respectively corresponding to the selection of an initial component or a final component of the alphabetical phonetic transcription of the character to be encoded.

22. A method according to claim 21, wherein said at least one input step comprises selecting a final component of an alphabetical phonetic transcription, and the array comprises a plurality of third level elements arranged around a central element corresponding to an end point of the shortcut, each third level element corresponding to a group of final alphabetical phonetic components.

23. A method according to claim 22, wherein the selection of a third level element corresponding to a group of final components generates a nested sub-array.

24. A method according to claim 23, wherein each nested sub-array comprises a plurality of fourth level elements, each fourth level element including at least one final component.

25. A method according to claim 24, wherein each array comprises six third level hexagons and each nested sub-array comprises six fourth level hexagons arranged around a central third level hexagon, each of the six fourth level hexagons corresponding to at least one final component of the alphabetical phonetic transcription.

26. A method according to claim 25, further comprising displaying final components in each fourth level hexagon in accordance with the selection of a group of final components in the third level hexagon with which the fourth level hexagons are associated.

27. A method according to claims 3 to 8, further comprising a second input step for selecting a final component of the alphabetical phonetic transcription for the character in accordance with the selected initial component, the initial component and the final component together comprising a complete alphabetical phonetic transcription for the character.

28. A method according to claim 27, wherein the second input step further comprises displaying possible final components of the alphabetical phonetic transcription in accordance with the selected initial component of the alphabetic phonetic transcription.

29. A method according to claim 27 or 28, wherein the array comprises a plurality of third level elements arranged around a central element corresponding to the selected initial component of the alphabetical phonetic transcription, each third level element corresponding to a group of final alphabetical phonetic components.

30. A method according to claim 29, wherein the selection of a third level element corresponding to a group of final components generates a nested sub-array.

31. A method according to claim 30, wherein each nested sub-array comprises a plurality of fourth level elements, each fourth level element including at least one final component.

32. A method according to claim 31, wherein each array comprises six third level hexagons and each nested sub-array comprises six fourth level hexagons arranged around a central third level hexagon, each of the six fourth level hexagons corresponding to at least one final component of the alphabetical phonetic transcription.

33. A method according to claim 32, further comprising displaying final components in each fourth level hexagon in accordance with the selection of a group of final components in the third level hexagon with which the fourth level hexagons are associated.

34. A method according to any one of claims 27 to 33, further comprising validating the selection of the final component to obtain the complete alphabetical phonetic transcription for the character.

35. A method according to any one of claims 27 to 33, further comprising automatically validating the final component.

36. A method according to any one of claims 27 to 35, wherein the complete alphabetical phonetic transcription is unambiguous and used for encoding the character.

37. A method according to any one of claims 27 to 35, further comprising performing a third input step for selecting at least one semantic component for the character based on the selected alphabetical phonetic transcription from a plurality of semantic components related to the character in the symbol-based written language.

38. A method according to any one of claim 1 or 2, wherein said at least one input step comprises a third input step for selecting at least one semantic component for the character.

39. A method according to claim 37 or 38, wherein said at least one semantic component is selected from a plurality of semantic components grouped according to similarities in at least one of: meaning and shape.

40. A method according to any one of claims 37 to 39, wherein the array comprises a plurality of fifth level elements arranged around a central element corresponding to the selected final component of an alphabetical phonetic transcription corresponding to the character to be encoded, each fifth level element corresponding to a group of semantic components compatible with the selected component of the alphabetical phonetic transcription.

41. A method according to claim 40, wherein the selection of a fifth level element corresponding to a group of semantic components generates a nested sub-array.

42. A method according to any one of claims 37 to 39, wherein each group of semantic components comprises a group of radicals.

43. A method according to claim 41 or 42, wherein each nested sub-array comprises a plurality of sixth level elements, each sixth level element including at least one of a semantic component for the character to be encoded and a character to be encoded.

44. A method according to claim 43, wherein each array comprises six fifth level hexagons and each nested sub-array comprises six sixth level hexagons arranged around a central fifth level hexagon corresponding to the selected group of semantic components, each of the six sixth level hexagons corresponding to at least one of a semantic component for the character to be encoded and a character to be encoded.

45. A method according to claim 44, further comprising displaying at least one of: a semantic component for the character to be encoded and a character to be encoded in each sixth level hexagon in accordance with the selection of a group of semantic components in the fifth level hexagon with which the sixth level hexagons are associated.

46. A method according to any one of claims 37 to 45, further comprising validating the selection of the character to be encoded.

47. A method according to any one of claims 37 to 45, further comprising automatically validating the selection of the character to be encoded.

48. A method according to any one of claims 37 to 47, wherein the selection of the character is used for encoding.

49. A method according to any one of claims 37 to 45, further comprising validating the selection of the semantic component of the character to be encoded.

50. A method according to any one of claims 37 to 45, further comprising automatically validating the selection of the semantic component of the character to be encoded.

51. A method according to claim 49 or 50, further comprising performing a fourth input step for selecting a character from a number of possible characters in the same grouping of semantic components to resolve any ambiguities for the character arising from similarities in at least one of: meaning and shape.

52. A method according to claim 51, wherein the number of characters in the same grouping comprises a fixed list of characters.

53. A method according to claim 52, wherein the fixed list of characters is arranged in a predetermined hierarchy.

54. A method according to claim 53, wherein the predetermined hierarchy comprises a rank based on frequency of use.

55. A method according to any one of claims 51 to 54, further comprising displaying said number of characters in the same grouping of semantic components in a matrix.

56. A method according to claim 55, wherein the matrix comprises at least a 3×3 matrix.

57. A method according to claim 56 or 57, wherein the matrix comprises at least a first level.

58. A method according to claim 57, wherein the matrix comprises a second level, a link being provided to the second level from the first level.

59. A method according to any one of the preceding claims, further comprising inserting at least one of: punctuation, symbols, numbers and spaces into a string of encoded characters.

60. A method according to claim 59, further comprising displaying said at least one of: punctuation, symbols, numbers and spaces in an array.

61. A method according to claim 60, wherein the array comprises a plurality of elements.

62. A method according to claim 61, wherein selection of an element in the array generates at least one nested sub-array.

63. A method according to claim 61 or 62, wherein the plurality of elements comprises six hexagons arranged around a central hexagon.

64. A method according to claim 63, wherein each nested sub-array comprises a plurality of hexagons arranged around the hexagon with which it is associated.

65. A method according to claim 64, wherein each hexagon and the central hexagon comprises at least one of: punctuation, symbols, numbers and spaces.

66. A method according to any one of the preceding claims, further comprising, when two movements are made in the same direction, using a clockwise movement to replace the second of said movements.

67. A method according to any one of the preceding claims, further comprising using a counter-clockwise movement to bypass an input step.

68. A method according to any one of the preceding claims, further comprising performing each input step in the input path for the character to be encoded in at least one single continuous movement on a touch-sensitive input device.

69. A method according to claim 68, further comprising displaying each step in the input path during said at least one single continuous movement.

70. A method according to any one of claims 1 to 67, further comprising performing each input step in the input path for the character to be encoded using a gesture recognition system, the gesture recognition system forming part of the computerised system.

71. A method according to any one of the preceding claims, further comprising providing a start position for said at least one input step irrespective of positioning within a predetermined interaction region.

72. A method according to any one of claims 1 to 67, further comprising performing each input step in the input path for the character to be encoded using a series of discrete individual movements on a touch-sensitive input device.

73. A method according to claim 72, wherein said series of discrete movements includes at least one movement predetermined by the computerised system.

74. A method according to claim 73, wherein said at least one predetermined movement comprises at least one of: a tap, a stroke, and a swipe.

75. A method according to claim 73, wherein said at least one predetermined movement comprises lifting an object from a touch-sensitive surface.

76. A method according to any one of claims 1 to 67, further comprising performing each input step in the input path for the character to be encoded using a series of discrete movements on an input device including a numeric keypad.

77. A method according to claim 76, wherein the series of discrete movements comprises selecting at least one location on the numeric keypad.

78. A method according to claim 77, wherein a plurality of selected locations on the numeric keypad define directional movements relative to a neutral location.

79. A method according to claim 78, wherein the neutral location corresponds to a central location of the keypad, and selection of the central location defines a validation of a character to be encoded.

80. A method according to claim 78 or 79, wherein the plurality of selected locations comprise a upper row and a lower row relative to the neutral location.

81. A method according to any one of claims 77 to 80, further comprising associating a predefined colour to each location on the numeric keypad.

82. A method according to any one of claims 77 to 81, further comprising associating a predefined sound to each location on the numeric keypad.

83. A method according to claim 82, wherein each predefined sound corresponds to a defined note in musical scale.

84. A method according to any one of the preceding claims, further comprising associating a symbolic representation with said at least one input step.

85. Apparatus for encoding a character in a symbol-based written language in a computerised system, the system comprising:—
a database arranged for storing information relating to each character to be encoded;
an input device operable for permitting input of at least one input component relating to a character to be encoded, and, through which information stored in the database is retrieved in accordance with said at least one input component;
a processor connected to the database and the input device, the processor being operable for using said at least one component input to the input device for retrieving information relating to said at least one input component relating to character to be encoded from the database; and
a display connected to the processor and being operable for displaying said at least one input component and information retrieved from the database relating to said at least one input component.

86. Apparatus according to claim 85, further comprising a memory associated with the processor, the memory being operable for storing retrieved information relating to the character to be encoded.

87. Apparatus according to claim 85 or 86, wherein the input device comprises a touch-sensitive surface, contact and subsequent movement of an object over the touch-sensitive surface inputting said at least one input component.

88. Apparatus according to claim 87, wherein the touch-sensitive surface forms part of the display.

89. Apparatus according to claim 87 or 88, wherein the computerised system comprises a tablet.

90. Apparatus according to claim 87 or 88, wherein the computerised system comprises a smart phone.

91. Apparatus according to claim 87 or 88, wherein the computerised system comprises a smart watch.

92. Apparatus according to any one of claims 87 to 91, wherein the processor comprises an operating system associated with the touch-sensitive surface.

93. Apparatus according to claim 85 or 86, wherein the input device comprises a numeric keypad.

94. Apparatus according to claim 93, wherein the numeric keypad forms part of the computerised system.

95. Apparatus according to claim 93, wherein the numeric keypad forms part of a touch-sensitive surface.

96. Apparatus according to any one of claims 93 to 95, wherein the computerised system associates a predefined colour with each location on the numeric keypad.

97. Apparatus according to any one of claims 93 to 96, wherein the computerised system associates a predefined sound to each location on the numeric keypad.

98. Apparatus according to claim 97, wherein each predefined sound corresponds to a defined note in musical scale.

99. Apparatus according to claim 85 or 86, wherein the input device comprises a gesture recognition system associated with the computerised system.

100. Apparatus according to any one of claims 85 to 99, wherein the database is located in a hosted environment, the processor being operable to connect to the hosted environment.

101. Apparatus according to any one of claims 85 to 99, wherein the database forms part of the computerised system.

102. A method of encoding a character in a symbol-based written language using a touch-sensitive input device, the touch-sensitive input device having a touch-sensitive surface, the method comprising:—
making contact with a first region of the touch-sensitive surface of the touch-sensitive input device using an object; and
selecting at least an initial component relating to the character to be encoded from a plurality of initial components by moving the object from the first region to at least one other region on the touch-sensitive surface maintaining contact between the object and the touch-sensitive surface.

103. A method according to claim 102, wherein said at least one other region is located around the position of the object in contact with the first region of the touch-sensitive input device.

104. A method according to claim 102 or 103, further comprising, with continuous contact with between the object and the touch-sensitive surface, moving the object in at least one direction from the second region to at least one other region to select additional components of the character to be encoded; and removing the object from said at least one other region to encode the character.

105. A method according to claim 104, wherein said at least one other region comprises a nested sub-region.

106. A method according to claim 104 or 105, further comprising moving the object in a predetermined direction prior to removing it from contact with said at least one other region.

107. A method according to any one of claims 104 to 106, wherein said at least one other region comprises a series of regions, each region including a plurality of components relating to the character to be encoded compatible with a previously selected component, the object being removed from contact with the region of the series which fully defines the character to be encoded.

108. A method according to any one of claims 104 to 107, wherein removing the object from contact with the touch-sensitive surface encodes the character.

109. A method according to any one of claims 104 to 108, further comprising displaying the components for selection at each region.

110. A computer program product executable on a computerised system and operable for performing the method of inputting a character in a symbol-based written language for encoding in a computerised system using at least phonetic information relating to the character to be input in no more than four input steps, the four input steps defining an input path and each input step resolving ambiguity associated with the encoding of the character, the method being in accordance with any one of claims 1 to 84.

111. A computer program product executable on a computerised system and operable for performing a method of encoding a character in a symbol-based written language using a touch-sensitive input device, the touch-sensitive input device having a touch-sensitive surface, the method being in accordance with any one of claims 104 to 106.

112. A computer program product executable on a computerised system and operable for performing a method of encoding a character in a symbol-based written language using a gesture recognition system associated with a computerised system, the method being in accordance with claim 99.
